(19) United States
(12) Patent Application Publication
(10) Pub. No.: US 2016/0134927 A1
(43) Pub. Date: May 12, 2016

(54) RECEPTION DEVICE, RECEPTION METHOD, TRANSMISSION DEVICE, AND TRANSMISSION METHOD

(71) Applicant: SONY CORPORATION, Tokyo (JP)

(72) Inventors: Naohisa KITAZATO, Tokyo (JP); Jun KITAHARA, Shizuoka (JP)

(73) Assignee: SONY CORPORATION, Tokyo (JP)

(21) Appl. No.: 14/896,552

(22) PCT Filed: Sep. 24, 2014
(86) PCT No.: PCT/JP2014/004873

§ 371 Date: Dec. 7, 2015

(30) Foreign Application Priority Data
Oct. 4, 2013 (JP) 2013-209055

(51) Int. Cl. H04N 21/438; H04N 21/2381; H04N 21/434; H04N 21/643; H04N 21/63

(52) U.S. Cl. CPC H04N 21/4381; H04N 21/64322; H04N 21/631; H04N 21/4345; H04N 21/2381

(57) ABSTRACT

Provided is a reception device, a reception method, a transmission device, and a transmission method, in which a service package unit uses one or a plurality of components and a control signal constituting a specific service among a plurality of services included in the broadcasting wave of digital broadcast by using an IP transmission mode to package in units of a service by using IP an address included in each packet, and performs a predetermined process, thereby being flexibly adaptable to various operation forms in the digital broadcast using the IP transmission mode. The present disclosure is adaptable to, for example, a television set.

### TECHNICAL FIELD

The present disclosure relates to a reception device, a reception method, a transmission device, and a transmission method, and more particularly, to a reception device, a reception method, a transmission device, and a transmission method configured to be flexibly adaptable to various operation forms.

### CROSS REFERENCE TO RELATED APPLICATIONS

This application claims the benefit of Japanese Priority Patent Application JP 2013-209055 filed on Oct. 4, 2013, the entire contents of which are incorporated herein by reference.

### BACKGROUND ART

In standards of digital broadcast of various countries, an MPEG2-TS (Moving Picture Experts Group phase 2-Transport Stream) mode is employed as a transmission format (for example, refer to PTL 1). In the future, a more advanced service is considered to be provided by employing an IP transmission mode in which IP (Internet Protocol) packets used in fields of communication is used in the digital broadcast.

### CITATION LIST

### Patent Literature

PTL 1: JP 2012-156712A

### SUMMARY OF INVENTION

### Technical Problem

Contents having various formats may be transmitted to various devices by employing the IP transmission mode, so that various operation forms are considered to be used. However, technological methods for adapting to the operation forms are not established.

The present disclosure is made in view of such a situation and intended to be flexibly adaptable to various operation forms in digital broadcast employing an IP transmission mode.

According to a first aspect of the present disclosure, there is provided a reception device including circuitry configured to receive a digital broadcast signal including an IP (Internet Protocol) transport stream; package, for a specific service among a plurality of services included in the digital broadcast signal, packets of one or a plurality of components and a first control signal constituting the specific service by using an IP address included in each of the packets; and perform a predetermined process by using the packaged one or the plurality of components and control information.

Packets of the one or the plurality of components and a packet of the first control information which are packaged as a same service have a same IP address.

The circuitry is configured to package the first control information used for a first layer which is an upper layer of an IP layer among layers of a protocol used to transmit the digital broadcast signal.

Second control information transmitted in a packet having a structure which is different from a structure of the IP packet includes: an ID identifying a network; an ID identifying the IP transport stream; and an ID identifying a service.

The second control information includes a different ID for identifying each of a plurality of IP transport streams included in the digital broadcast signal.

The ID identifying the network identifies a network associated with the received digital broadcast signal. The ID identifying the service identifies the specific service.

The circuitry is further configured to extract, based on the second control information, service information indicating one or more port numbers associated with the one or the plurality of components corresponding to the ID identifying the specific service, and package the specific service based on the IP address and the one or more port numbers.

Each of the packets of the one or the plurality of components includes a first header, a second header, and a third header. The first header indicates a type of information included in the respective packet. The second header indicates the IP address associated with the specific service. The third header indicates a port number of a UDP (User Datagram Protocol).

The first control information used for the first layer includes information on the one or the plurality of components constituting the specific service.

The information on the one or the plurality of components includes a port number of a UDP, and the circuitry is further configured to extract the one or the plurality of components constituting the specific service by performing filtering using the IP address and the port number.

The first control information used for the first layer includes control information of an application.

The second control information includes information associated with the IP address for each of the services.

The digital broadcast signal is transmitted using an IP transmission mode in which the packets are designated with port numbers of a UDP (User Datagram Protocol).

The one or the plurality of components is acquired from one of an RTP (Real-time Transport Protocol) session and a FLUTE (File Delivery over Unidirectional Transport) session of the digital broadcast signal based on whether the specific service is provided in a synchronous or an asynchronous format.

The circuitry is further configured to store the packaged one or the plurality of components and the first control information in a memory.

The circuitry is further configured to read the one or the plurality of components and the first control information which are stored in the memory to perform reproduction.

The circuitry is further configured to transmit the packaged one or the plurality of components and the first control information to another electronic device.

### Solution to Problem

A reception device may be an independent device or an internal block constituting one device.

A reception method according to a first embodiment of the present disclosure is a reception method which is adapted to a reception device according to the first embodiment of the present disclosure.

In a reception device and a reception method according to the first embodiment of the present disclosure, a digital broadcast signal including an IP transport stream is received by circuitry of the reception device, one or a plurality of components and control information constituting a specific service among a plurality of services included in the digital broadcast signal are packaged for a specific service by the circuitry by using an IP address included in each of the packets, and a predetermined process is performed by using the packaged components and control information.

A transmission device according to a second embodiment of the present disclosure is configured to include circuitry configured to acquire one or a plurality of components, a acquire control information, and transmit a digital broadcast signal including an IP transport stream in which packets of the one or the plurality of components and a packet of the control information constituting a specific service have the same IP address.

The transmission device may be an independent device and may be an internal block constituting one device.

A transmission method according to the second embodiment of the present disclosure is a transmission method corresponding to the transmission device according to the second embodiment of the present disclosure.

In the transmission device and the transmission method according to the second embodiment of the present disclosure, one or a plurality of components are acquired by circuitry of the transmission device, control information is acquired by the circuitry, and a digital broadcast signal including an IP transport stream is transmitted, by the circuitry, in which packets of the one or the plurality of components and a packet of the control information constituting a specific service have the same IP address.

### Advantageous Effects of Invention

According to the first and second embodiments of the present disclosure, it is possible to flexibly adapt to various operation forms.

In addition, the effects described herein are not necessarily limited, and they may also be any effect described in the present disclosure.

### BRIEF DESCRIPTION OF DRAWINGS

FIG. 1 is a diagram illustrating a protocol stack of digital broadcast in an IP transmission mode.

FIG. 2 is a diagram illustrating a relation between a signal of a broadcasting wave and an ID system in the IP transmission mode.

FIG. 3 is a diagram illustrating a configuration of the broadcasting wave of the digital broadcast in the IP transmission mode.

FIG. 4 is a diagram illustrating a configuration of an LLS.

FIG. 5 is a diagram illustrating a configuration of an MLS.

FIG. 6 is a diagram illustrating a concept of service channels.

FIG. 7 is a diagram illustrating a configuration of an embodiment of a broadcasting system employing the present disclosure.

FIG. 8 is a diagram illustrating a configuration of an embodiment of a transmission device employing the present disclosure.

FIG. 9 is a diagram illustrating a configuration of an embodiment of a reception device employing the present disclosure.

FIG. 10 is a diagram illustrating details of a filtering process of each packet in a Demux.

FIG. 11 is a diagram describing a basic signaling system.

FIG. 12 is a diagram describing a signaling system in an NRT service.

FIG. 13 is a diagram describing a signaling system in a hybrid service.

FIG. 14 is a diagram illustrating a data structure of an NIT.

FIG. 15 is a diagram illustrating an example of descriptors arranged in a loop of the NIT.

FIG. 16 is a diagram illustrating a data structure of Name_descriptor.

FIG. 17 is a diagram illustrating a data structure of Service_list_descriptor.

FIG. 18 is a diagram illustrating a data structure of ATSC3_delivery_system_descriptor.

FIG. 19 is a diagram illustrating a data structure of Transport_stream_protocol_descriptor.

FIG. 20 is a diagram illustrating a data structure of ESG_bootstrap_descriptor.

FIG. 21 is a diagram illustrating a data structure of an AMT.

FIG. 22 is a diagram illustrating a data structure of an SAT.

FIG. 23 is a diagram illustrating an example of a packet for transmission of the SAT.

FIG. 24 is a diagram illustrating a data structure of SAT_data.

FIG. 25 is a diagram illustrating a data structure of an SMT.

FIG. 26 is a diagram illustrating an example of descriptors arranged in a loop of the SMT.

FIG. 27 is a diagram describing an initial scan process.

FIG. 28 is a diagram describing flow of information acquired during initial scan.

FIG. 29 is a diagram illustrating operations of a reception device during the initial scan.

FIG. 30 is a diagram describing an ESG acquisition process.

FIG. 31 is a diagram illustrating flow of information acquired during ESG acquisition.

FIG. 32 is a diagram illustrating operations of a reception device during the ESG acquisition.

FIG. 33 is a diagram describing a direct channel selection process.

FIG. 34 is a diagram illustrating flow of information acquired during direct channel selection.

FIG. 35 is a diagram illustrating operations of a reception device during the direct channel selection.

FIG. 36 is a diagram describing an ESG channel selection process.

FIG. 37 is a diagram describing flow of information acquired during ESG channel selection.

FIG. 38 is a diagram illustrating operations of a reception device during the ESG channel selection.

FIG. 39 is a diagram describing an ESG recording reservation/execution process.

FIG. 40 is a diagram describing flow of information acquired during ESG recording reservation/execution.

FIG. 41 is a diagram illustrating operations of a reception device during the ESG recording reservation/execution.

FIG. 42 is a diagram illustrating operations of a reception device during recording program reproduction.

FIG. 43 is a diagram describing an NRT-ESG acquisition process.

FIG. 44 is a diagram illustrating operations of a reception device during NRT-ESG acquisition.

FIG. 45 is a diagram describing an NRT content acquisition/reproduction process.

FIG. 46 is a diagram describing flow of information acquired during NRT content acquisition/reproduction.

FIG. 47 is a diagram illustrating operations of a reception device during the NRT content acquisition/reproduction.

FIG. 48 is a diagram describing an NRT content acquisition/display process.

FIG. 49 is a diagram describing flow of information acquired during NRT content acquisition/display.

FIG. 50 is a diagram illustrating operations of a reception device during the NRT content acquisition/display.

FIG. 51 is a diagram describing an application acquisition/display process.

FIG. 52 is a diagram describing flow of information acquired during application acquisition/display.

FIG. 53 is a diagram illustrating operations of a reception device during the application acquisition/display.

FIG. 54 is a flowchart describing a transmission process.

FIG. 55 is a flowchart describing a package recording process.

FIG. 56 is a flowchart describing a depackage reproduction process.

FIG. 57 is a diagram illustrating an example of a configuration of a computer.

### DESCRIPTION OF EMBODIMENTS

Herein, embodiments of the present disclosure will be described with reference to the drawings.

<Overview of the Present Disclosure>

(Protocol Stack)

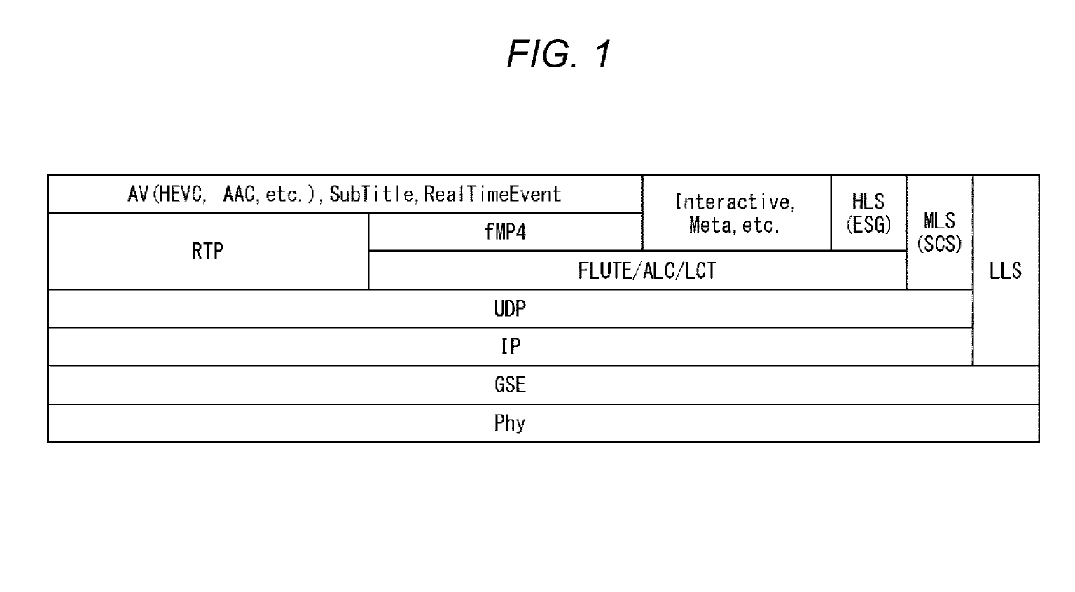

FIG. 1 is a diagram illustrating a protocol stack of digital broadcast in an IP transmission mode.

As illustrated in FIG. 1, the lowermost layer is considered to be a physical layer, which corresponds to a frequency band of a broadcasting wave allocated for service (channel). The upper layer adjacent to the physical layer is considered to be a GSE layer. The GSE (Generic Stream Encapsulation) layer is a layer for associating the lower-adjacent physical layer with an upper-adjacent IP layer. In addition, the GSE is employed as a standard of DVB (Digital Video Broadcasting).

The IP layer is the same as IP (Internet Protocol) of a protocol stack of TCP/IP, and an IP packet is specified by an IP address. The upper layer adjacent to the IP layer is considered to be a UDP layer, and the upper layer thereof is considered to be RTP (Real-time Transport Protocol), or FLUTE (File Delivery over Unidirectional Transport)/ALC (Asynchronous Layered Coding Protocol)/LCT (Layered Coding Transport). Namely, in the digital broadcast in the IP transmission mode, packets which are designated with port numbers of UDP (User Datagram Protocol) are transmitted, and for example, an RTP session or a FLUTE session is established. In addition, details of the FLUTE are regulated as RFC3926.

The upper layer adjacent to the FLUTE/ALC/LCT is considered to be an fMP4 (Fragmented MP4), and the upper layers adjacent to the RTP and the fMP4 are considered to be AV (Audio Video), SubTitle, and RealTimeEvent. Video data (Video) is encoded according to an encoding scheme, for example, HEVC (High Efficiency Video Coding), or the like. In addition, audio data (Audio) is encoded according to an encoding scheme, for example, AAC (Advanced Audio Coding), or the like. Namely, in a case where the video data or the audio data are transmitted in a synchronous stream format, the RTP session is used; and in a case where the video data or the audio data are transmitted in an asynchronous file format, the FLUTE session is used.

In addition, the upper layers of the FLUTE/ALC/LCT are considered to be Interactive, Meta, and etc. For example, in the case of transmitting a file of an application which is to be executed in conjunction with AV content, the FLUTE session is used.

At the right side of the protocol stack of FIG. 1, an LLS, an MLS, and an HLS are regulated as signaling. The LLS (Low Layer Signaling) is signaling of a low layer and becomes an upper layer of the GSE layer. For example, as the LLS, a combination (hereinafter, referred to as a “triplet”) of network_id, transport_stream_id, and service_id and a section format which are used in an MPEG2-TS mode may be employed.

In this case, as the LLS, an NIT (Network Information Table) representing a transport stream configuration and a service configuration in a broadcasting network by using the triplet may be transmitted. In addition, as described later in detail, as the LLS, an AMT (Address Map Table) together with the NIT is transmitted, so that, for example, channel selection information for selection of a service (channel) may be obtained. In addition, as the LLS, an SAT (Service Association Table) is transmitted, so that it may be determined whether or not a specific service is in an on-air state (in a broadcasting state).

In addition, the MLS (Middle Layer Signaling) is signaling of a middle layer and becomes an upper layer of the UDP layer. The MLS is installed, so that a rapid channel selection process is available. For example, as the MLS, SCS (Service Channel Signaling) for transmitting service-associated information or component information in units of a service may be employed. As the SCS, for example, an SMT (Service Map Table), an AIT (Application Information Table), or the like is transmitted in a section format. The SMT includes service attributes in units of a service, configuration information of components, component attributes, filter information of components, and the like. The AIT is control information of an application in the later-described hybrid service.

The HLS (High Layers Signaling) is signaling (or announcement) of a high layer and becomes an upper layer of the FLUTE/ALC/LCT. For example, as the HLS, a file of ESG (Electronic Service Guide) is transmitted by using the FLUTE session, so that a program title, a start time, or the like may be displayed.

(ID System in the Present Disclosure)

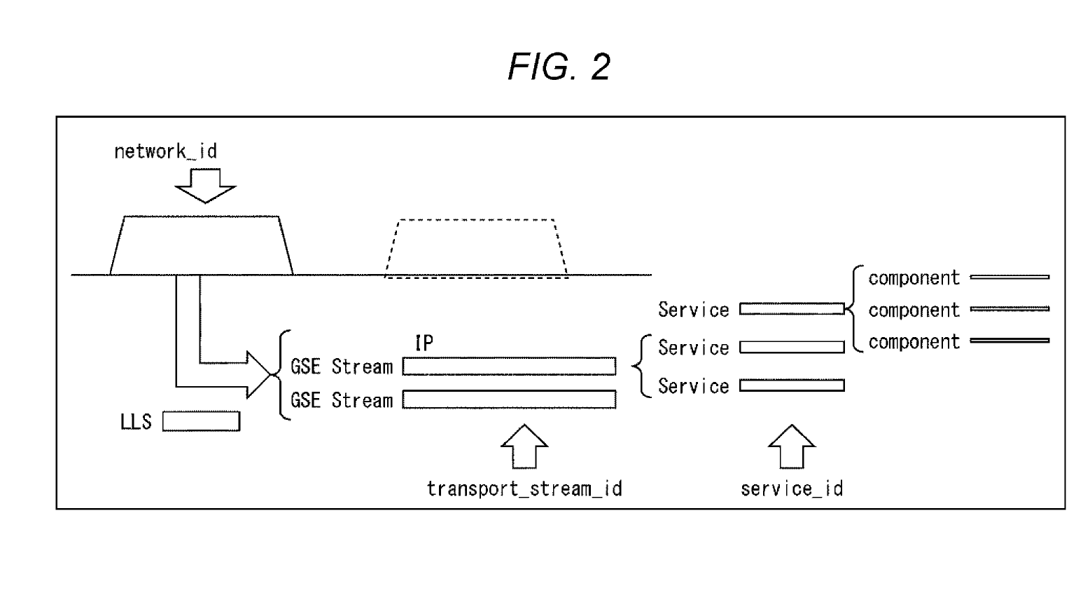

FIG. 2 is a diagram illustrating a relation between a signal of a broadcasting wave and an ID system in the IP transmission mode.

As illustrated in FIG. 2, the network_id may be allocated to a broadcasting wave (broadcasting network) having a frequency band of 6 MHz. Each broadcasting wave includes one or a plurality of GSE streams identified by the transport_stream_id. The GSE stream is constructed with a plurality of GSE packets including a GSE header and a payload.

Each GSE stream includes a plurality of services identified by the service_id. Each service is configured with a plurality of components. Each component is information, for example, video data, audio data, and the like constituting a program.

In this manner, similarly to the MPEG2-TS mode, a triplet is employed as the ID system of the IP transmission mode, and thus, by using a combination of the network_id, the transport_stream_id, and the service_id, it is possible to perform matching with the MPEG2-TS mode which widely prevails at present may be performed. Therefore, for example, it is possible to easily adapt to simulcast during transition from the MPEG2-TS mode to the IP transmission mode.

In addition, in the case of performing the operation using a major channel number and a minor channel number as identification information corresponding to the service_id, it is possible to adapt to the operation by allocating upper 8 bits among 16 bits of the service_id to 8 bits of the major channel number, and lower 8 bits to 8 bits of the minor channel number.

(Configuration of Broadcasting Wave in IP Transmission Mode)

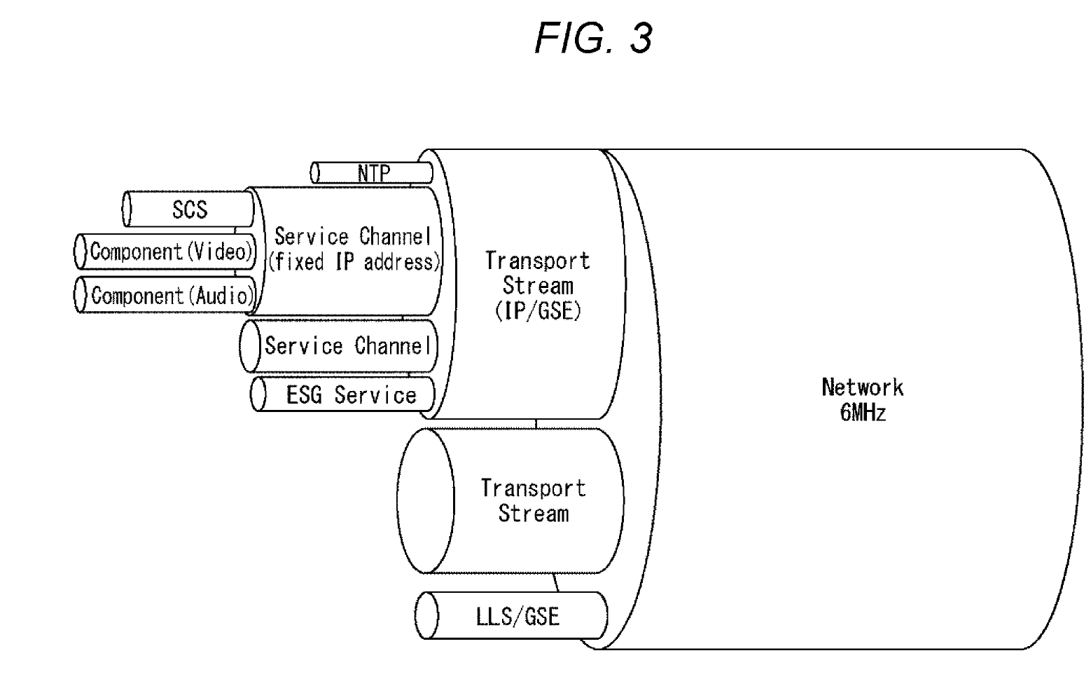

FIG. 3 is a diagram illustrating a configuration of the broadcasting wave of the digital broadcast in the IP transmission mode.

As illustrated in FIG. 3, one or a plurality of transport streams and the LLS may be acquired from a broadcasting wave (“Network” in the figure) having a frequency band of 6 MHz. In addition, the NTP (Network Time Protocol), a plurality of service channels, and an electronic service guide (ESG Service) may be acquired from each transport stream. The NTP is time information and is common to a plurality of the service channels.

Each service channel includes components such as video data or audio data and SCS such as an AMT or an AIT. In addition, each service channel is provided with a fixed IP address, and the components, the control signals, and the like for each service channel may be packaged by using the IP address.

In addition, in FIG. 3, the transport stream corresponds to the GSE stream of FIG. 2, and transport streams written in the description hereinafter denote GSE streams. In addition, the service channel corresponds to the service of FIG. 2, and the components also correspond thereto.

(Configuration of LLS)

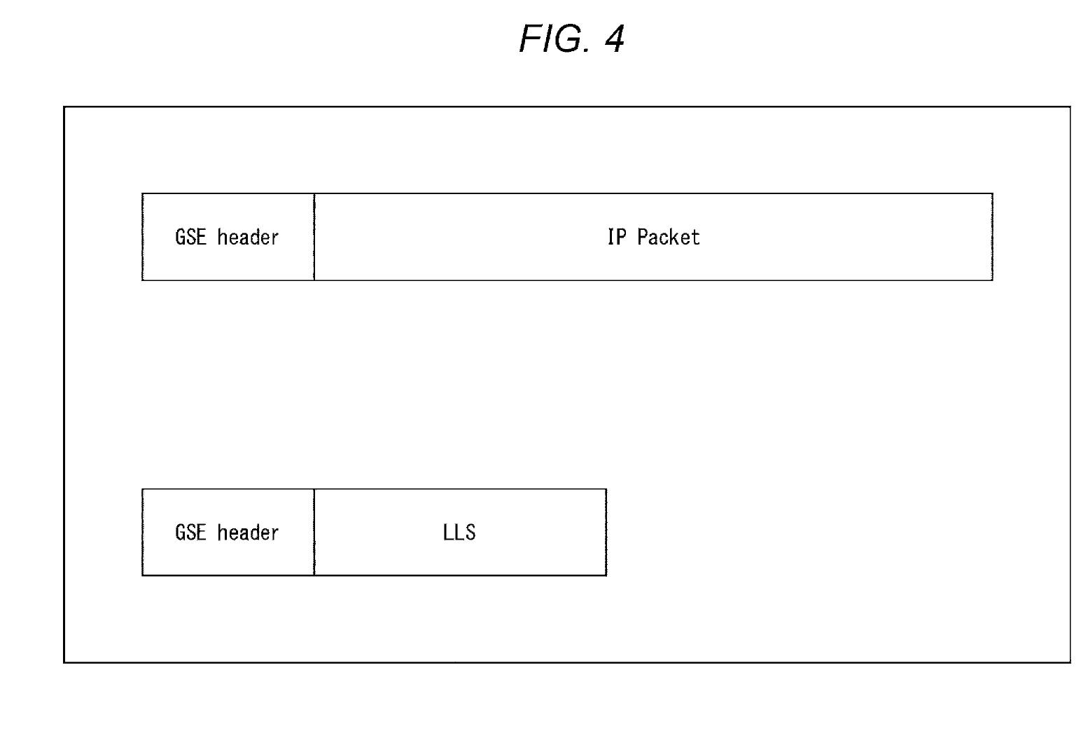

FIG. 4 is a diagram illustrating a configuration of the LLS.

As illustrated in FIG. 4, the GSE packet is configured to include a GSE header and a payload. In a case where an upper layer of the GSE layer is the IP layer, a portion of the payload becomes an IP packet. Although the LLS is an upper layer of the GSE layer, the LLS is arranged following the GSE header in order to be transmitted in a section format. As the LLS, for example, the NIT, the AMT, and the SAT may be arranged.

In addition, the GSE header includes 2-bit type information, and according to the type information, it may be distinguished whether the GSE packet is an IP packet or an LLS.

(Configuration of MLS)

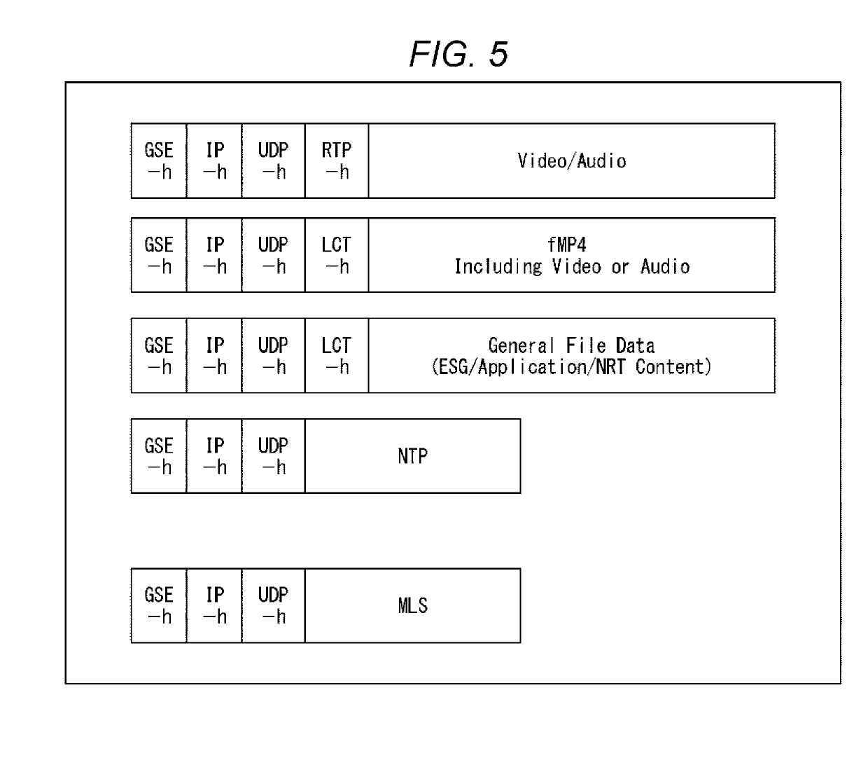

FIG. 5 is a diagram illustrating a configuration of the MLS.

As illustrated in FIG. 5, for example, in a case where the video data or the audio data are transmitted in a synchronous stream format, since the RTP session is used, each header of the GSE, the IP, the UDP, and the RTP is added to the payload. In addition, in a case where the file data such as an fMP4 or an ESG are transmitted in an asynchronous file format, since the FLUTE session is used, each header of the GSE, the IP, the UDP, and the LCT is added to the payload. In addition, since the NTP is the upper layer of the UDP layer, the NTP is arranged following each header of the GSE, the IP, and the UDP.

Although the MLS is the upper layer of the UDP layer, the MLS is arranged following each header of the GSE, the IP, and the UDP in order to be transmitted in a section format. As the MLS (SCS), for example, the SMT or the AIT may be arranged.

(Concept of Service Channel)

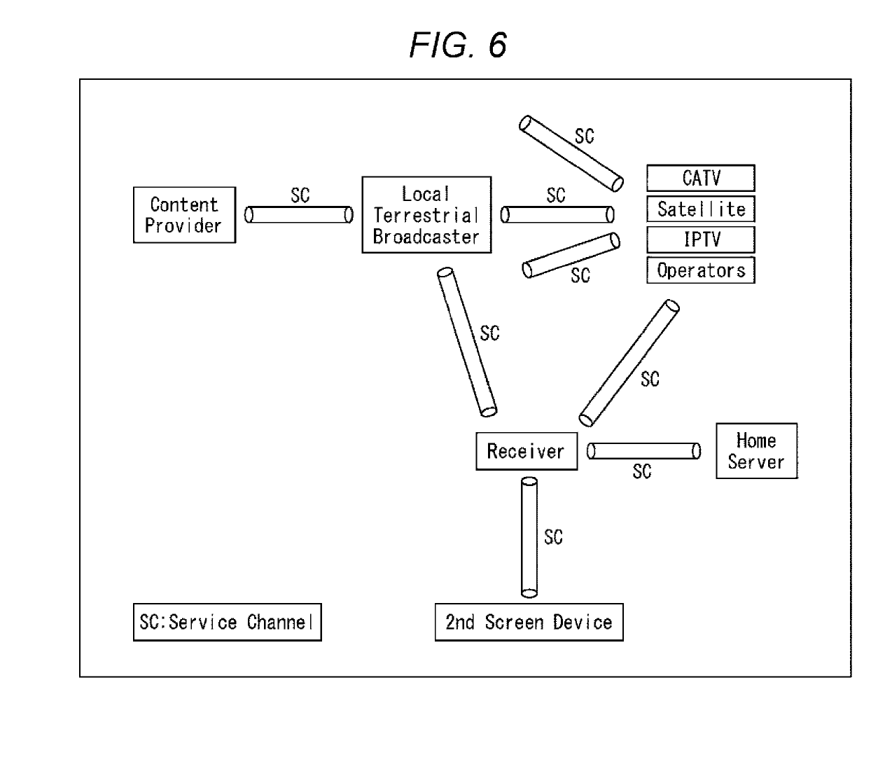

FIG. 6 is a diagram illustrating a concept of service channels (SCs).

As illustrated in FIG. 6, when a content produced by a content provider is provided to a local terrestrial broadcaster, components, control signals, and the like associated with the same IP address are packaged so as to be provided in units of a service channel. In addition, the local terrestrial broadcaster is allowed to provide the service channel to a CATV provider, a satellite broadcaster (Satellite), an IPTV provider, operators, and the like. In addition, the CATV provider or the like may perform re-packaging, for example, by adding an application to the service channel.

A receiver receives the service channel transmitted from the local terrestrial broadcaster, the CATV, or the like. The receiver displays video of the service channel on a display and simultaneously outputs audio corresponding to the video from a speaker. In addition, the receiver may transmit the service channel to a home server, an external device (2nd Screen Device), and the like which are connected to a home network constructed inside a house. Therefore, the service channel from the receiver is stored in the home server. In addition, in the external device, the video of the service channel from the receiver is displayed on a display, and the audio corresponding to the video is output from a speaker.

In this manner, signals of configuration elements of service such as video data, audio data, control signals, and the like which serve as the same IP address are packaged, and thus, data may be handled in units of a service channel (service), so that it is possible to flexibly adapt to various operation forms, for example, by easily adding an application to the service channel.

<Example of Configuration of Broadcasting System>

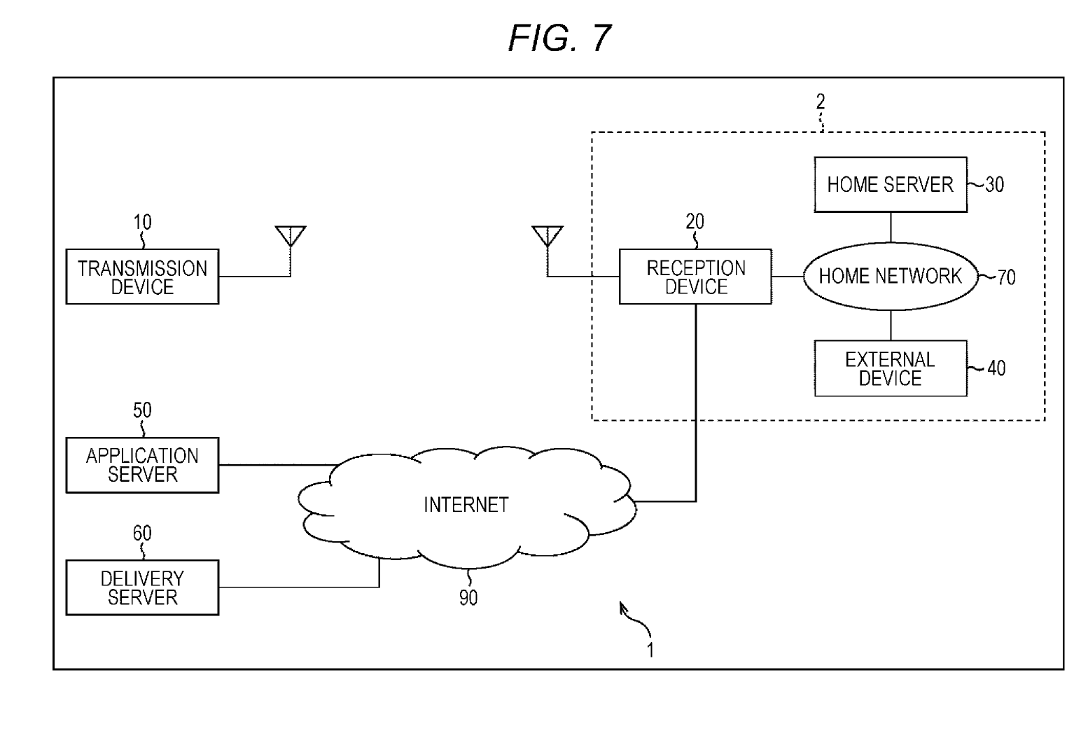

FIG. 7 is a diagram illustrating a configuration of an embodiment of a broadcasting system employing the present disclosure.

As illustrated in FIG. 7, a broadcasting system 1 is configured to include a transmission device 10, a reception device 20, a home server 30, an external device 40, an application server 50, and a delivery server 60. The reception device 20, the home server 30, and the external device 40 are installed inside a house 2 and are connected to each other via a home network 70. In addition, the reception device 20, the application server 50, and the delivery server 60 are connected to each other via the Internet 90.

The transmission device 10 transmits a broadcast content such as a TV program by a broadcasting wave of digital broadcast using an IP transmission mode.

The reception device 20 receives a broadcast signal transmitted from the transmission device 10 and acquires video and audio of the broadcast content. The reception device 20 outputs the audio synchronized with the video from a speaker while displaying the video of the broadcast content on a display. In addition, the reception device 20 may be configured as one body including the display or the speaker, and the reception device 20 may be configured to be built in a television set, a video recorder, or the like.

The reception device 20 communicates various data with the home server 30 via the home network 70. The home server 30 receives and records the data transmitted from the reception device 20 via the home network 70, or the home server 30 supplies the data in response to a request from the reception device 20 via the home network 70.

In addition, the reception device 20 communicates various data with the external device 40 via the home network 70. The external device 40 receives and displays the data transmitted from the reception device 20 via the home network 70.

The application server 50 manages an application executed in conjunction with the broadcast content. The application server 50 supplies the application in response to a request from the reception device 20 via the Internet 90. The reception device 20 executes the application from the application server 50 in conjunction with the broadcast content.

The delivery server 60 supplies a communication content such as a broadcasted broadcasting program or a published movie as a VOD (Video On Demand). The reception device 20 receives the communication content delivered from the delivery server 60 via the Internet 90. The reception device 20 outputs the audio synchronized with the video from the speaker while displaying the video of the communication content on the display.

The broadcasting system 1 is configured as described hereinbefore.

(Example of Configuration of Transmission Device)

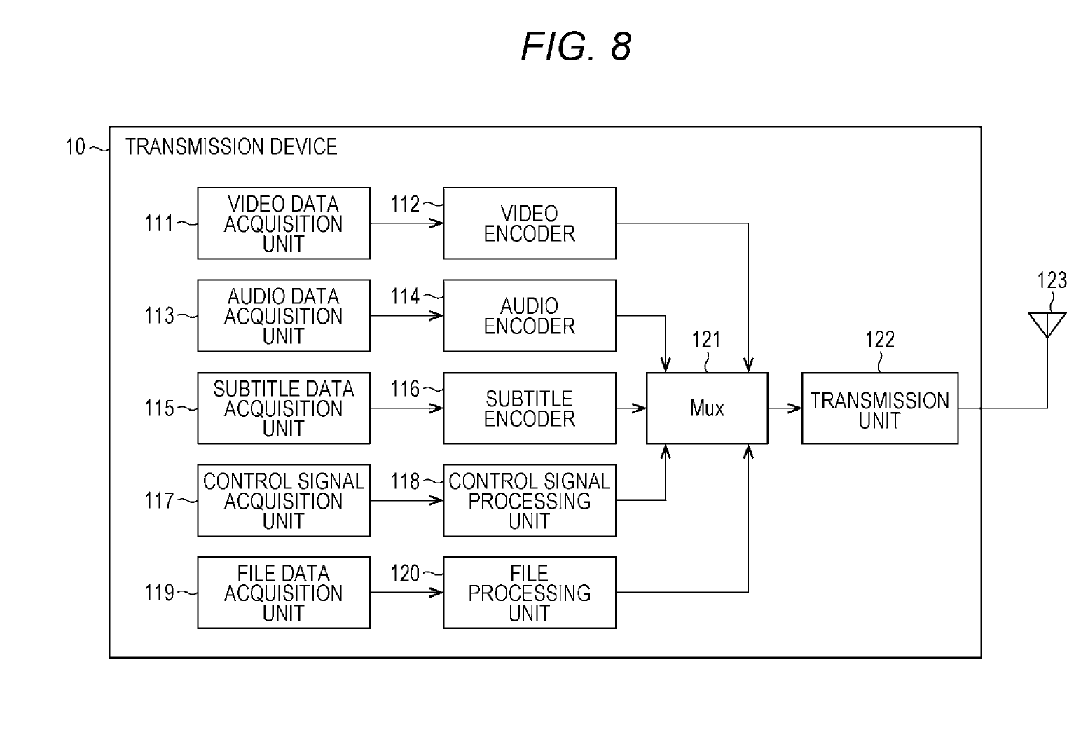

FIG. 8 is a diagram illustrating a configuration of an embodiment of a transmission device employing the present disclosure.

As illustrated in FIG. 8, the transmission device 10 is configured to include a video data acquisition unit 111, a video encoder 112, an audio data acquisition unit 113, an audio encoder 114, a subtitle data acquisition unit 115, a subtitle encoder 116, a control signal acquisition unit 117, a control signal processing unit 118, a file data acquisition unit 119, a file processing unit 120, a Mux 121, and a transmission unit 122.

The video data acquisition unit 111 acquires video data from a built-in HDD (Hard Disk Drive), an external server, a camera, or the like and supplies the video data to the video encoder 112. The video encoder 112 encodes the video data supplied from the video data acquisition unit 111 according to an encoding scheme such as MPEG and supplies the encoded video data to the Mux 121.

The audio data acquisition unit 113 acquires audio data from a built-in HDD, an external server, a microphone, or the like and supplies the audio data to the audio encoder 114. The audio encoder 114 encodes the audio data supplied from the audio data acquisition unit 113 according to an encoding scheme such as MPEG and supplies the encoded audio data to the Mux 121.

The subtitle data acquisition unit 115 acquires subtitle data from a built-in HDD or an external server, or the like and supplies the subtitle data to the subtitle encoder 116. The subtitle encoder 116 encodes the subtitle data supplied from the subtitle data acquisition unit 115 according to a predetermined encoding scheme and supplies the encoded subtitle data to the Mux 121.

The control signal acquisition unit 117 acquires control signals such as an NIT or an SMT from a built-in HDD or an external server and supplies the control signals to the control signal processing unit 118. The control signal processing unit 118 performs a predetermined signal process on the control signals supplied from the control signal acquisition unit 117 and supplies the processed control signals to the Mux 121.

In a case where data in an asynchronous file format is transmitted, the file data acquisition unit 119 acquires file data, for example, the NRT content, the application, or the like from a built-in storage, an external server, or the like and supplies the file data to the file processing unit 120. The file processing unit 120 performs a predetermined file process on the file data supplied from the file data acquisition unit 119 and supplies the processed file data to the Mux 121. For example, the file processing unit 120 performs a file process for transmitting the file data acquired by the file data acquisition unit 119 by the FLUTE session.

The Mux 121 multiplexes the video data from the video encoder 112, the audio data from the audio encoder 114, the subtitle data from the subtitle encoder 116, the control signal from the control signal processing unit 118, and the file data from the file processing unit 120 to generates a stream of the IP transmission format and supplies the stream to the transmission unit 122. The transmission unit 122 transmits the stream supplied from the Mux 121 as a broadcast signal through an antenna 123.

(Example of Configuration of Reception Device)

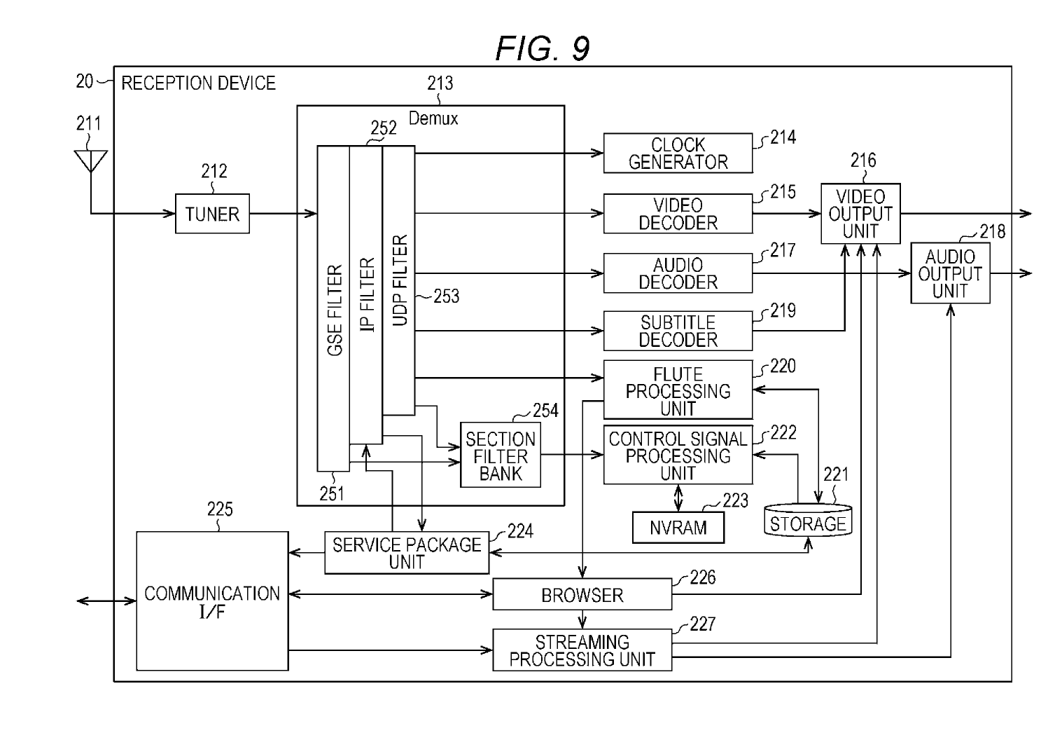

FIG. 9 is a diagram illustrating a configuration of an embodiment of a reception device employing the present disclosure.

As illustrated in FIG. 9, the reception device 20 is configured to include a tuner 212, a Demux 213, a clock generator 214, a video decoder 215, a video output unit 216, an audio decoder 217, an audio output unit 218, a subtitle decoder 219, a FLUTE processing unit 220, a storage 221, a control signal processing unit 222, an NVRAM 223, a service package unit 224, a communication I/F 225, a browser 226, and a streaming processing unit 227.

The tuner 212 extracts and demodulates the broadcast signal of the service of which selection is instructed from the broadcast signal received by the antenna 211 and supplies the resultant stream in an IP transmission format to the Demux 213.

The Demux 213 divides the stream in an IP transmission format supplied from the tuner 212 into the video data, the audio data, the subtitle data, the section data, and the like and outputs the divided data to the following block. More specifically, the Demux 213 is configured to include a GSE filter 251, an IP filter 252, a UDP filter 253, and a section filter bank 254. The GSE filter 251 performs a filtering process based on the GSE header to supply the LLS to the section filter bank 254.

The IP filter 252 performs a filtering process based on the IP header. In addition, the UDP filter 253 performs a filtering process based on the UDP header. Due to the filtering processes in the IP filter 252 and the UDP filter 253, the NTP is supplied to the clock generator 214, and the MLS is supplied to the section filter bank 254. In addition, the video data, the audio data, and the subtitle data are supplied to the video decoder 215, the audio decoder 217, and the subtitle decoder 219, respectively. In addition, various file data are supplied to the FLUTE processing unit 220.

The section filter bank 254 performs a filtering process based on the Section header to appropriately supply the LLS and the MLS to the control signal processing unit 222. In addition, the IP filter 252 performs a filtering process based on the IP address to supply the components (Audio/Video), the control signal (MLS), and the like and the time information (NTP) which serves as IP address to the service package unit 224.

The clock generator 214 generates a clock signal based on the NTP supplied from the Demux 213 and supplies the clock signal to the video decoder 215, the audio decoder 217, and the subtitle decoder 219.

The video decoder 215 decodes the video data supplied from the Demux 213 in a decoding scheme corresponding to the video encoder 112 (FIG. 8) based on the clock signal supplied from the clock generator 214 and supplies the decoded video data to the video output unit 216. The video output unit 216 outputs the video data supplied from the video decoder 215 to the display (not illustrated) in the following stage. Therefore, the video, for example, a TV program or the like is displayed on the display.

The audio decoder 217 decodes the audio data supplied from the Demux 213 in a decoding scheme corresponding to the audio encoder 114 (FIG. 8) based on the clock signal supplied from the clock generator 214 and supplies the decoded audio data to the audio output unit 218. The audio output unit 218 supplies the audio data supplied from the audio decoder 217 to the speaker (not illustrated) in the following stage. Therefore, the audio corresponding to the video, for example, a TV program or the like is output from the speaker.

The subtitle decoder 219 decodes the subtitle data supplied from the Demux 213 in a decoding scheme corresponding to the subtitle encoder 116 (FIG. 8) based on the clock signal supplied from the clock generator 214 and supplies the decoded subtitle data to the video output unit 216. In a case where the subtitle data is supplied from the subtitle decoder 219, the video output unit 216 combines the subtitle data with the video data from the video decoder 215 and supplies the combined data to the display (not illustrated) in the following stage. Therefore, the subtitle corresponding to the video together with the video from a TV program is displayed on the display.

The FLUTE processing unit 220 recovers the ESG, the application, the content, and the like from the various file data supplied from the Demux 213. For example, the FLUTE processing unit 220 records the recovered ESG or content in the storage 221. In addition, for example, the FLUTE processing unit 220 supplies the recovered application to the browser 226. The storage 221 is a recording device with a large capacity such as an HDD (Hard Disk Drive). The storage 221 records various types of data supplied from the FLUTE processing unit 220 and the like.

The control signal processing unit 222 controls operations of each unit based on the control signals (LLS and MLS) supplied from the Demux 213. The NVRAM 223 is a nonvolatile memory and records various types of data according to the control of the control signal processing unit 222.

The service package unit 224 packages configuration elements of the service channel such as components, control signals, time information, and the like supplied from the Demux 213 and records the packaged data in the storage 221. In addition, the service package unit 224 reads the packaged data of the service channel from the storage 221 and depackages the data to supply the depackaged data to the IP filter 252 of the Demux 213. Accordingly, the packaged configuration elements of the service channel may be recovered to be reproduced. In addition, the packaged data of the service channel may be supplied through the communication I/F 225 to the home server 30, the external device 40, or the like.

The communication I/F 225 communicates data with the home server 30 connected to the home network 70, the external device 40, and the like. In addition, the communication I/F 225 receives the application from the application server 50 installed on the Internet 90 and supplies the application to the browser 226. The application from the FLUTE processing unit 220 or the communication I/F 225 is supplied to the browser 226. The browser 226 generates video data according to the application configured with an HTML document written, for example, by HTML5 (Hyper Text Markup Language 5) and supplies the video data to the video output unit 216. Therefore, the video of the application in conjunction with the TV program is displayed on the display.

In addition, the communication I/F 225 receives the data of the communication content delivered from the delivery server 60 installed on the Internet 90 and supplies the data to the streaming processing unit 227. The streaming processing unit 227 performs various processes necessary for performing streaming reproduction on the data supplied from the communication I/F 225 to supply the resultant video data to the video output unit 216 and to supply the audio data to the audio output unit 218.

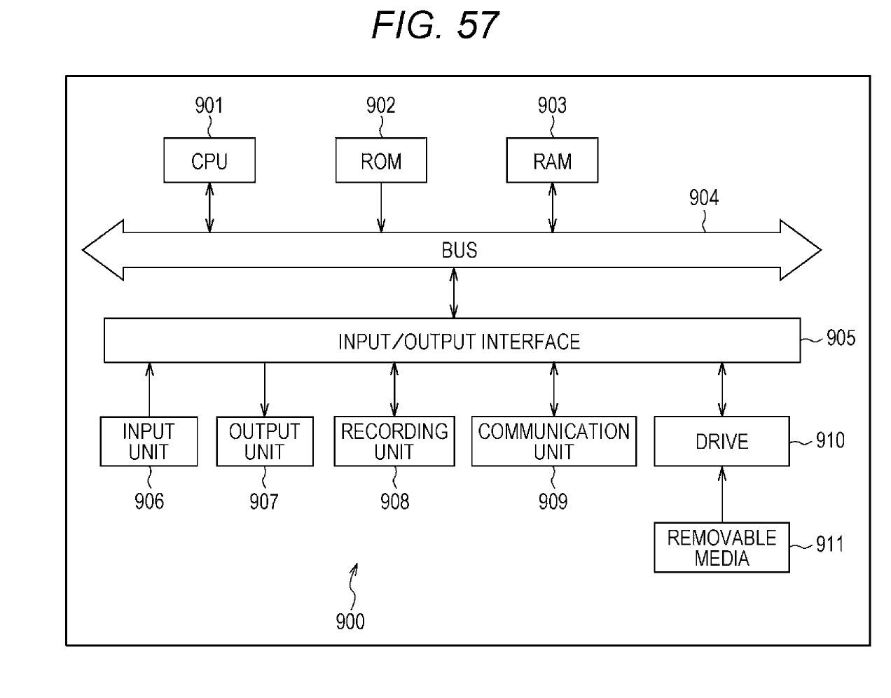

In addition, in the reception device 20 of FIG. 9, for example, the tuner 212, the Demux 213, the clock generator 214, the video decoder 215, the video output unit 216, the audio decoder 217, the audio output unit 218, the subtitle decoder 219, the storage 221, the NVRAM 223, and the communication I/F 225 are configured as hardware. In addition, for example, the FLUTE processing unit 220, the control signal processing unit 222, the service package unit 224, the browser 226, and the streaming processing unit 227 are implemented by a program executed by the CPU (CPU 901 of FIG. 57).

In addition, although in the configuration of the reception device 20 of FIG. 9, the storage 221 is described to be built in the reception device 20, an externally-attached storage may be used.

(Details of Filtering Processes)

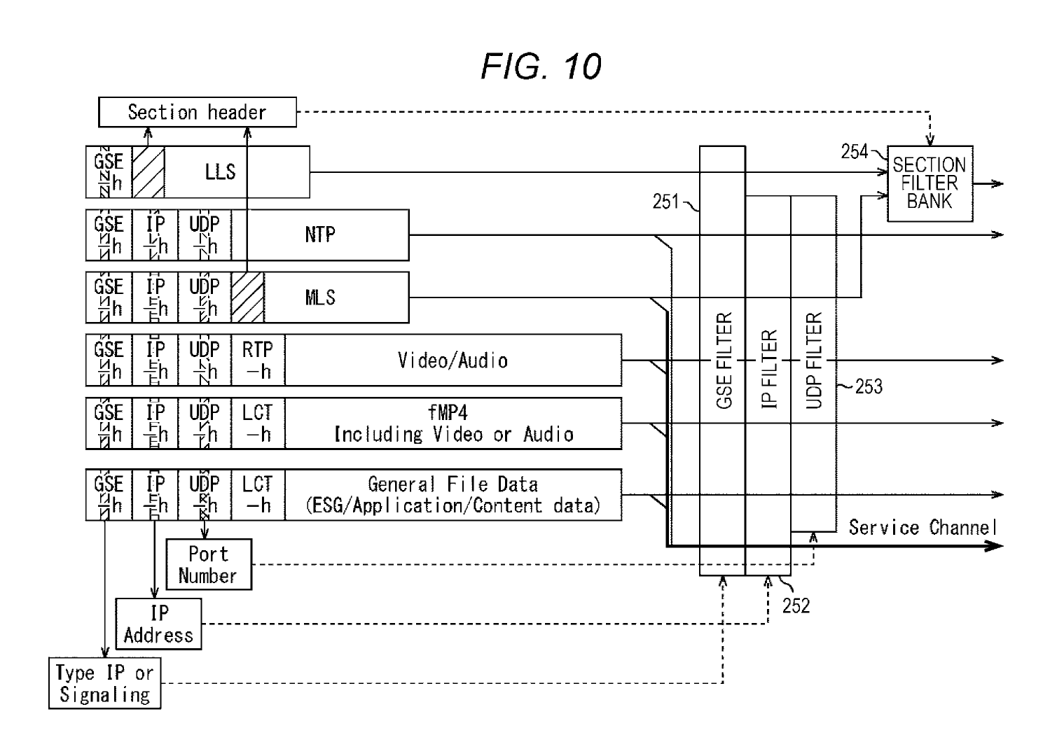

Next, details of the filtering processes of the packets in the Demux 213 of FIG. 9 will be described with reference to FIG. 10.

As illustrated in FIG. 10, in addition to various types of header information, the packets including the LLS, the NTP, the MLS, the video data, the audio data, or various file data are input as the payload in the Demux 213.

The GSE header includes type information representing IP or Signaling. The GSE filter 251 performs a filtering process based on the type information included in the GSE header. In the example of FIG. 10, since only the type information of the packet of the LLS becomes the Signaling and the other packets become the IP, only the packets of the LLS are supplied to the section filter bank 254.

In addition, the IP header includes the IP address. The IP filter 252 performs a filtering process based on the IP address included in the IP header. In the example of FIG. 10, only the IP address of the packet of the NTP is different, but the addresses of the other packets become the same address.

In addition, the UDP header includes the port number. The UDP filter 253 performs a filtering process based on the port number included in the UDP header. In the example of FIG. 10, the port numbers of the packets are different from each other. Therefore, the IP filter 252 and the UDP filter 253 performs the filtering processes using the IP address and the port number, so that all the packets may be distributed over output destinations. However, since the packets of the LLS and the packets of the MLS are supplied to the section filter bank 254, the section filter bank 254 performs a filtering process based on the Section header added to the packets, and only the packets satisfying filtering conditions are retained in a buffer memory inside the section filter bank 254, so that the packets may be drawn up intermittently from the CPU (CPU 901 of FIG. 57) by using software.

Therefore, the packets of the LLS and the packets of the MLS are output to the control signal processing unit 222. In addition, the packets of the NTP are output to the clock generator 214. In addition, the packets of the video data are output to the video decoder 215, and the packets of the audio data are output to the audio decoder 217. In addition, the packets of the data of various files are output to the FLUTE processing unit 220 or the like.

In addition, since the packets of the MLS, the video data, the audio data, and various file data which serves as the same service channel are given with the same IP address, the IP filter 252 may output the packets together with the packet of the NTP to the service package unit 224. Therefore, the service package unit 224 may package the components (Audio/Video), the time information (NTP), the control signal (MLS), and the like in units of a service channel (service). In addition, in the case of this example, since the NTP is common to a plurality of the service channels, although the NTP does not have the same IP address as the other packets, the NTP is packaged according to at least two IP addresses.

<Details of Signaling>

(Basic Signaling System)

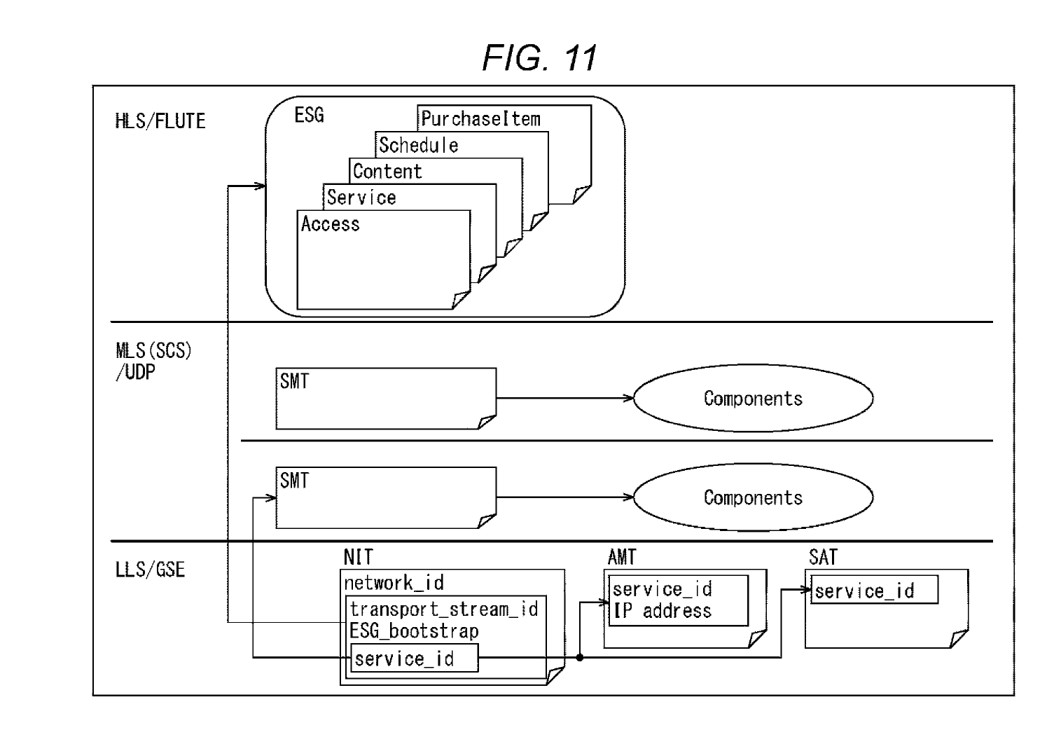

FIG. 11 is a diagram describing a basic signaling system.

As illustrated in FIG. 11, the NIT, the AMT, and the SAT are used for the LLS. The NIT and the AMT are considered to have a transmission period of, for example, one second and are acquired in the initial scan. In addition, the SAT is considered to have a transmission period of, for example, 100 milliseconds and is acquired during the service selection.

The NIT represents the configuration of the transport stream and the configuration of the service in the broadcasting network by the triplet. The network_id and the transport stream loop are arranged in the NIT, and the service loop is arranged in the transport stream loop.

The AMT represents the IP address of each service. In addition, the SAT represents the on-air service. The NIT, the AMT, and the SAT may be connected with each other by the service_id, and for example, the channel selection information may be obtained by combining the NIT and the AMT. In addition, it may be determined by using the SAT whether or not the specific service is in an on-air state.

In addition, as illustrated in FIG. 11, the SMT is used for the MLS (SCS). The SMT is considered to have a transmission period of, for example, 100 milliseconds. The SMT represents service attribute of each service in units of a service, configuration information of a component, component attribute, and filter information of the component and is prepared for each service. Namely, a component group of the specific service may be acquired by performing the filtering processes using the IP address of the AMT and the port number of the SMT.

In addition, as illustrated in FIG. 11, as the HLS, the ESG is transmitted by the FLUTE session. The ESG is an electronic service guide configured with Access, Service, Content, Schedule, PurchaseItem, and the like. Next, the ESG may be acquired from the FLUTE session by using a TSI (Transport Session Identifier) included in the ESG_bootstrap information of the NIT in addition to the IP address of the AMT and the port number of the SMT.

(Signaling System in NRT Service)

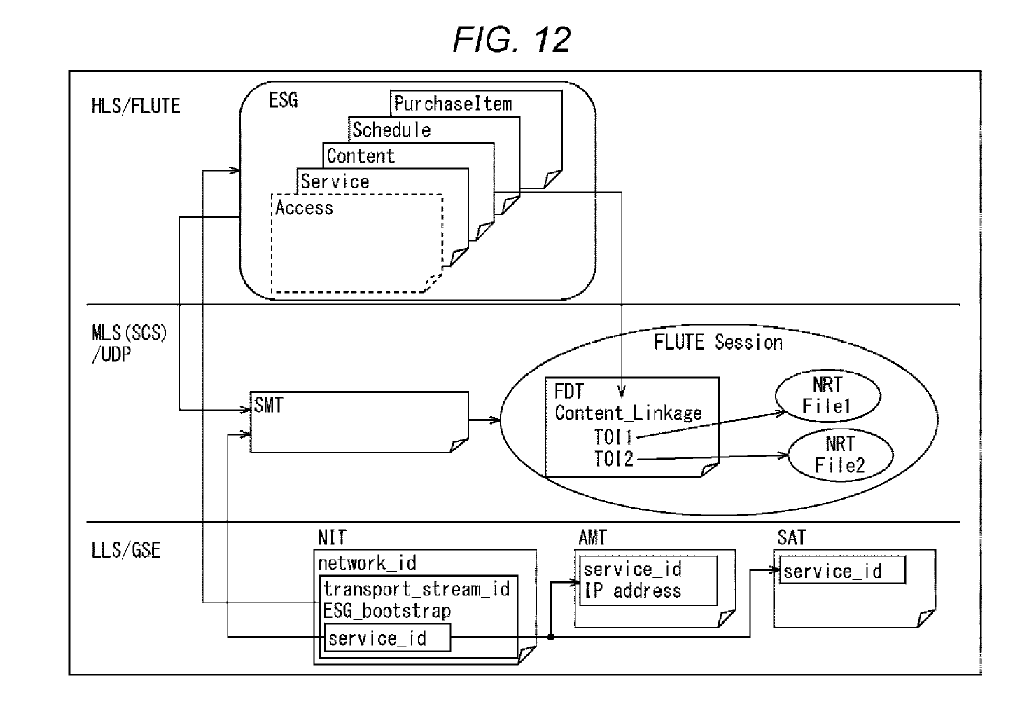

FIG. 12 is a diagram describing a signaling system in an NRT service.

Herein, the NRT service is a service where the NRT content transmitted in the NRT (Non-Real Time) broadcast is once stored in the storage 221 of the reception device 20 and the reproduction is then performed.

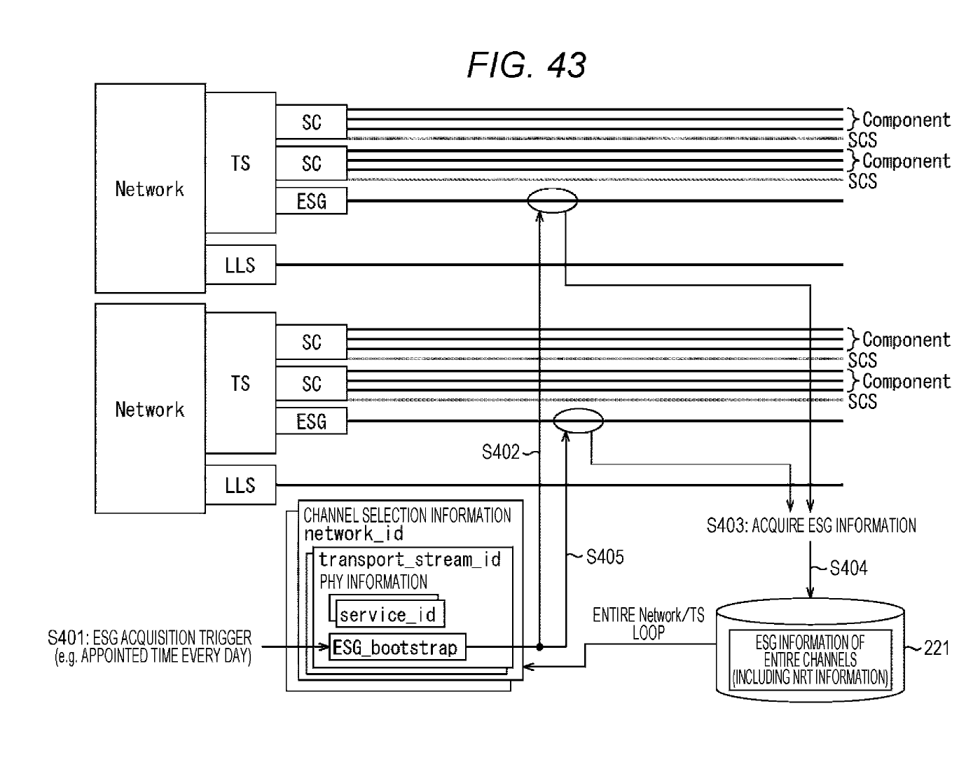

As illustrated in FIG. 12, similarly to FIG. 11, in the NRT service, the NIT, the AMT, and the SAT are used in the LLS. In addition, similarly to FIG. 11, in the NRT service, as the HLS, the ESG is transmitted by the FLUTE session. In addition, although the details are described below with reference to FIGS. 43 to 50, since, in the NRT service, the SMT of the MLS (SCS) includes the TSI, an FDT (File Delivery Table) periodically transmitted in the FLUTE session is acquired by using the TSI, and a file of the target NRT content may be acquired by referring to the index information.

(Signaling System in Hybrid Service)

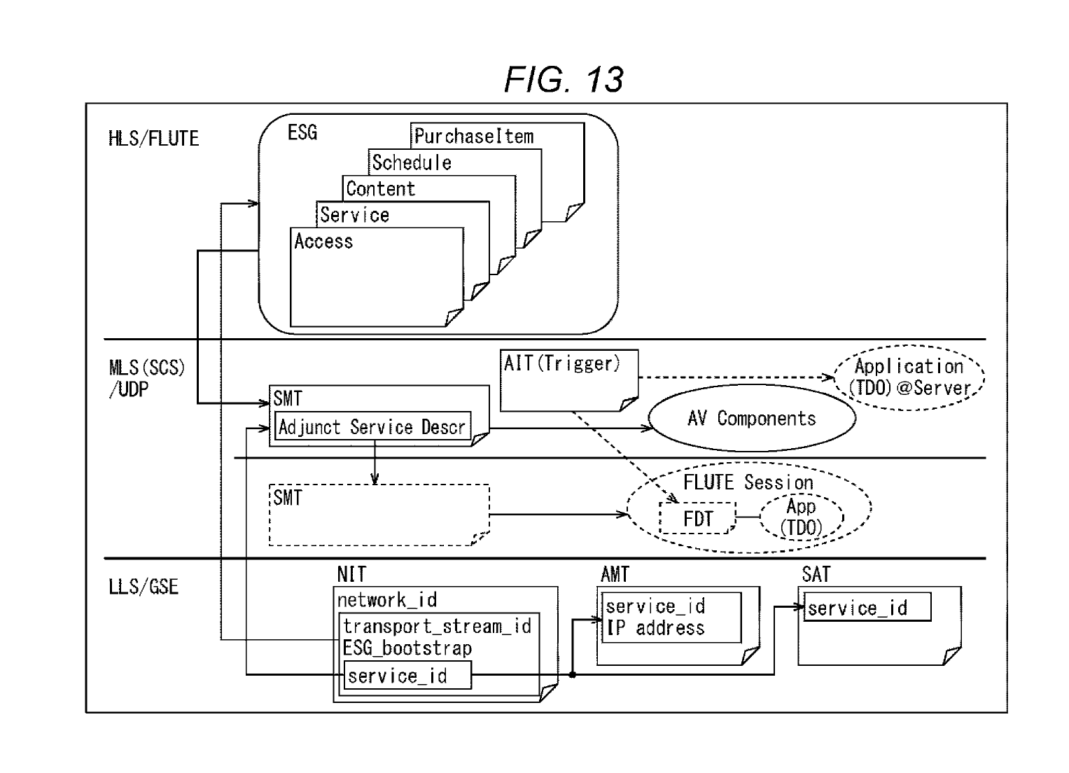

FIG. 13 is a diagram describing a signaling system in a hybrid service.

Herein, the hybrid service denotes not only a service which uses broadcast in a field of digital broadcast but also a service which cooperates with the Internet. In the hybrid service, an application delivered via the Internet may be executed in conjunction with broadcast content such as a TV program.

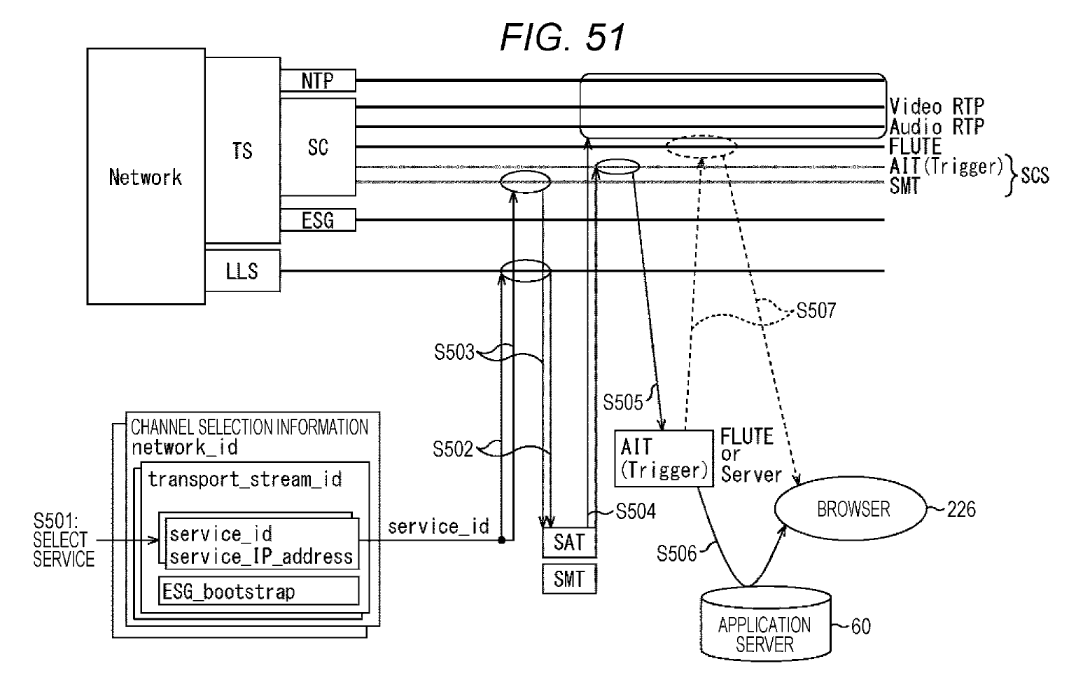

As illustrated in FIG. 13, similarly to FIG. 11, in the hybrid service, the NIT, the AMT, and SAT are used in the LLS. In addition, similarly to FIG. 11, in the hybrid service, as the HLS, the ESG is transmitted by the FLUTE session. In addition, although the details are described below with reference to FIGS. 51 to 53, in the hybrid service, since the AIT other than the SMT is used for the MLS (SCS), the application transmitted in the FLUTE session or the application supplied by the application server 50 is acquired based on the AIT and is executed in conjunction with the TV program or the like.

<Detailed Structure of LLS>

(Data Structure of NIT)

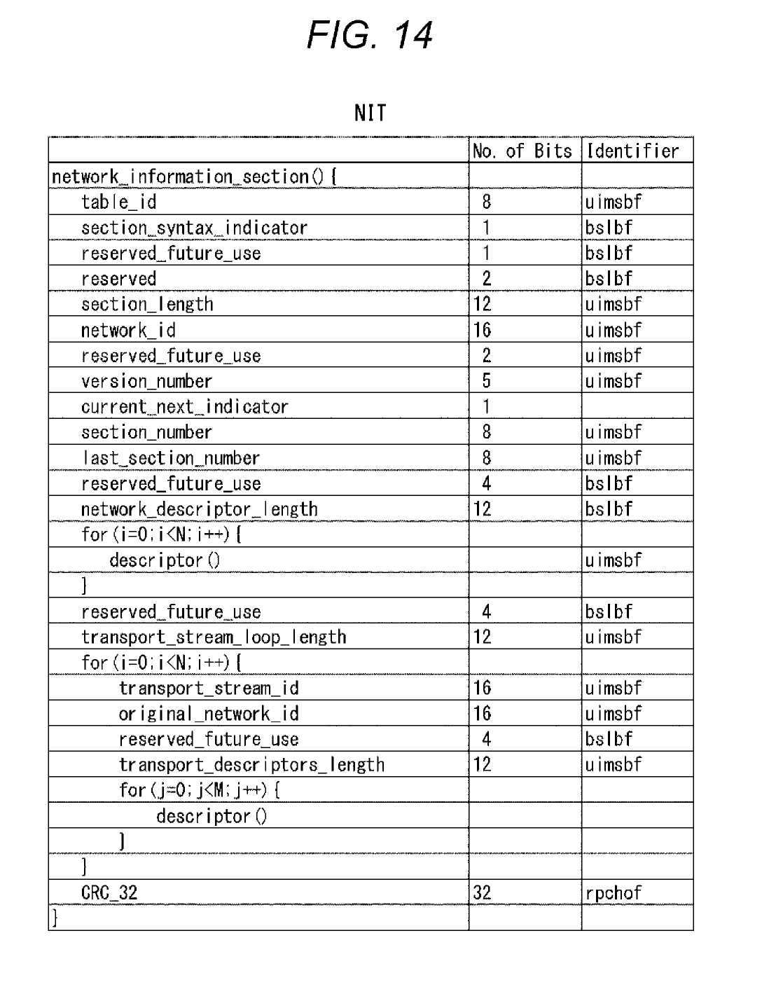

FIG. 14 is a diagram illustrating a data structure of an NIT.

Table_id represents table identification. Section_syntax_indicator is a 1-bit field and is designated with a fixed value. Section_length represents a section length.

Network_id represents network identification and serves as a label for identifying a distribution system represented by the NIT by distinguishing the distribution system from other distribution systems.

Version_number represents a version number. Current_next_indicator represents a current next indicator. Section_number represents a section number. Last_section_number represents the last section number.

Network_descriptors_length represents a network descriptor length. Transport_stream_loop_length represents a transport stream loop length.

Transport_stream_id represents transport stream identification. Original_{—} network_id represents original network identification. Transport_descriptors_length represents a transport descriptor length.

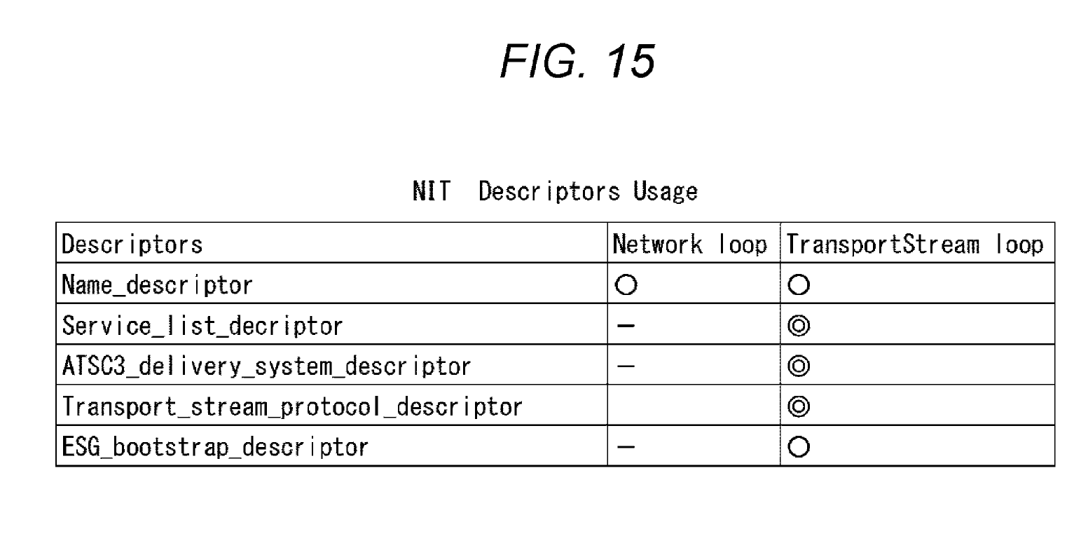

FIG. 15 is a diagram illustrating an example of descriptors arranged in a loop of the NIT of FIG. 14.

As illustrated in FIG. 15, Name_descriptor is arranged in a network loop of the NIT as necessary. In addition, Service_list_descriptor, ATSC3_delivery_system_descriptor, and Transport_stream_protocol_descriptor are necessarily arranged in a transport stream loop of the NIT, and the Name_descriptor and ESG_bootstrap_descriptor are arranged as necessary.

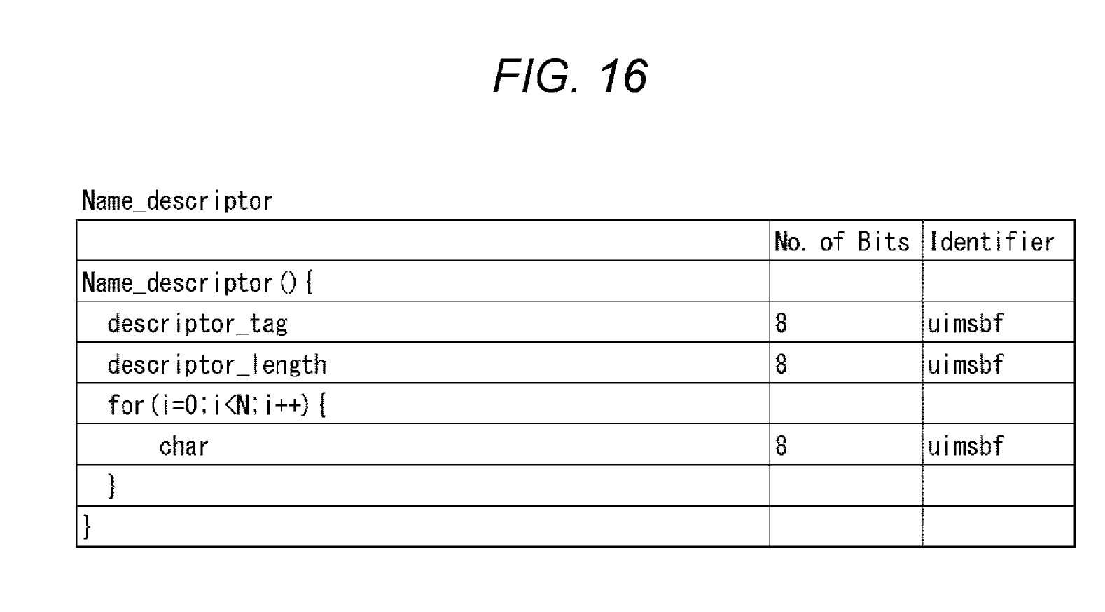

As illustrated in FIG. 16, the Name_descriptor provides a name by a character symbol. In FIG. 16, the char represents the character symbol, and a predetermined name is written.

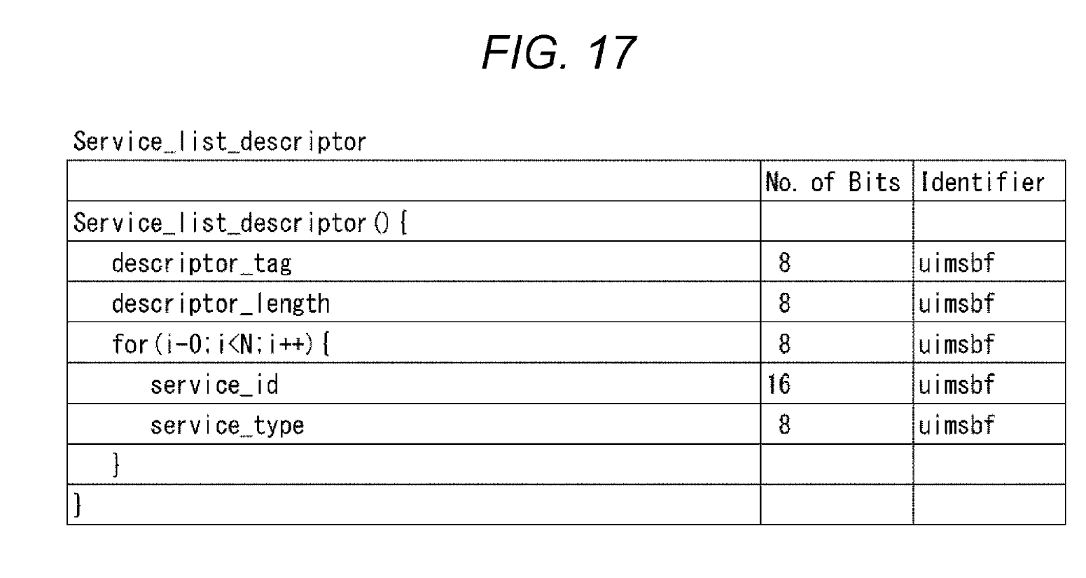

As illustrated in FIG. 17, the Service_list_descriptor provides a list of service according to the service identification and a type of a service form. In FIG. 17, the Service_id represents service identification. In addition, the service_type represents a type of the service form.

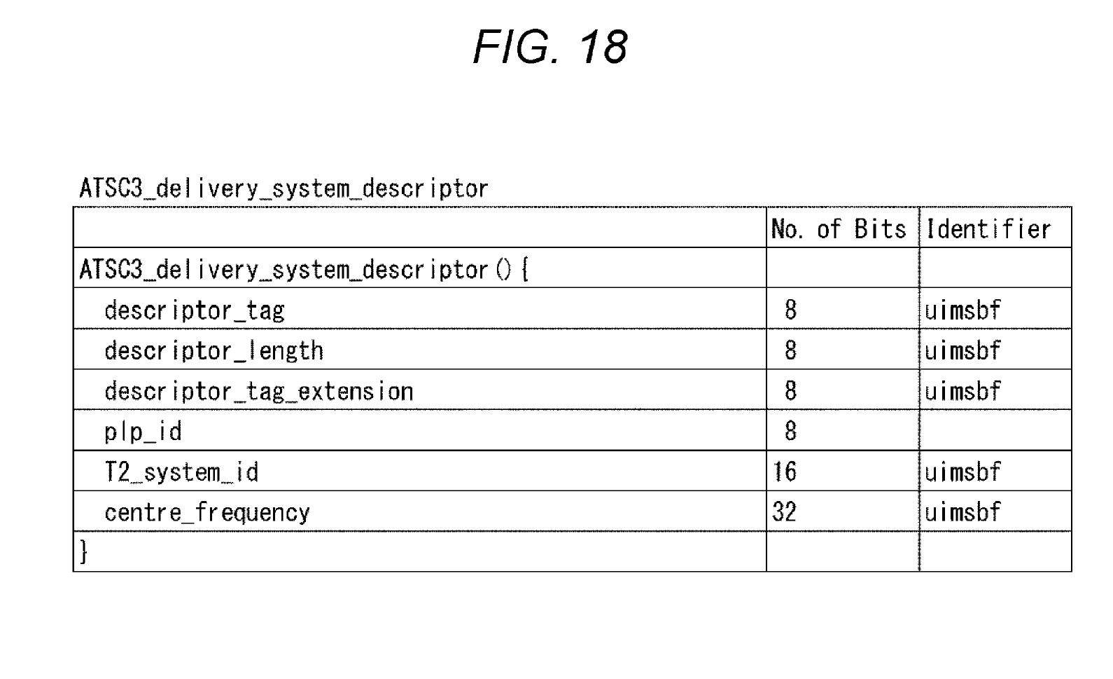

As illustrated in FIG. 18, the ATSC3_delivery_system_descriptor provides physical information for performing the channel selection process. In FIG. 18, plp_id represents plp identification. In addition, T2_system_id represents system identification. Centre_frequency represent a frequency.

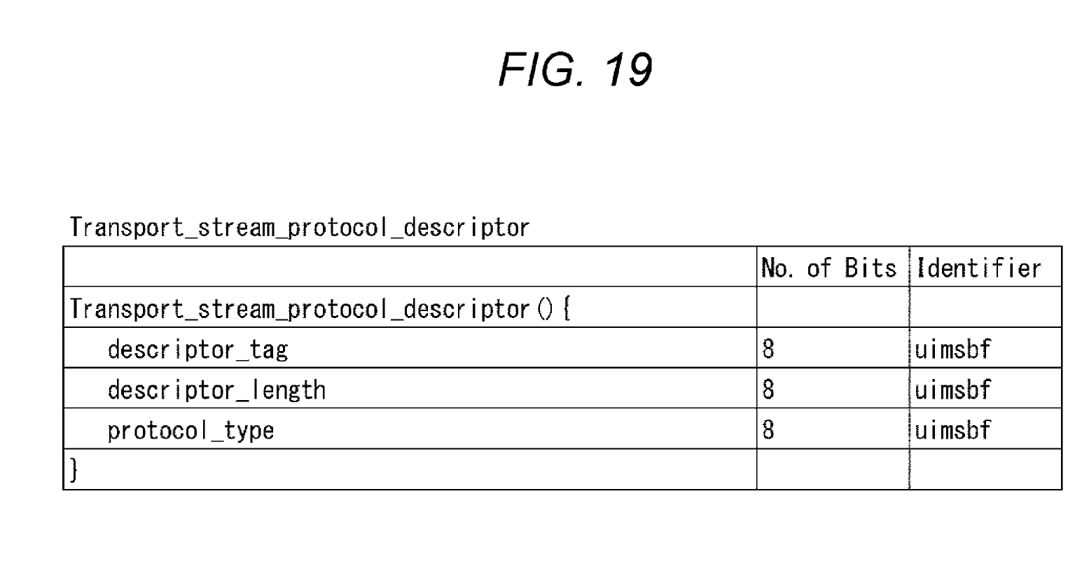

As illustrated in FIG. 19, the Transport_stream_protocol_descriptor provides a type of the protocol of the transport stream. In FIG. 19, protocol_type represents a type of a protocol form. For example, in a case where the protocol_type is designated with ‘0’, the MPEG2-TS may be considered to be represented; in a case where the protocol_type is designated with ‘1’, the IPv4 may be considered to be represented; and in a case where the protocol_type is designated with ‘2’, the IPv6 may be considered to be represented.

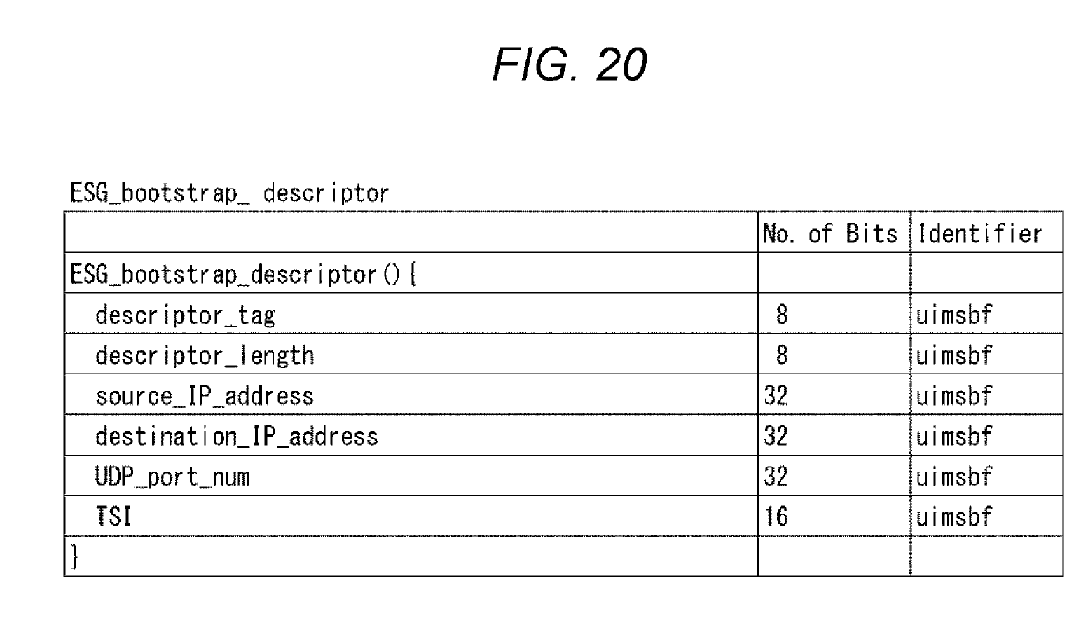

As illustrated in FIG. 20, the ESG_bootstrap_descriptor provides information for acquiring the ESG transmitted by the FLUTE session. In FIG. 20, source_IP_address and destination_IP_address represent an IP address of a transmission source (source) and an IP address of a destination (destination). UDP_port_num represents a port number of the UDP. The TSI represents a TSI in the FLUTE session.

(Data Structure of AMT)

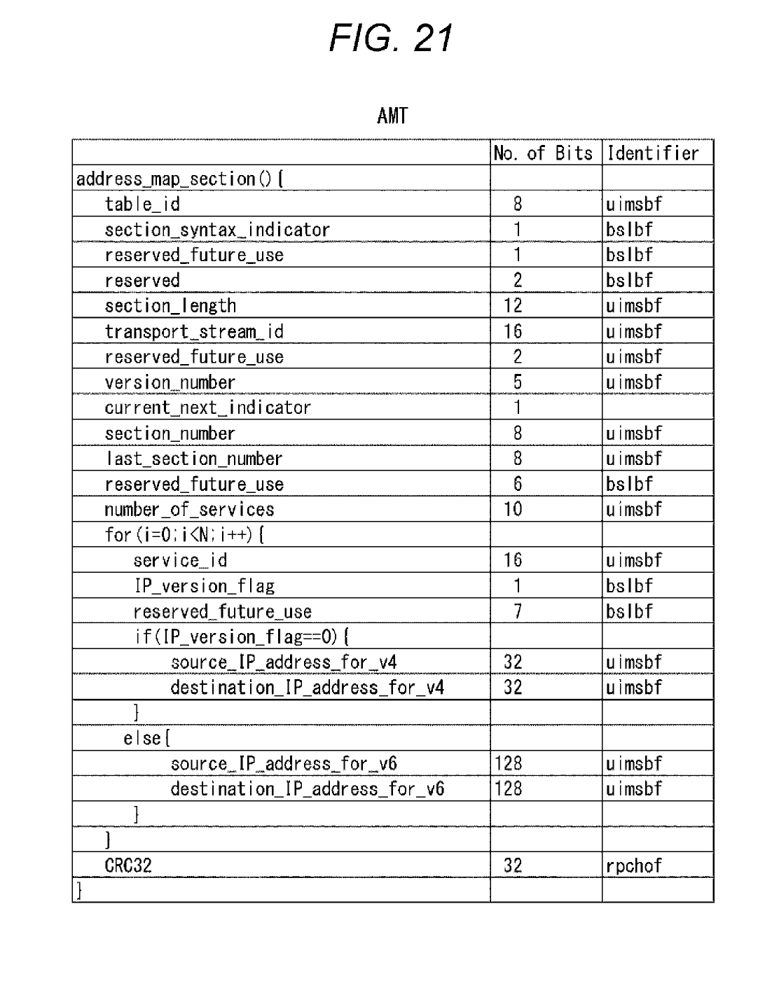

FIG. 21 is a diagram illustrating a data structure of an AMT.

Table_id represents table identification. A section_syntax_indicator is a 1-bit field and is designated with a fixed value. Section_length represents a section length.

Transport_stream_id represents transport stream identification. Version_number represents a version number. Current_next_indicator represents a current next indicator. Section_number represents a section number. Last_section_number represents the last section number. Number_of_services represents the number of services.

Service_id represents service identification. IP_version_flag represents a flag of IP version. For example, in a case where the IP_version_flag is designated with ‘0’, the IPv4 may be considered to be represented; in a case where the IP_version_flag is designated with ‘1’, the IPv6 may be considered to be represented.

Source_IP_address_for_v4 and destination_IP_address_for_v4 represent an IP address of a transmission source (source) and an IP address of a destination (destination) for version 4. In addition, source_IP_address_for_v6 and destination_IP_address_for_v6 represent an IP address of a transmission source (source) and an IP address of a destination (destination) for version 6.

In addition, in the AMT, in a case where service_id=‘0xFFFF’ is designated, instead of the service, the IP address of the NTP packet is considered to be represented.

(Data Structure of SAT)

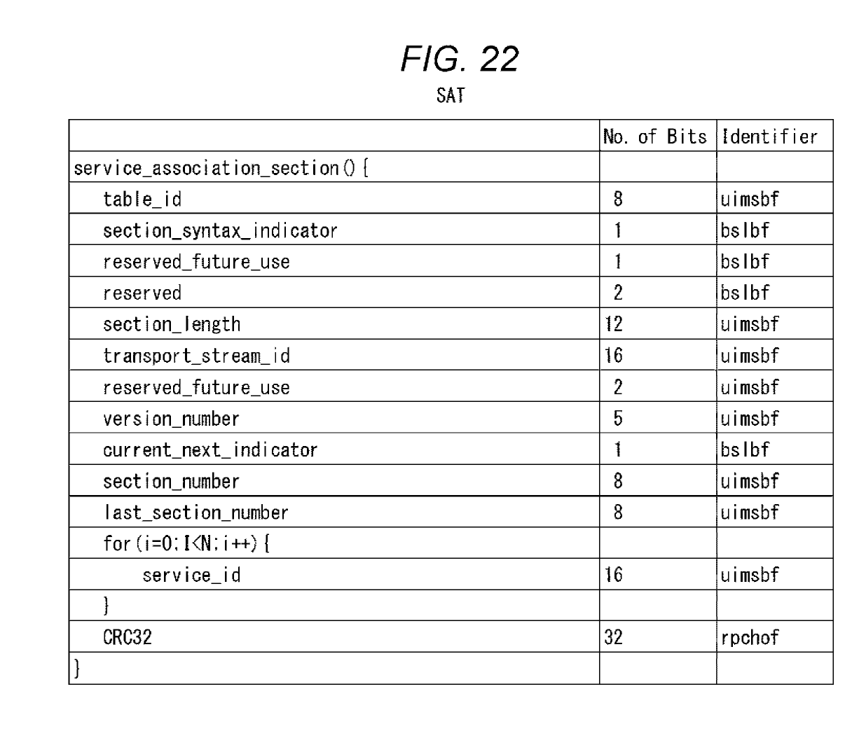

FIG. 22 is a diagram illustrating a data structure of an SAT.

Table_id represents table identification. A section_syntax_indicator is a 1-bit field and is designated with a fixed value. Section_length represents a section length.

Transport_stream_id represents transport stream identification. Version_number represents a version number. Current_next_indicator represents a current next indicator. Section_number represents a section number. Last_section_number represents the last section number.

Service_id represents service identification.

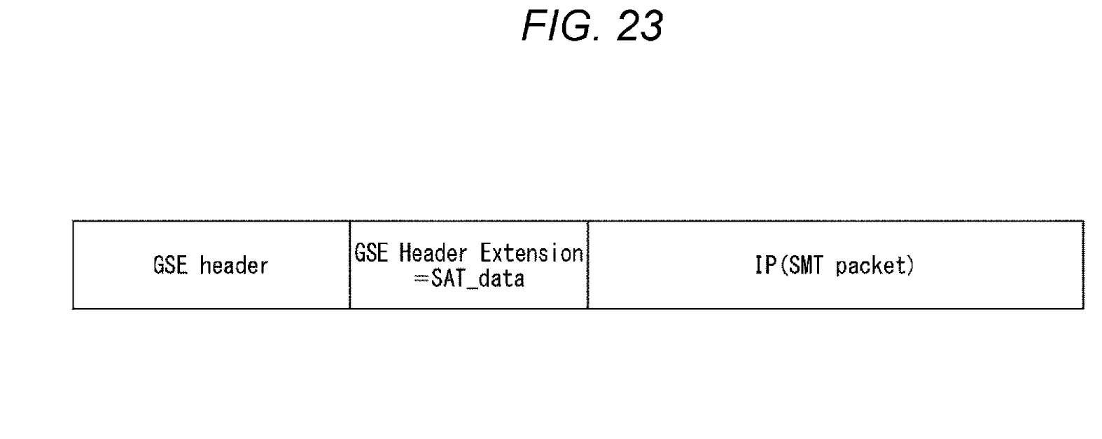

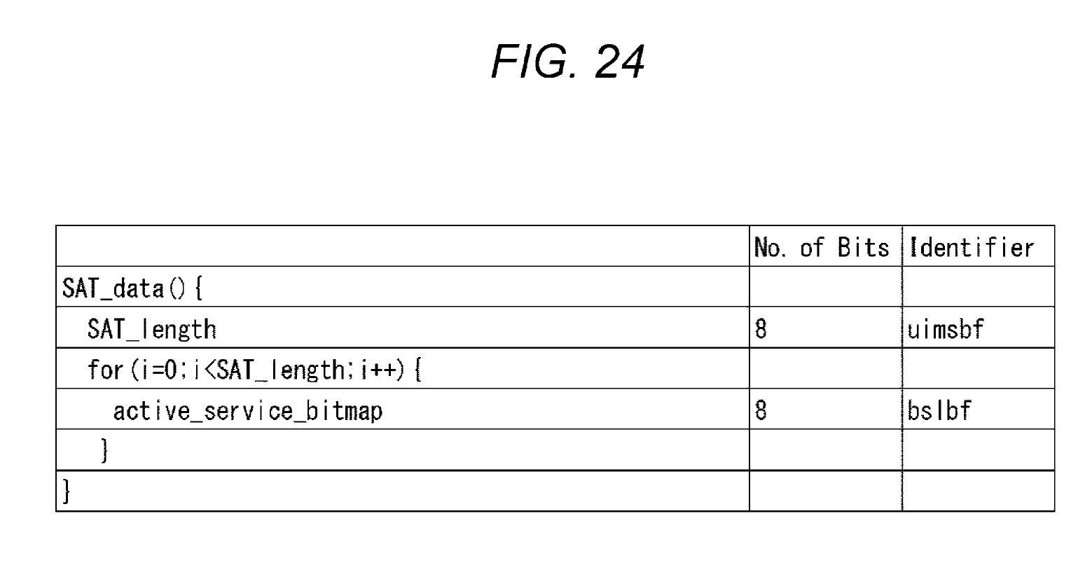

In addition, as illustrated in FIG. 23, instead of the SAT as a table, SAT_data as a structure may be arranged in the extension area of the GSE header. As illustrated in FIG. 24, similarly to the SAT, the SAT_data provides the on-air service. For example, in the SAT_data, although the active_service_bitmap is configured with 8 bits, the on-air service may be represented by associating the bits with the order of the list of the service_id written in the Service_list_descriptor of the NIT.

However, it is not necessary to arrange the SAT_data in the extension areas of the GSE headers of all the packets, and for example, as illustrated in FIG. 23, the SAT_data may be arranged in the extension area of only the GSE header of the packet of the SMT.

<Detailed Structure of MLS>

(Data Structure of SMT)

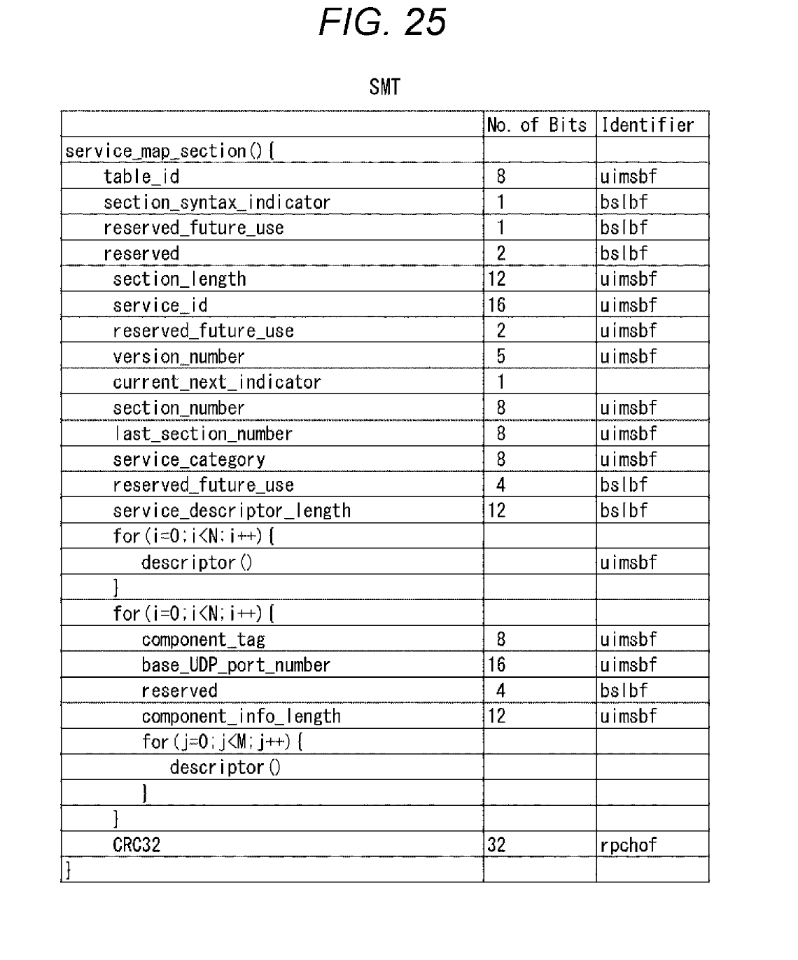

FIG. 25 is a diagram illustrating a data structure of an SMT.

Table_id represents table identification. A section_syntax_indicator is a 1-bit field and is designated with a fixed value. Section_length represents a section length.

Service_id represents service identification. Version_number represents a version number. Current_next_indicator represents a current next indicator. Section_number represents a section number. Last_section_number represents the last section number. Service_category represents a category of service.

Service_descriptor_length represents a service descriptor length. Base_UDP_port_number represents a port number of the RTP. In addition, the port number of the RTCP (RTP Control Protocol) is, for example, the next value of the value of the port number of the RTP. Component_info_length represents a component information length.

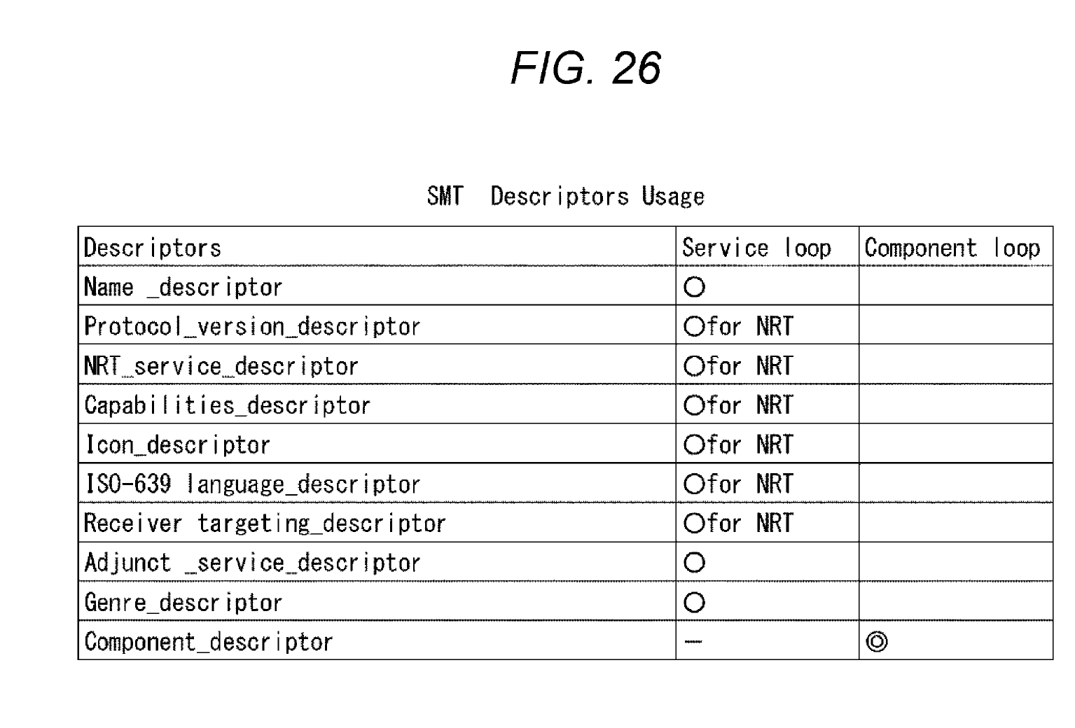

FIG. 26 is a diagram illustrating an example of descriptors arranged in a loop of the SMT of FIG. 25.

As illustrated in FIG. 26, Name_descriptor, Protocol_version_descriptor, NRT_service_descriptor, Capabilities_descriptor, Icon_descriptor, ISO-639 language_descriptor, Receiver_targeting_descriptor, Adjunct_service_descriptor, and Genre_descriptor are arranged in the service loop of the SMT as necessary. In addition, Component_descriptor for supplying information necessary for each component is typically arranged in a component loop of the SMT.

<Detailed Operation Example>

Next, detailed operation examples of a reception device employing the present disclosure will be described. The description will be made according to the following order.

1. Basic Operations

(1) Scan

(2) Channel Selection

(3) Recording

2. Adaptation to NRT Service

3. Adaptation to Hybrid Service

<1. Basic Operations>

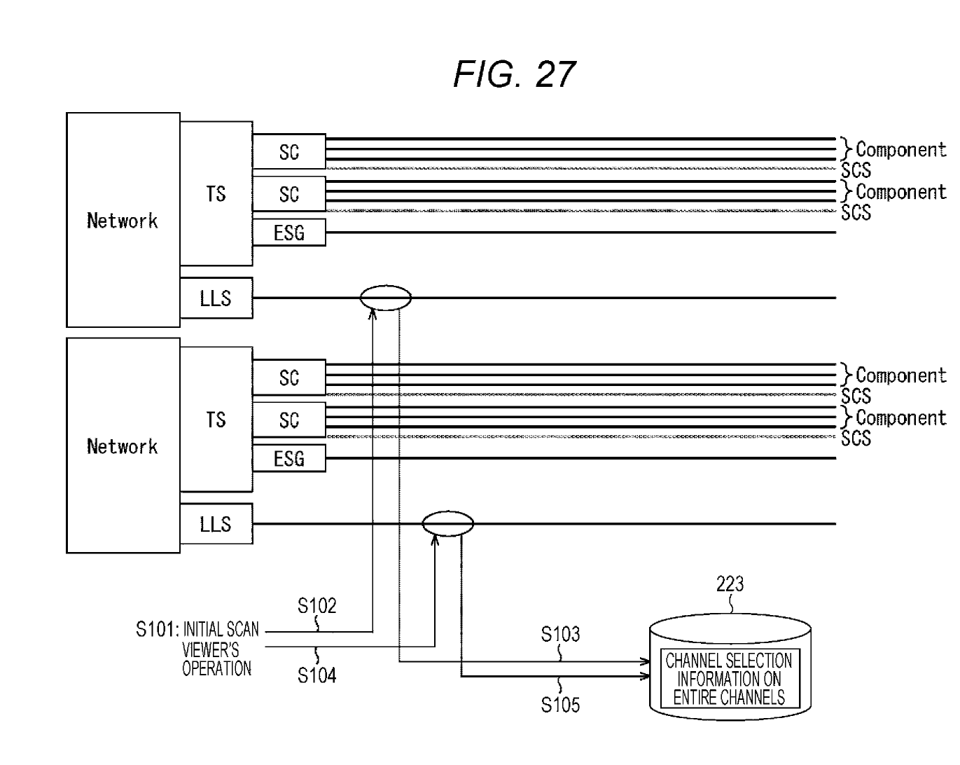

First, basic operations of the reception device 20 will be described with reference to FIGS. 27 to 42. In addition, the signaling in the basic operations is the same as that described with reference to FIG. 11.

(1) Scan

(1-1) Initial Scan

An initial scan process performed in order to set a receivable channel in the case of initially starting up the reception device 20 or the like will be described with reference to FIGS. 27 to 29.

FIG. 27 is a diagram describing the initial scan process.

As illustrated in FIG. 27, in the reception device 20, in a case where start instruction of initial scan by viewer's operation or the like is detected (S101), the NIT and the AMT which are transmitted as the LLS in a predetermined transmission period are acquired, and the channel selection information which is obtained from the control signals is recorded in the NVRAM 223 (S102 and S103). The scan process is repeated for each broadcasting network, and the channel selection information for the entire channels is recorded in the NVRAM 223 (S104 and S105).

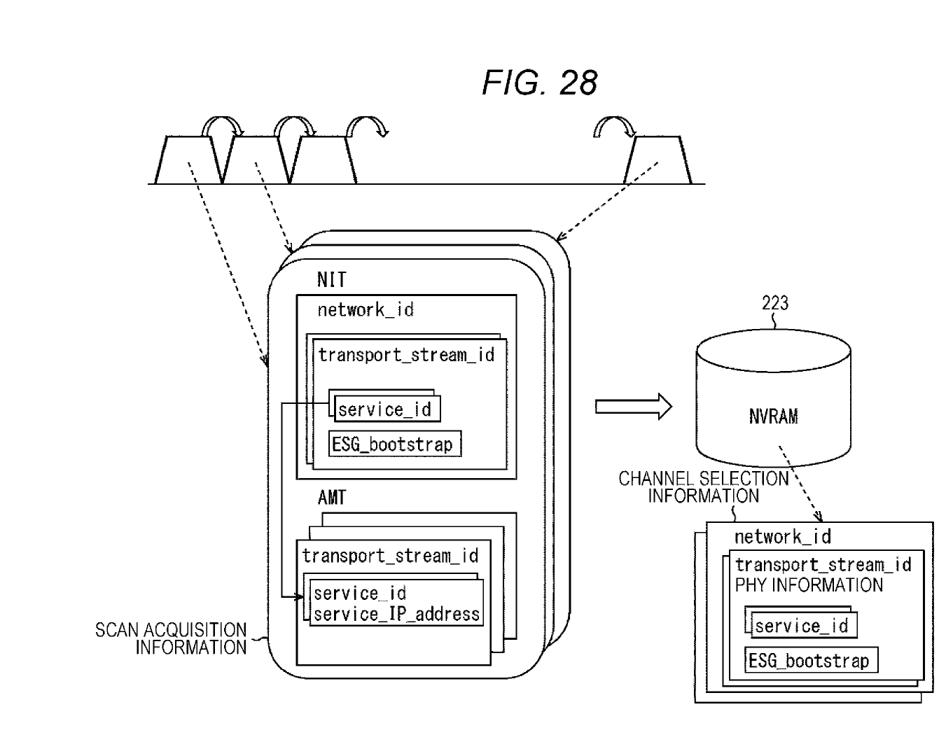

More specifically, as illustrated in FIG. 28, the NIT represents the configuration of the transport stream and the configuration of the service in the broadcasting network, and the configurations are identified by using a triplet. In addition, the AMT represents settings of the IP addresses in units of a service in each transport stream. Therefore, in a case where the IP address in each service is configured to be fixed, the channel selection information which is obtained by combining the NIT and the AMT acquired as the scan acquisition information is designated with the IP address (service_IP_address) corresponding to each service_id. In addition, although all the details are not written in the example of FIG. 28, the channel selection information includes, for example, information written in the NIT and the AMT such as information on the physical layer or ESG_bootstrap information.

In this manner, the channel selection information for the entire channels is acquired by sequentially combining the NIT and AMT which are obtained as the scan acquisition information in each broadcasting network by the initial scan process, and the channel selection information is recorded in the NVRAM 223.

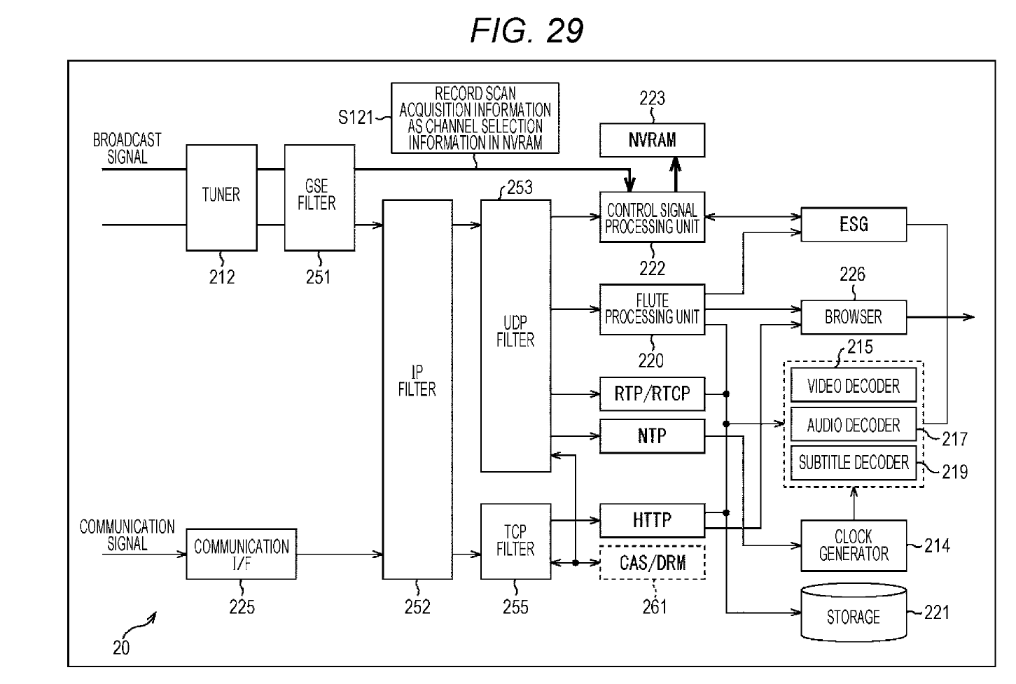

FIG. 29 is a diagram illustrating operations of the reception device 20 during the initial scan.

As illustrated in FIG. 29, in the reception device 20 during the initial scan, broadcast signals of a first channel are extracted and demodulated by the tuner 212, and the resultant data in a section format are supplied to the GSE filter 251 (S121). The GSE filter 251 and the section filter bank 254 (not illustrated) perform a filtering process to extract the NIT and the AMT from the data from the tuner 212 and supply the NIT and the AMT as the scan acquisition information to the control signal processing unit 222 (S121). The control signal processing unit 222 records the channel selection information which is obtained by combining the NIT and the AMT in the NVRAM 223 (S121).

In this manner, the channel selection information of the first broadcasting network is recorded in the NVRAM 223, and similarly, the process of S121 of FIG. 29 is repeated, so that channel selection information which is obtained from the second to N-th (N is an integer of 1 or more) broadcasting networks is recorded in the NVRAM 223. Therefore, the channel selection information on the entire receivable channels which can perform reception is retained. In addition, a TCP filter 255 is a filter for TCP (Transmission Control Protocol). In addition, a CAS/DRM 261 performs a process regarding a copyright of content.

(1-2) ESG Acquisition

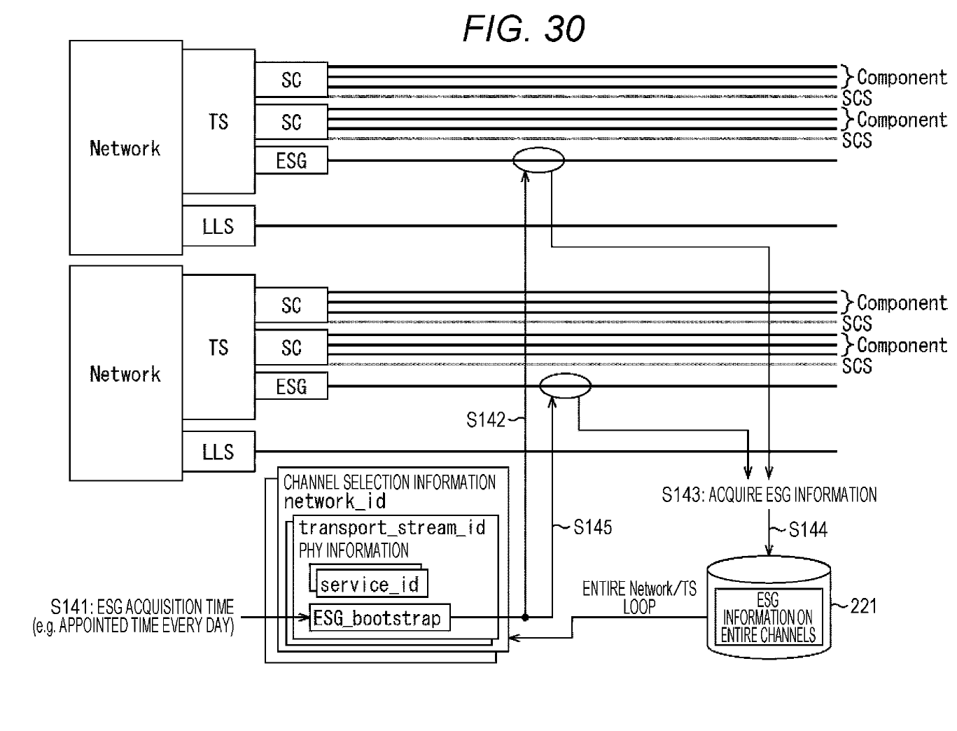

An ESG acquisition process performed in order to acquire an ESG (Electronic Service Guide) at the time of power-off of the reception device 20 will be described with reference to FIGS. 30 to 32.

FIG. 30 is a diagram describing the ESG acquisition process.

As illustrated in FIG. 30, in the reception device 20, for example, when an ESG acquisition time such as an appointed time every day elapses, the channel selection information recorded in the NVRAM 223 is read (S141). Since the channel selection information includes the ESG_bootstrap information, ESG information is acquired by accessing the ESG session among the FLUTE session according to the ESG_bootstrap information (S142 and S143). The ESG information is recorded in the storage 221 (S144). The ESG acquisition process is repeated for each broadcasting network, and the ESG information for the entire channels is recorded in the storage 221 (S145, S143, and S144).

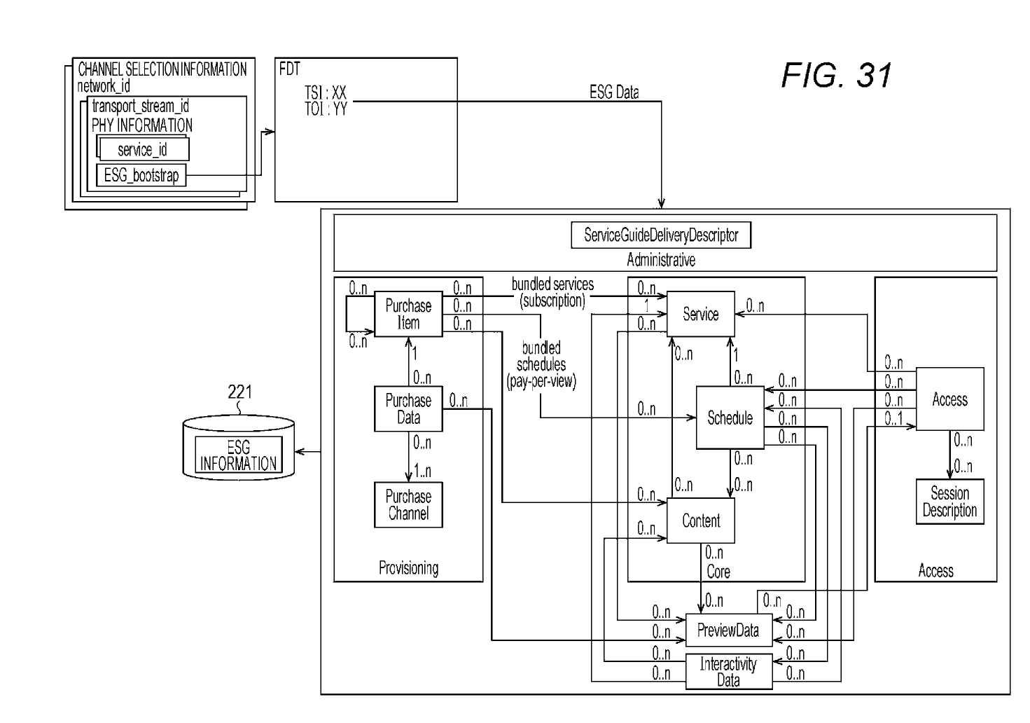

In the FLUTE session, a specific file is designated with two pieces of identification information of a TSI (Transport Session Identifier) and a TOI (Transport Object Identifier). Herein, since the ESG_bootstrap information includes the TSI, an FDT which is periodically transmitted may be acquired by using the TSI. Namely, the FDT (File Delivery Table) as a file of TOI=0 is transmitted for each TSI, and index information of each TSI is written in the FDT. Therefore, as illustrated in FIG. 31, the ESG information which is configured with Service, Schedule, Content, Access, and the like may be generated from the file transmitted in the ESG session by referring to the index information of the FDT and may be recorded in the storage 221.

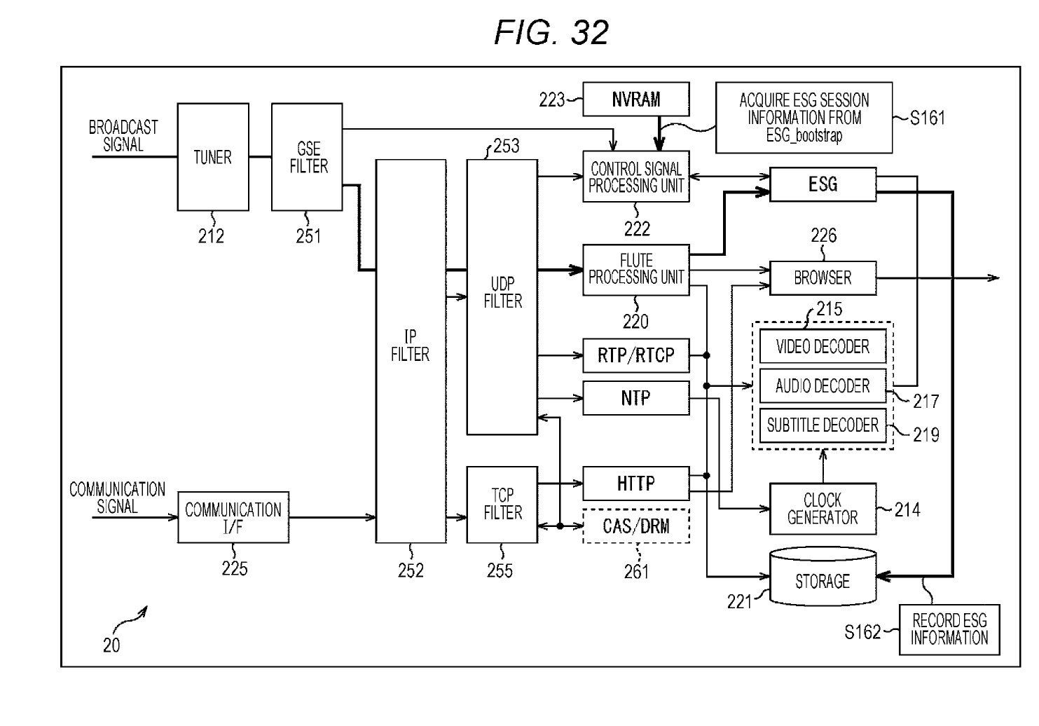

FIG. 32 is a diagram illustrating operations of the reception device 20 during the ESG acquisition.

As illustrated in FIG. 32, in the reception device 20 during the ESG acquisition, the control signal processing unit 222 reads the channel selection information recorded in the NVRAM 223 to acquire the TSI included in the ESG_bootstrap information as ESG session information (S161). The FLUTE processing unit 220 acquires the FDT according to the ESG session information from the control signal processing unit 222 and acquires the file transmitted by the ESG session by referring to the index information. The FLUTE processing unit 220 generates ESG information from the file transmitted by the ESG session and records the ESG information in the storage 221 (S162).

In this manner, the ESG information of the first broadcasting network is recorded in the storage 221, and similarly, the processes of S161 and S162 of FIG. 32 are repeated, so that the ESG information for the entire channels which can be designated with the channel selection information recorded in the NVRAM 223 is retained.

(2) Channel Selection

(2-1) Direct Channel Selection

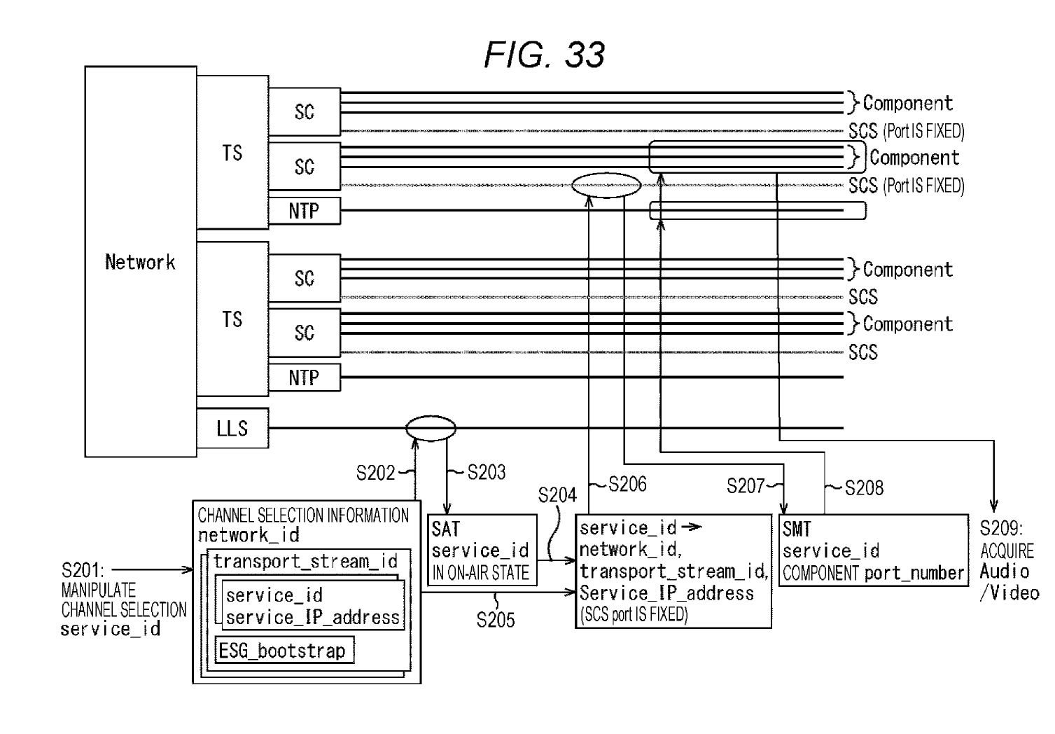

A direct channel selection process performed in the case of directly selecting a specific channel (service) by viewer's operation of a remote controller will be described with reference to FIGS. 33 to 35.

FIG. 33 is a diagram describing the direct channel selection process.

As illustrated in FIG. 33, in the reception device 20, in a case where viewer's operation of channel selection is detected, the channel selection information recorded in the NVRAM 223 is read (S201). In addition, in the reception device 20, the SAT transmitted as the LLS in a predetermined transmission period is acquired, and the service_id of the on-air service is acquired (S202 and S203). Next, the service_id of the specific service selected by the viewer and the service_id of the service included in the SAT are cross-checked, and it is determined whether or not the specific service is in an on-air state (S204).

In a case where the specific service is in the on-air state, since the network_id, the transport_stream_id, and the service_IP_address are specified from the service_id of the selected service according to the channel selection information, the SMT transmitted as the SCS in a predetermined transmission period is acquired by performing the filtering processes using the IP address and the port number (S205 to S207). However, in this example, the port number of the SCS is predefined by a fixed value according to a predetermined standard or the like.

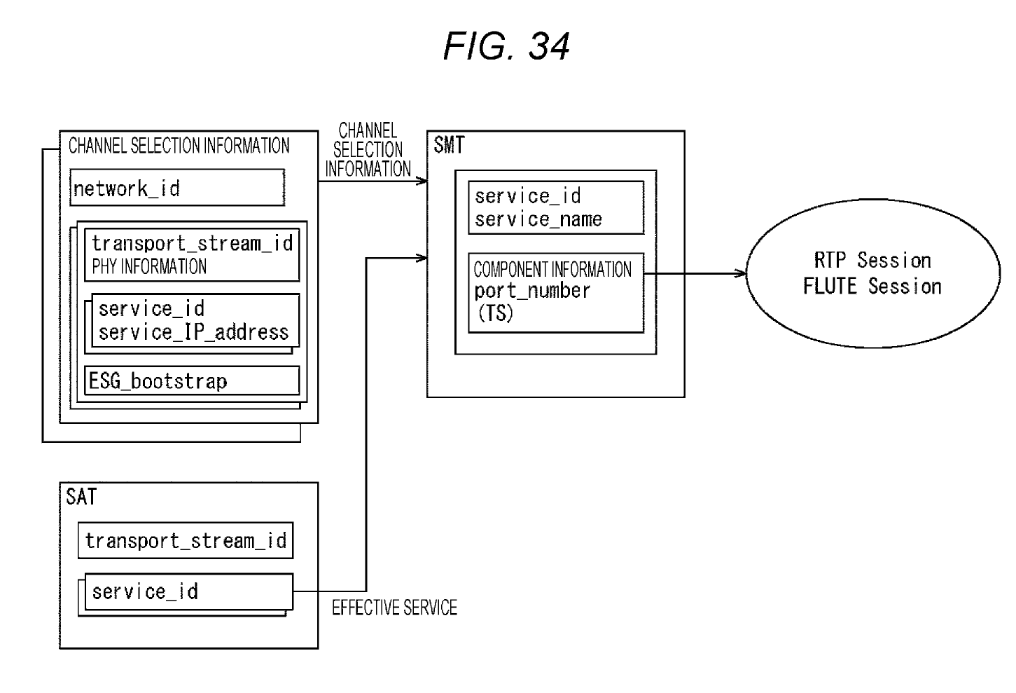

The SMT includes attribute or configuration information of components such as port numbers of the components. Therefore, as illustrated in FIG. 34, the components of the specific service or the time information (NTP) which is common to a plurality of the services may be acquired from the RTP session or the FLUTE session by performing the filtering processes using the IP address obtained from the channel selection information and the port number included in the SMT.

In the example of FIG. 33, the video data and the audio data are acquired as the components from the RTP session (S208 and S209). The video data and the audio data which are acquired in this manner are decoded according to a clock signal based on the NTP.

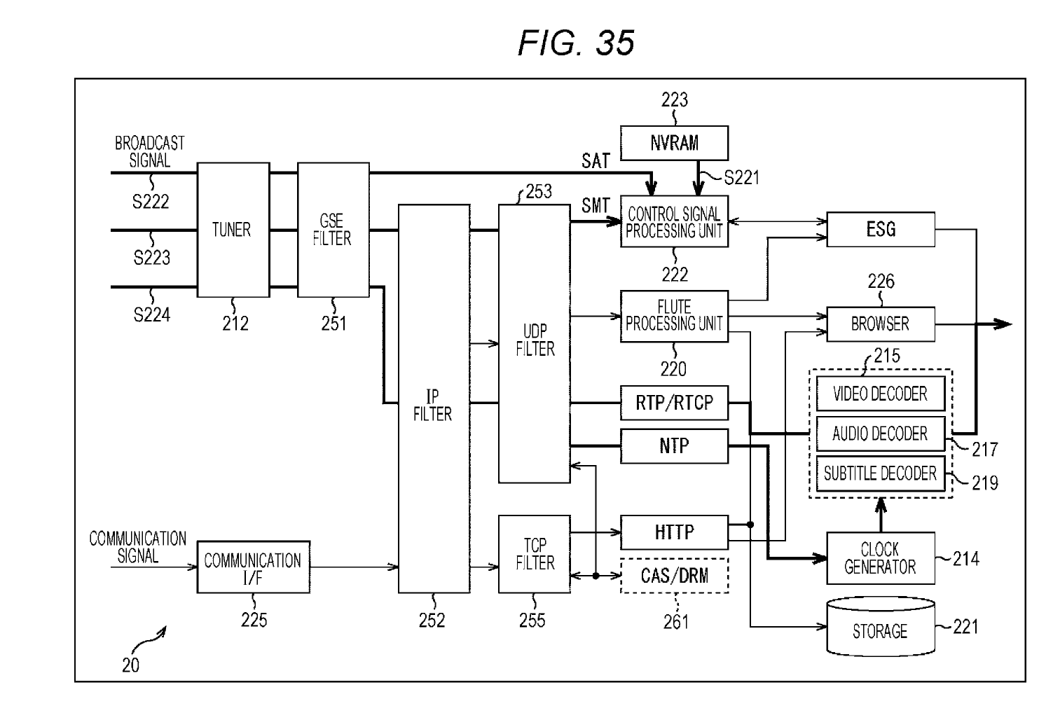

FIG. 35 is a diagram illustrating operations of the reception device 20 during the direct channel selection.

As illustrated in FIG. 35, in the reception device 20 during the direct channel selection, the control signal processing unit 222 reads the channel selection information recorded in the NVRAM 223 (S221). The tuner 212 performs the channel selection process corresponding to the channel selection information according to the control of the control signal processing unit 222. In addition, the control signal processing unit 222 acquires the SAT extracted by the filtering processes of the GSE filter 251 and the section filter bank 254 (not illustrated) and determines whether or not the specific service selected by the viewer is in an on-air state (S222).

In a case where the specific service is in the on-air state, the filtering processes using the IP address and the port number are performed by the IP filter 252 and the UDP filter 253, so that the control signal processing unit 222 acquires the SMT (S223). In addition, in the example of FIG. 35, since the components are transmitted by the RTP session, the IP filter 252 and the UDP filter 253 perform the filtering processes using the IP address and the port number and supply the NTP, the video data, and the audio data to the clock generator 214, the video decoder 215, and the audio decoder 217, respectively (S224).

The clock generator 214 generates a clock signal based on the NTP from the UDP filter 253 and supplies the clock signal to the video decoder 215 and the audio decoder 217 (S224). The video decoder 215 decodes the video data from the UDP filter 253 according to the clock signal from the clock generator 214 and supplies the decoded video data to the video output unit (not illustrated) 216 (S224). The audio decoder 217 decodes the audio data from the UDP filter 253 according to the clock signal from the clock generator 214 and supplies the decoded audio data to the audio output unit 218 (not illustrated) (S224). Therefore, the video of the TV program corresponding to the specific service selected by the viewer is displayed on the display, and the audio corresponding to the video is output from the speaker.

(2-2) ESG Channel Selection

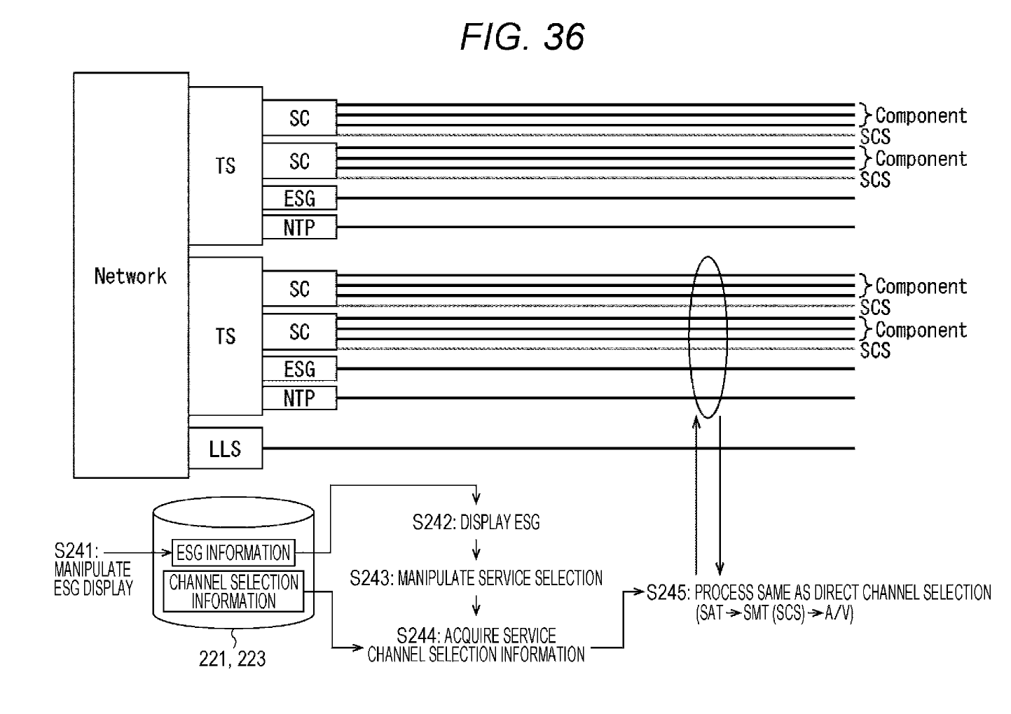

An ESG channel selection process performed in the case of selecting a specific service from the ESG (electronic service guide) by viewer's operation of a remote controller will be described with reference to FIGS. 36 to 38.

FIG. 36 is a diagram describing the ESG channel selection process.

As illustrated in FIG. 36, in the reception device 20, in a case where viewer's operation of display of the ESG is detected, the ESG information is read from the storage 221 (S241), and the ESG information is displayed on the display (S242). Therefore, the viewer selects the specific service, which the viewer wants to view, from the service list displayed on the display. In a case where viewer's operation of selection of the specific service is detected (S243), the reception device 20 reads the channel selection information from the NVRAM 223 and performs the channel selection process (S244).

In addition, in the reception device 20, the components or the time information (NTP) of the specific service are acquired by performing the same filtering process as the direction channel selection process of FIG. 33 (S245).

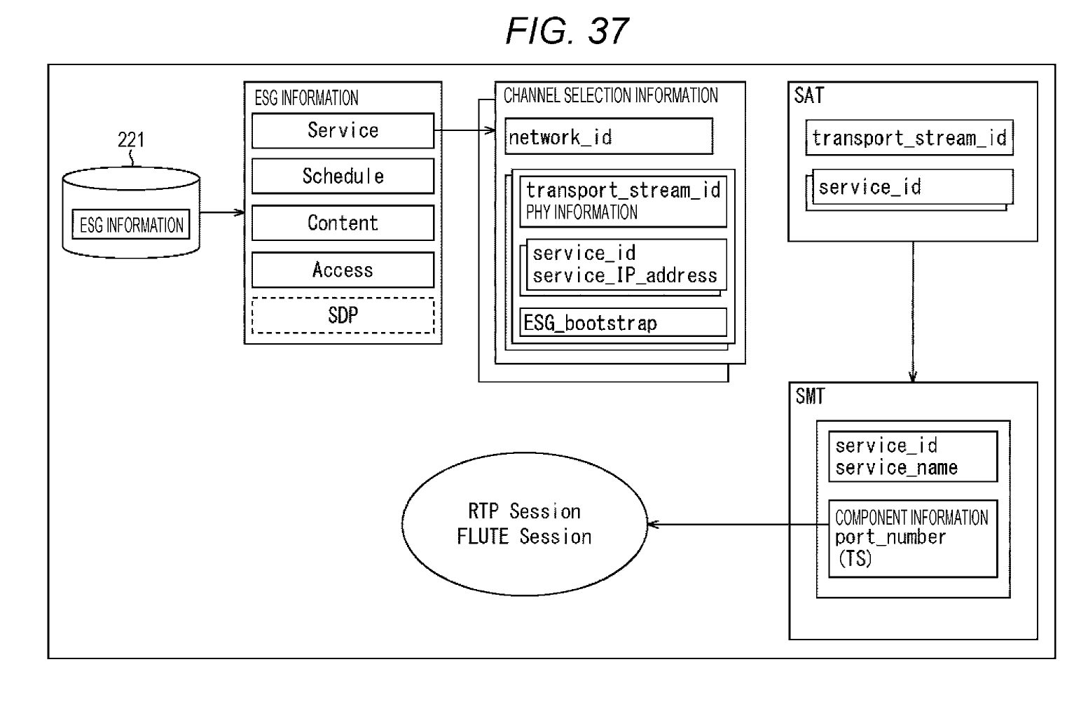

More specifically, as illustrated in FIG. 37, first, it is determined by using the SAT transmitted as the LLS in a predetermined transmission period whether or not the specific service is in an on-air state. Next, in a case where the specific service is in the on-air state, since the IP address is specified by the channel selection information, the SMT transmitted as the SCS in a predetermined transmission period is acquired by performing the filtering processes using the IP address and the fixed port number. In addition, the components of the specific service or the time information (NTP) which is common to a plurality of services may be acquired from the RTP session or the FLUTE session by performing the filtering processes using the IP address obtained from the channel selection information and the port number obtained from the SMT.

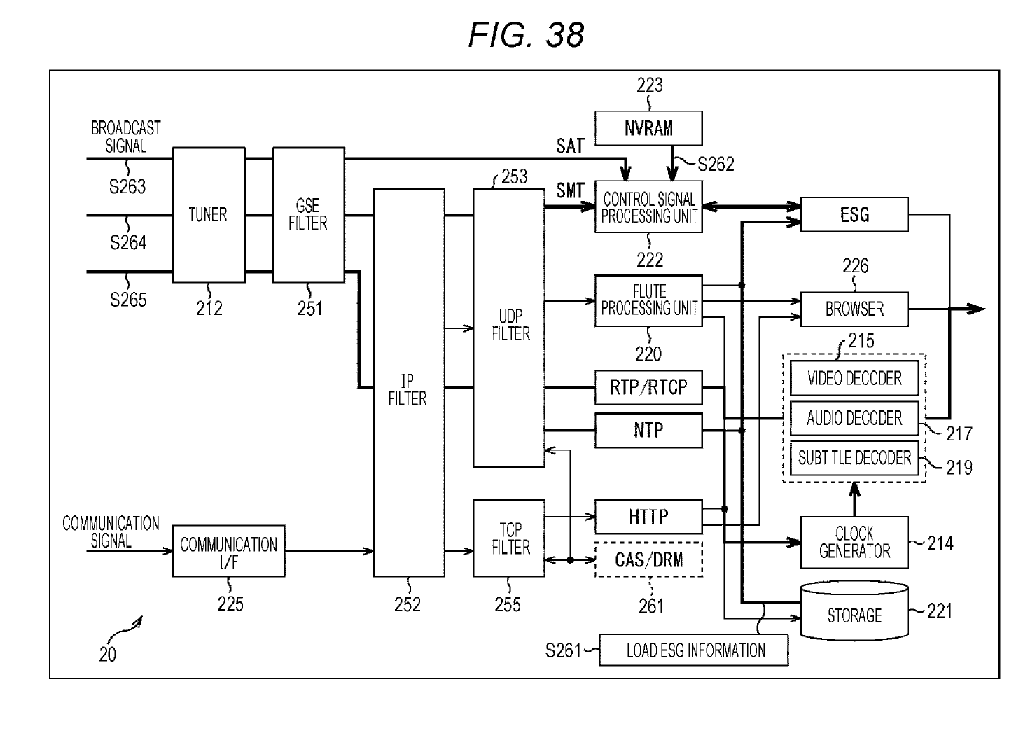

FIG. 38 is a diagram illustrating operations of the reception device 20 during the ESG channel selection.

As illustrated in FIG. 38, in the reception device 20 during the ESG channel selection, the ESG information is read from the storage 221 and displayed on the display (S261). In addition, in a case where viewer's operation of selecting the specific service corresponding to the ESG information is detected, the control signal processing unit 222 reads the channel selection information recorded in the NVRAM 223 (S262). The tuner 212 performs the channel selection process corresponding to the channel selection information according to the control of the control signal processing unit 222. In addition, the control signal processing unit 222 acquires the SAT extracted by the filtering processes in the GSE filter 251 and the section filter bank 254 (not illustrated) and determines whether or not the specific service selected by the viewer is in an on-air state (S263).

In a case where the specific service is in the on-air state, the filtering processes using the IP address and the port number are performed by the IP filter 252 and the UDP filter 253, so that the control signal processing unit 222 acquires the SMT (S264). In addition, in the example of FIG. 38, since the components are transmitted by the RTP session, the IP filter 252 and the UDP filter 253 perform the filtering processes using the IP address and the port number and supply the NTP, the video data, and the audio data to the clock generator 214, the video decoder 215, and the audio decoder 217, respectively (S265).

The clock generator 214 generates a clock signal based on the NTP from the UDP filter 253 and supplies the clock signal to the video decoder 215 and the audio decoder 217 (S265). The video decoder 215 decodes the video data from the UDP filter 253 according to the clock signal from the clock generator 214 and supplies the decoded video data to the video output unit 216 (not illustrated) (S265). The audio decoder 217 decodes the audio data from the UDP filter 253 according to the clock signal from the clock generator 214 and supplies the decoded audio data to the audio output unit 218 (not illustrated) (S265). Therefore, the video of the TV program corresponding to the specific service selected from the ESG information by the viewer is displayed on the display, and the audio corresponding to the video is output from the speaker.

(3) Recording

(3-1) ESG Recording Reservation/Execution

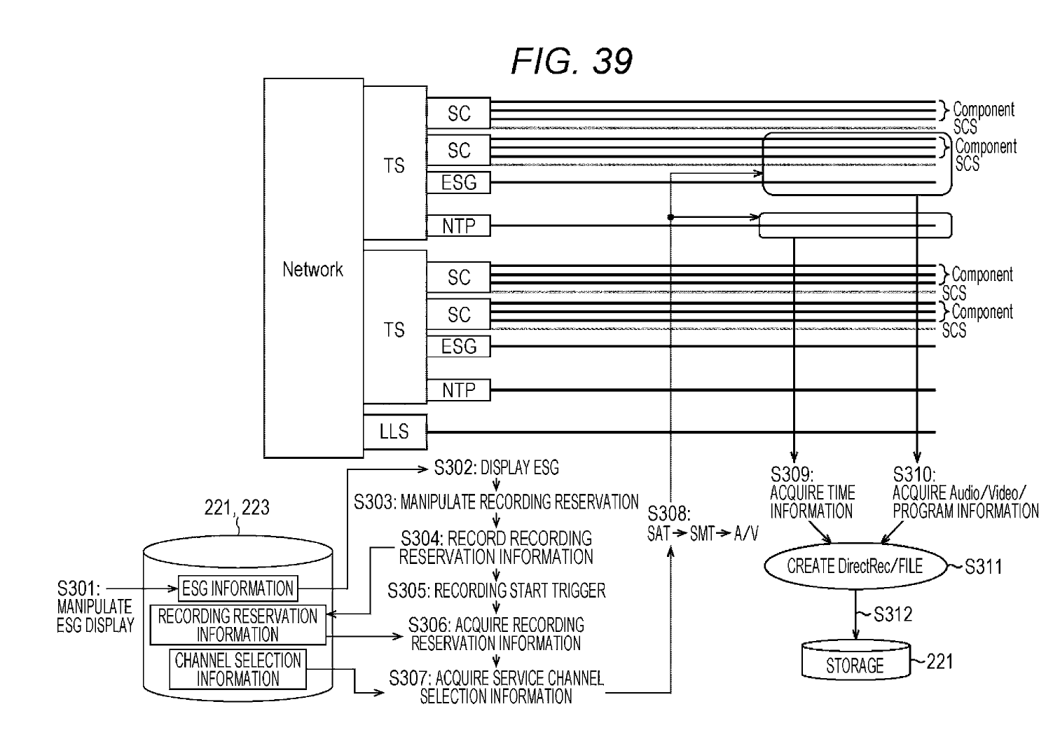

An ESG recording reservation/execution process performed in a case where the viewer performs the recording reservation of the specific service from the ESG (electronic service guide) by using a remote controller or the like will be described with reference to FIGS. 39 to 41.

FIG. 39 is a diagram describing the ESG recording reservation/execution process.

As illustrated in FIG. 39, in the reception device 20, in a case where viewer's operation of ESG display is detected, the ESG information is read from the storage 221 (S301), and the ESG information is displayed on the display (S302). Therefore, the viewer selects the specific service, of which the viewer wants to perform recording reservation, from the service list displayed on the display. In a case where viewer's operation of selection of the specific service is detected, the reception device 20 records recording reservation information according to the operation of selection in the storage 221 (S303 and S304).

Next, in the reception device 20, just before the start time of the recording reservation of the specific service, a recording start trigger is notified (S305). In response to the recording start trigger, the reception device 20 reads the recording reservation information and the channel selection information of the specific service from the storage 221 and the NVRAM 223 and performs the channel selection process (S306 and S307).

The reception device 20 acquires the components or the control information (MLS (SCS)) constituting the specific service by performing the filtering process using the same IP address in the specific service (S308 to S310). In the filtering process, in addition to the components or the control information (MLS (SCS)) of the specific service, the time information (NTP) is acquired by the filtering process using the IP address for the NTP. In addition, the ESG information may be acquired. Next, after the acquired information is packaged in units of a service, the packaged information is recorded as the program recording information corresponding to the specific service in the storage 221 (S311 and S312). However, the program recording information may be recorded in the storage 221 as it is, or the program recording information may be formed as a file and then recorded.

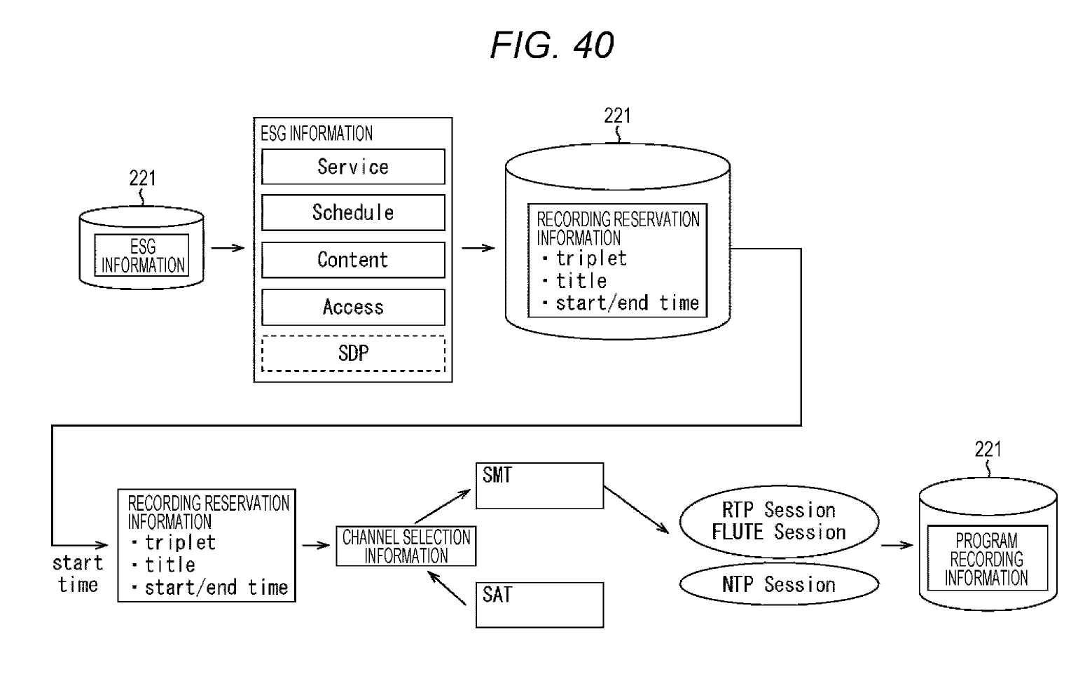

More specifically, as illustrated in FIG. 40, if the specific service is selected from the ESG information, the triplet, the title of the recording program, the recording start time (start time), the recording end time (end time), and the like corresponding to the service are recorded as the recording reservation information in the storage 221. Next, at the recording start time, the recording reservation information and the channel selection information of the specific service are acquired, and the channel selection process is performed. In addition, the SAT transmitted as the LLS in a predetermined transmission period is acquired, and it is determined whether or not the specific service is in an on-air state. In a case where the specific service is in the on-air state, since the IP address is specified by the channel selection information, the SMT transmitted as the MLS (SCS) in a predetermined transmission period is acquired by performing the filtering processes using the IP address and the fixed port number.

In addition, the components of the specific service may be acquired from the RTP session by performing the filtering process using the IP address obtained from the channel selection information. Herein, the video data and the audio data are acquired as the components. In addition, since the IP address for the NTP may be specified from the channel selection information, the NTP is acquired by performing the filtering process using the IP address. In this manner, the components (Audio/Video), the time information (NTP), the control signal (MLS (SCS)), and the like acquired by performing the filtering process using the IP address are packaged in units of a service, and the packaged data are recorded as the program recording information corresponding to the specific service in the storage 221.

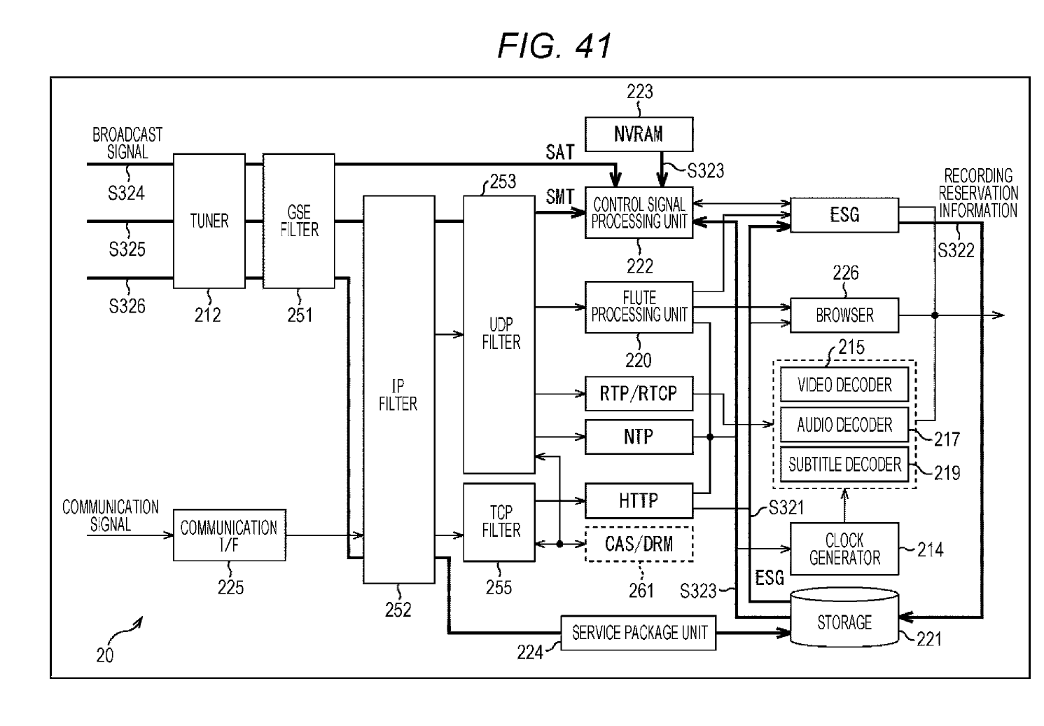

FIG. 41 is a diagram illustrating operations of the reception device 20 during the ESG recording reservation/execution.

As illustrated in FIG. 41, in the reception device 20 during the ESG recording reservation/execution, the ESG information is read from the storage 221 and is displayed on the display (S321). In a case where the specific service is selected from the service list displayed on the display by the viewer, the reception device 20 records the recording reservation information according to the operation of selection in the storage 221 (S322).

Next, in a case where a recording start trigger is notified, the control signal processing unit 222 reads the recording reservation information and the channel selection information of the specific service from the storage 221 and the NVRAM 223 (S323). Therefore, the tuner 212 performs the channel selection process according to the recording reservation information and the channel selection information of the specific service according to the control of the control signal processing unit 222. In addition, the control signal processing unit 222 acquires the SAT extracted by the filtering processes in the GSE filter 251 and the section filter bank 254 (not illustrated) and determines whether or not the specific service selected by the viewer is in an on-air state (S324).

In a case where the specific service is in the on-air state, the control signal processing unit 222 acquires the SMT by performing the filtering processes using the IP address and the port number in the IP filter 252 and the UDP filter 253 (S325).

In addition, the components (Audio/Video), the time information (NTP), and the control signals (MLS (SCS)) of the specific service are extracted by performing the filtering process using the IP address in the IP filter 252 and are supplied to the service package unit 224. Next, the service package unit 224 packages the component, the time information, and the control signals from the IP filter 252 in units of a service and records the packaged data as the program recording information corresponding to the specific service in the storage 221 (S326).

In this manner, in the ESG recording reservation/execution process, the information of the components, the control signal, and the like necessary for the specific service recording-reserved by the viewer is extracted by the filtering process using the IP address, and the information may be packaged in units of a service.

(3-2) Recording Program Reproduction

Next, a recording program reproduction process executed in the case of performing reproduction of the program recording information recorded in the storage 221 by the above-described ESG recording reservation/execution process will be described.

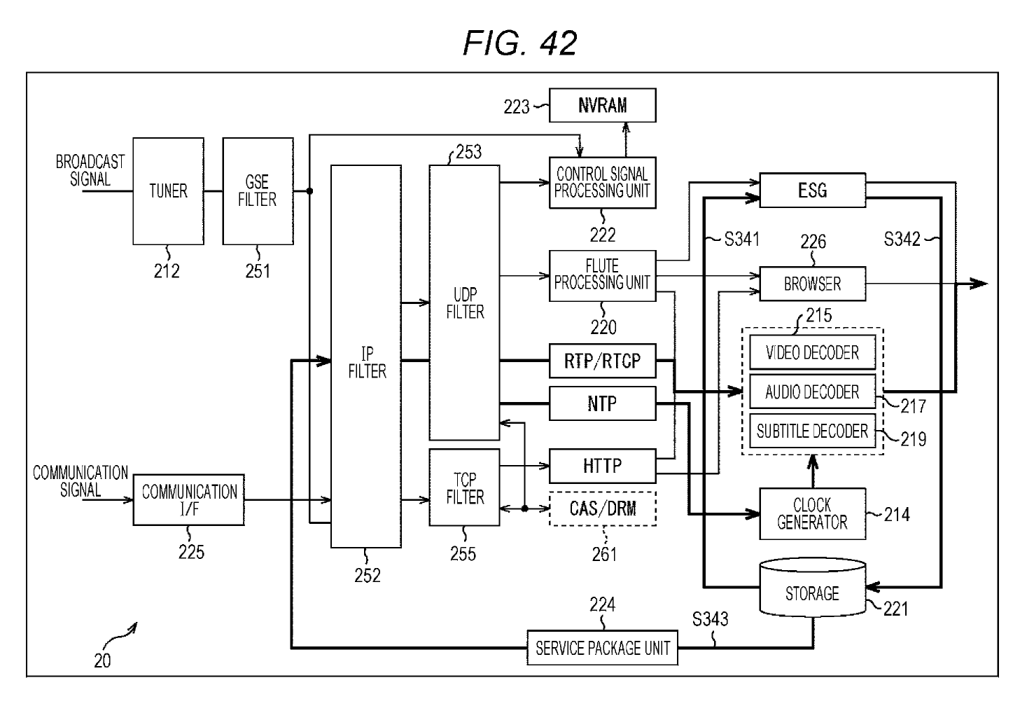

FIG. 42 is a diagram illustrating operations of the reception device 20 during the recording program reproduction.

In the reception device 20 during the recording program reproduction, the ESG information is read from the storage 221, and the ESG information is displayed on the display (S341). In a case where the specific service is selected from the service list by the viewer, the service package unit 224 reads the program recording information corresponding to the specific service in response to the operation of selection from the storage 221 (S342 and S343).

The service package unit 224 acquires the components (Audio/Video), the time information (NTP), and the control signals (MLS (SCS)) which are packaged in units of a service by depackaging the program recording information corresponding to the specific service read from the storage 221 (S343). The information is supplied to the IP filter 252.

In the example of FIG. 42, since the components are transmitted by the RTP session, the IP filter 252 and the UDP filter 253 perform the filtering processes using the IP address and the port number and supply the NTP, the video data, and the audio data to the clock generator 214, the video decoder 215, and the audio decoder 217, respectively (S343).

The clock generator 214 generates a clock signal based on the NTP from the UDP filter 253 and supplies the clock signal to the video decoder 215 and the audio decoder 217 (S343). The video decoder 215 decodes the video data from the UDP filter 253 according to the clock signal from the clock generator 214 and supplies the decoded video data to the video output unit 216 (not illustrated) (S343). The audio decoder 217 decodes the audio data from the UDP filter 253 according to the clock signal from the clock generator 214 and supplies the decoded audio data to the audio output unit 218 (not illustrated) (S343).

Therefore, with respect to the specific service selected from the ESG information by the viewer, the video of the TV program based on the program recording information corresponding to the service is displayed on the display, and the audio corresponding to the video is output from the speaker.

In this manner, the recording program reproduction process allows the specific service to be reproduced by using the components or the control information packaged in units of a service by the ESG recording reservation/execution process.

<2. Adaptation to NRT Service>

Next, operations of the reception device 20 adapted to the NRT service will be described with reference to FIGS. 43 to 50. In addition, the signaling in the NRT service is the same as that described with reference to FIG. 12.

(1) NRT-ESG Acquisition

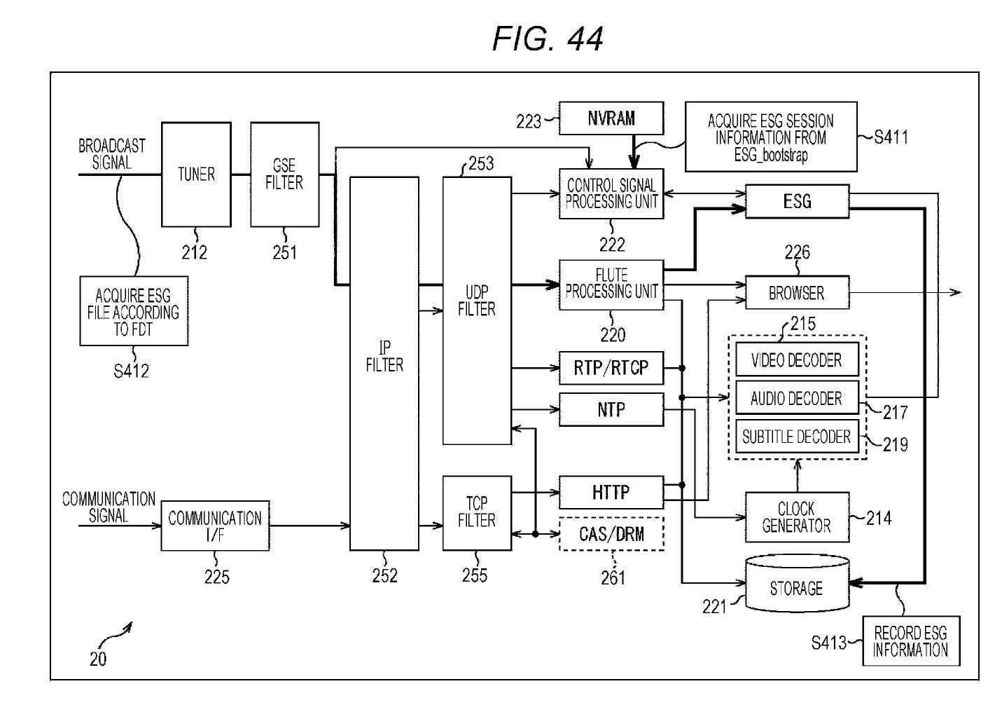

An NRT-ESG acquisition process performed at the time of power-off or the like of the reception device 20 in order to acquire the ESG information including the NRT information (hereinafter, referred to as “NRT-ESG information”) will be described with reference to FIGS. 43 and 44.

FIG. 43 is a diagram describing the NRT-ESG acquisition process.

As illustrated in FIG. 43, in the reception device 20, for example, when the ESG acquisition time such as an appointed time every day elapses, the channel selection information recorded in the NVRAM 223 is read (S401). Since the channel selection information includes the ESG_bootstrap information, NRT-ESG information is acquired by accessing the ESG session among the FLUTE session according to the ESG_bootstrap information (S402 and S403). The NRT-ESG information is recorded in the storage 221 (S404). The NRT-ESG acquisition process is repeated for each broadcasting network (Network), and the NRT-ESG information for the entire channels is recorded in the storage 221 (S405, S403, and S404).

FIG. 44 is a diagram illustrating operations of the reception device 20 during the NRT-ESG acquisition.

As illustrated in FIG. 44, in the reception device 20 during the NRT-ESG acquisition, the control signal processing unit 222 reads the channel selection information recorded in the NVRAM 223 to acquire the TSI included in the ESG_bootstrap information as the ESG session information (S411). The FLUTE processing unit 220 acquires an FDT according to the ESG session information from the control signal processing unit 222 and acquires a file transmitted by the ESG session by referring to the index information thereof (S412). The FLUTE processing unit 220 generates the NRT-ESG information from the file transmitted by the ESG session and records the NRT-ESG information in the storage 221 (S413).

In this manner, the NRT-ESG information of the first broadcasting network is recorded in the storage 221, and similarly, the processes of S411 to S413 of FIG. 44 are repeated, so that the NRT-ESG information for the entire channels which can be designated by the channel selection information recorded in the NVRAM 223 is retained.

(2) NRT Content Acquisition/Reproduction

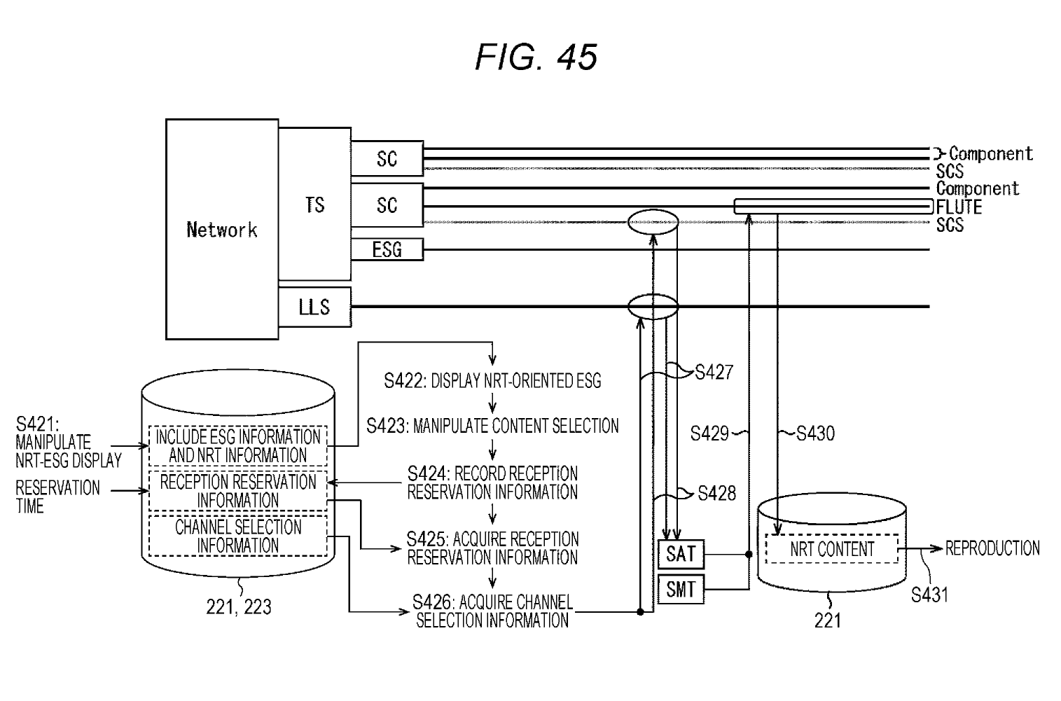

An NRT content acquisition/reproduction process will be described with reference to FIGS. 45 to 47. However, although three schemes of a browse and download scheme, a push scheme, and a portal scheme exist in the NRT service, the browse and download scheme and the push scheme may be applied to the NRT content acquisition/reproduction process.

Herein, in the browse and download scheme, the reception reservation is performed from the downloadable content list, and at the start time of the reservation, reception and storing processes are performed. In the push scheme, a push service list is displayed, service registration is performed, and when the delivery of a content of a registered service is started, the reception and storing processes are performed. In the portal scheme, a dedicated channel (service) for NRT broadcasting is selected, and the NRT content is received and displayed. In addition, in the description of FIGS. 45 to 47, the browse and download scheme will be mainly described.

FIG. 45 is a diagram describing the NRT content acquisition/reproduction process.

As illustrated in FIG. 45, in the reception device 20, in a case where the viewer's operation of display of the NRT-ESG is detected, the NRT-ESG information is read from the storage 221 (S421), and NRT-oriented ESG information is displayed on the display (S422). Therefore, the viewer selects the specific content from a downloadable content list displayed on the display. In a case where the operation of selection of the specific content is detected, the reception device 20 records the reception reservation information corresponding to the operation of selection in the storage 221 (S423 and S424). The reception device 20 waits until the start time of the reception reservation of the content of which reception-reservation is completed.

Next, in the reception device 20, at the start time of the reception reservation of the content of which reception-reservation is completed, the reception reservation information and the channel selection information of the target content are read from the storage 221 and the NVRAM 223 and the channel selection process is performed (S425 and S426). Next, in a case where the specific service is in the on-air state, the reception device 20 acquires the specific NRT content to be transmitted by the FLUTE session and records the specific NRT content in the storage 221 (S427 to S430).

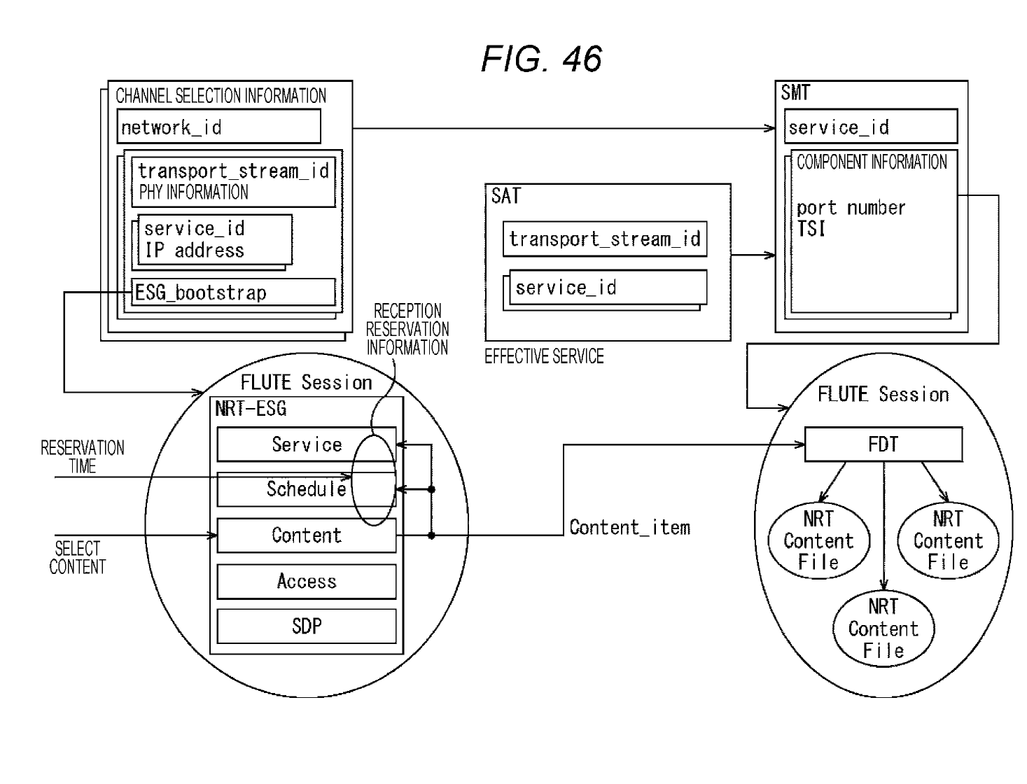

More specifically, as illustrated in FIG. 46, although the NRT-ESG information is acquired from the FLUTE session according to the ESG_bootstrap information included in the channel selection information (NRT-ESG acquisition process of FIGS. 43 and 44), if the specific content is selected from the NRT-oriented ESG information, for example, a portion of the NRT-ESG information such as Service and Schedule is recorded as the reception reservation information in the storage 221. Next, at the start time of the reception reservation, the reception reservation information and the channel selection information of the specific service are acquired, and the channel selection process is performed. In addition, the SAT transmitted as the LLS in a predetermined transmission period is acquired, and it is determined whether or not the specific service is in an on-air state. In a case where the specific service is in the on-air state, the SMT transmitted as the MLS (SCS) in a predetermined transmission period is acquired by performing the filtering processes using the IP address and the fixed port number.

Next, the FLUTE session may be extracted by performing the filtering processes using the IP address obtained from the channel selection information and the port number obtained from the SMT. In addition, since the Component_descriptor written in the SMT includes the TSI in the case of using the FLUTE session, the FDT periodically transmitted in the FLUTE session may be acquired by using the TSI. Since the FDT includes the Content_item as the index information, only the file corresponding to the target NRT content may be acquired from the FLUTE session by cross-checking the Content_item included in the reception reservation information obtained from the NRT-ESG information. The NRT content is configured to include one or a plurality of files.

The NRT content acquired in this manner is recorded in the storage 221. In addition, as illustrated in FIG. 45, for example, in a case where the operation of selection of the specific NRT content from the stored NRT content list is performed by the viewer, the specific NRT content recorded in the storage 221 is read and reproduced (S431).

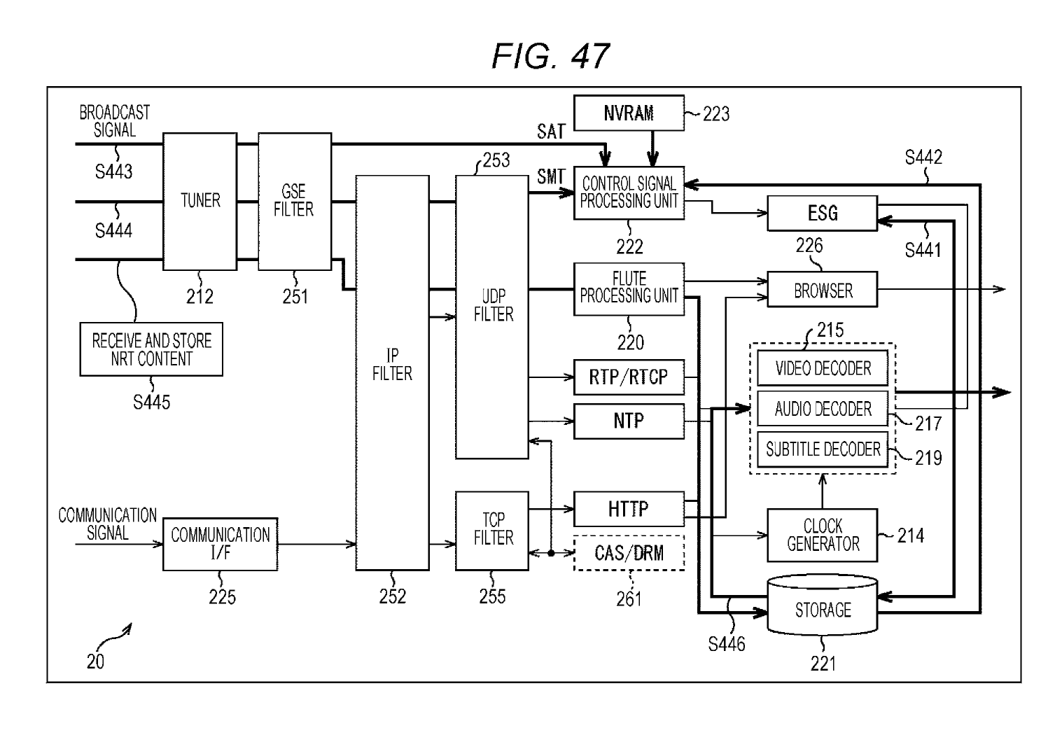

FIG. 47 is a diagram illustrating operations of the reception device 20 during the NRT content acquisition/reproduction.

As illustrated in FIG. 47, in the reception device 20 during the NRT content acquisition/reproduction, the NRT-ESG information is read from the storage 221, and the NRT-oriented ESG information is displayed on the display (S441). In a case where the specific content is selected from the downloadable content list displayed on the displayed by the viewer, the reception device 20 records the reception reservation information corresponding to the operation of selection in the storage (S441).

Next, at the start time of the reception reservation of the content of which reception-reservation is completed, the control signal processing unit 222 reads the reception reservation information and the channel selection information of the target content from the storage 221 and the NVRAM 223 (S442). Therefore, the tuner 212 performs the channel selection process corresponding to the reception reservation information and the channel selection information of the target content according to the control of the control signal processing unit 222.

The control signal processing unit 222 acquires the SAT extracted by the filtering processes in the GSE filter 251 and the section filter bank 254 (not illustrated) and determines whether or not the specific service is in an on-air state (S443). In a case where the specific service is in the on-air state, the filtering processes using the IP address and the fixed port number are performed by the IP filter 252 and the UDP filter 253, so that the control signal processing unit 222 acquires the SMT (S444).

In addition, the FLUTE session is extracted by performing the filtering processes using the IP address and the port number in the IP filter 252 and the UDP filter 253, the file corresponding to the specific NRT content is acquired from the FLUTE session by performing a Content_item collation process, and the file is recorded (stored) in the storage 221 (S445).

In addition, in a case where the viewer's operation of selection of the specific NRT content from the stored NRT content list is performed, the data of the specific NRT content recorded in the storage 221 is read. Next, the NRT content is decoded by the video decoder 215 and the audio decoder 217 to be reproduced (S446).

In addition, in the description of FIGS. 45 to 47, although the browse and download scheme is mainly described, as described above, the NRT content acquisition/reproduction process may also be applied to the push scheme. Namely, instead of registering the reception reservation information of the specific NRT content, a list of reception reservation of registered services is produced. Therefore, similarly to the NRT content acquisition/reproduction process of FIGS. 45 to 47, when the delivery of the NRT content of the registered service is started, the NRT content may be received and stored.

(3) NRT Content Acquisition/Display

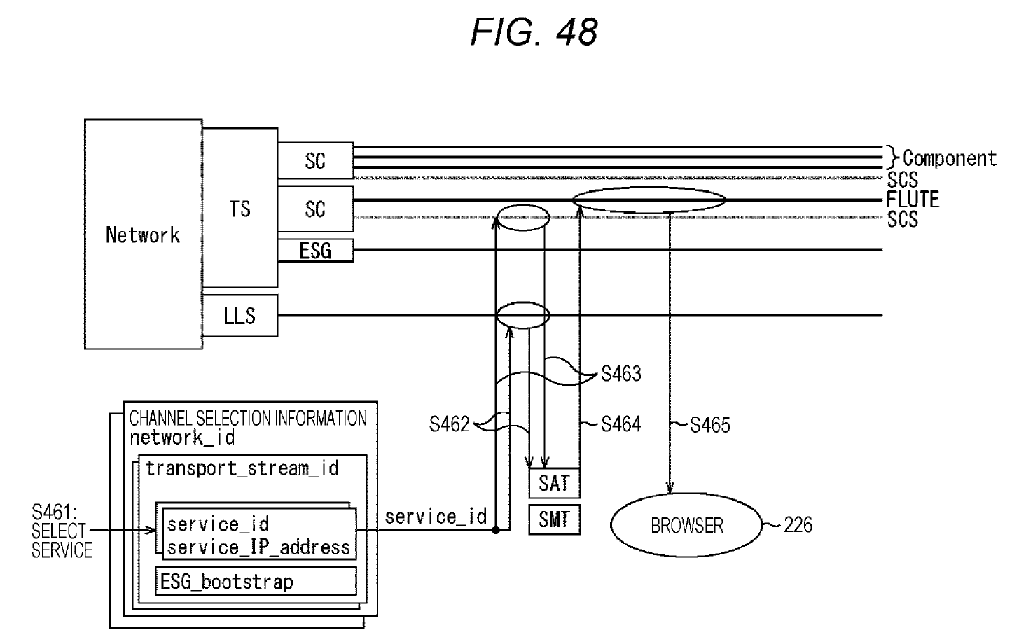

An NRT content acquisition/display process will be described with reference to FIGS. 48 to 50. However, the NRT content acquisition/display process may be applied to only the portal scheme.

FIG. 48 is a diagram describing the NRT content acquisition/display process.

As illustrated in FIG. 48, in the reception device 20, for example, in a case where the service for portal (for example, weather forecast, the latest news, or the like) is selected by the viewer's operation of a remote controller, the channel selection information is read from the NVRAM 223, and the channel selection process is performed (S461). Next, in a case where the specific service is in the on-air state, the reception device 20 acquires the target NRT content transmitted by the FLUTE session and displays the target NRT content by the browser 226 (S462 to S465).

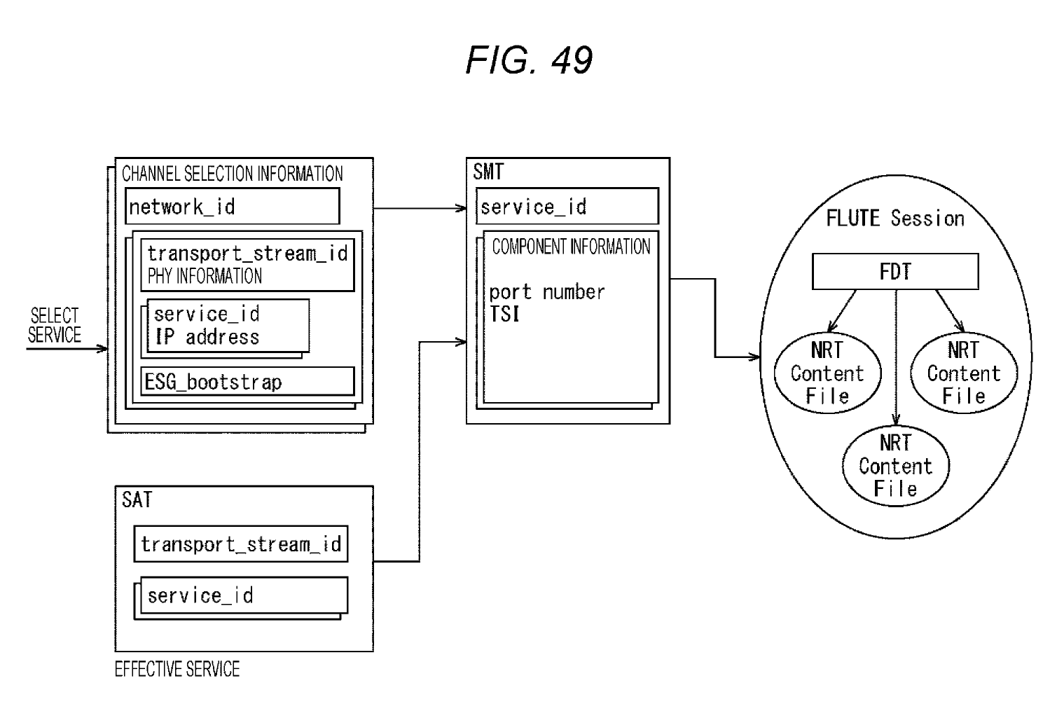

More specifically, as illustrated in FIG. 49, it is determined by using the SAT transmitted as the LLS in a predetermined transmission period whether or not the selected specific service is in an on-air state. In a case where the specific service is in the on-air state, since the IP address is specified by the channel selection information, the SMT transmitted as the SCS in a predetermined transmission period is acquired by performing the filtering processes using the IP address and the fixed port number.

Next, the file corresponding to the specific NRT content is acquired from the FLUTE session by performing the filtering processes using the IP address obtained from the channel selection information and the port number obtained from the SMT, and the file is displayed in the browser 226. In this case, the NRT content is an HTML (HyperText Markup Language) document where information on weather forecast, the latest news, and the like are written, and for example, a file of index.html is firstly acquired and is supplied to the browser 226, so that other associated files such as an image file may be acquired.

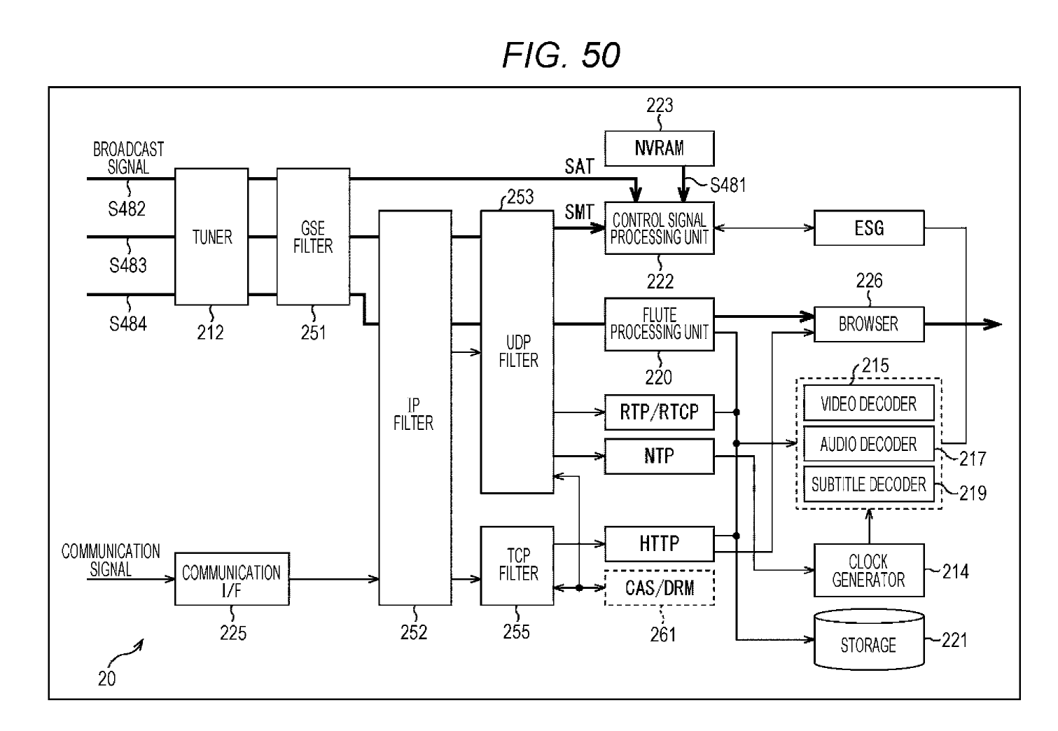

FIG. 50 is a diagram illustrating operations of the reception device 20 during the NRT content acquisition/display.

As illustrated in FIG. 50, in the reception device 20 during the NRT content acquisition/display, in a case where the service for portal is selected by the viewer, the control signal processing unit 222 reads the channel selection information from the NVRAM 223 (S481). Therefore, the tuner 212 performs the channel selection process corresponding to the channel selection information according to the control of the control signal processing unit 222. The control signal processing unit 222 acquires the SAT extracted by the filtering processes in the GSE filter 251 and the section filter bank 254 (not illustrated) and determines whether or not the specific service is in an on-air state (S482). Next, in a case where the specific service is in the on-air state, the control signal processing unit 222 acquires the SMT by performing the filtering processes using the IP address obtained from the channel selection information and the fixed port number (S483).

In addition, the file corresponding to the specific NRT content is acquired from the FLUTE session by performing the filtering processes using the IP address obtained from the channel selection information and the port number obtained from the SMT in the IP filter 252 and the UDP filter 253 and is displayed in the browser 226 (S484).

<3. Adaptation to Hybrid Service>

Finally, operations of the reception device 20 adapted to the hybrid service will be described with reference to FIGS. 51 to 53. In addition, the signaling in the hybrid service is the same as that described with reference to FIG. 13.

(Application Acquisition/Display)

FIG. 51 is a diagram describing an application acquisition/display process.

As illustrated in FIG. 51, in the reception device 20, for example, in a case where the service is selected by the viewer's operation of a remote controller, the channel selection information is read from the NVRAM 223, and the channel selection process is performed (S501). Next, in a case where the specific service is in the on-air state, the reception device 20 acquires the specific broadcast content transmitted by the RTP session and displays the specific broadcast content on the display (S502 to S504).

In addition, the reception device 20 acquires application control information transmitted as the SCS in a predetermined transmission period (S505). Herein, the application control information is information for controlling the operations of the application executed in conjunction with the broadcast content, for example, the AIT (Application Information Table) or the trigger information (Trigger). For example, identification information or acquisition source of the application, definition information for defining lifecycle, and the like are written in the application control information. In a case where a URL (Uniform Resource Locator) of the application server 50 is written as the acquisition source of the application, the reception device 20 accesses the application server 50 via the Internet 90 according to the URL to acquire the application (S506).

For example, the application is formed as an HTML document where the information on the broadcast content is written, and the application is displayed by the browser 226 (S506). Therefore, the broadcast content and the video of the application associated with the broadcast content are simultaneously displayed on the display. In addition, the application is not limited to the Internet delivery, but the application may be acquired from the FLUTE session (S507).

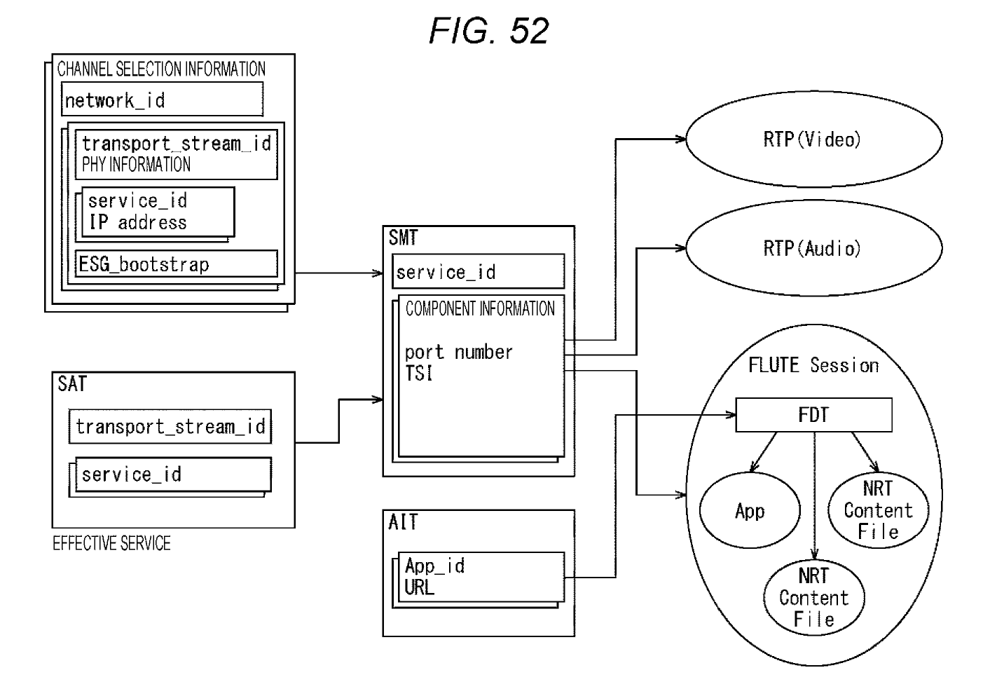

More specifically, as illustrated in FIG. 52, it is determined by using the SAT transmitted as the LLS in a predetermined transmission period whether or not the selected specific service is in an on air state. In a case where the specific service is in the on-air state, since the IP address of the specific service is specified by the channel selection information, the SMT transmitted as the SCS in a predetermined transmission period is acquired by performing the filtering processes using the IP address and the fixed port number.

In addition, the components of the specific service may be acquired from the RTP session by performing the filtering processes using the IP address obtained from the channel selection information and the port number included in the SMT. Herein, the video data and the audio data are acquired as the components, and the video decoder 215 and the audio decoder 217 perform decoding according to the time information represented by the NTP, so that the video and the audio of the broadcast content are synchronized.

In addition, the AIT transmitted as the SCS in a predetermined transmission period is acquired by performing the filtering processes using the IP address and the port number. However, the port number of the AIT is predefined by a fixed value according to a predetermined standard or the like. Identification information (App_id), acquisition source (URL), and the like of the application are written in the AIT.

For example, in a case where the application is transmitted by the FLUTE session, the FLUTE session may be extracted by performing the filtering processes using the IP address obtained from the channel selection information and the port number obtained from the SMT. In addition, in the case of using the FLUTE session, since the Component_descriptor written in the SMT includes TSI, the FDT periodically transmitted in the FLUTE session may be acquired by using the TSI. Since the FDT includes index information, the application may be acquired from the FLUTE session by using the index information.

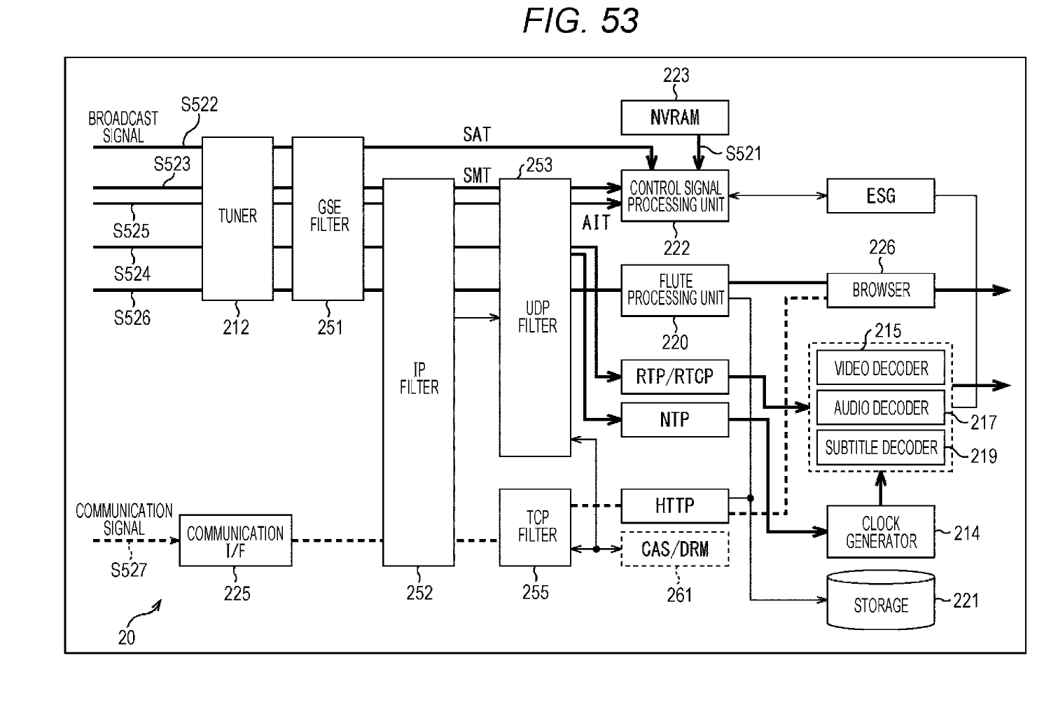

FIG. 53 is a diagram illustrating operations of the reception device 20 during the application acquisition/display.

As illustrated in FIG. 53, in the reception device 20 during the application acquisition/display, in a case where a service is selected by a viewer, the control signal processing unit 222 reads channel selection information from the NVRAM 223 (S521). Therefore, the tuner 212 performs the channel selection process corresponding to the channel selection information according to the control of the control signal processing unit 222.

The control signal processing unit 222 acquires the SAT extracted by the filtering processes in the GSE filter 251 and the section filter bank 254 (not illustrated) and determines whether or not the specific service is in an on-air state (S522). Next, in a case where the specific service is in the on-air state, the filtering processes using the IP address and the port number are performed by the IP filter 252 and the UDP filter 253, so that control signal processing unit 222 acquires the SMT (S523).

In addition, with respect to the broadcast content, since the components are transmitted by the RTP session, the IP filter 252 and the UDP filter 253 perform the filtering processes using the IP address and the port number and supply the NTP, the video data, and the audio data to the clock generator 214, the video decoder 215, and the audio decoder 217, respectively (S524).

The clock generator 214 generates a clock signal based on the NTP from the UDP filter 253 and supplies the clock signal to the video decoder 215 and the audio decoder 217 (S524). The video decoder 215 decodes the video data from the UDP filter 253 according to the clock signal from the clock generator 214 and supplies the decoded video data to the video output unit 216 (not illustrated) (S524). The audio decoder 217 decodes the audio data from the UDP filter 253 according to the clock signal from the clock generator 214 and supplies the decoded audio data to the audio output unit 218 (not illustrated) (S524). Therefore, for example, the video of the TV program or the like is displayed on the display, and the audio synchronized with the video is output from the speaker.

In addition, the IP filter 252 and the UDP filter 253 perform the filtering processes using the IP address and the port number to extract the AIT transmitted as the SCS in a predetermined transmission period and supply the AIT to the control signal processing unit 222 (S525). In addition, the IP filter 252 and the UDP filter 253 perform the filtering processes using the IP address and the port number to extract the FLUTE session. Next, a file of the application is acquired from the FLUTE session based on the application control information, and the application is executed in cooperation with the broadcast content (S526).

In addition, in this example, although the case where the application is transmitted by using the FLUTE session is described, in a case where the application is delivered via the Internet, the application is acquired from the application server 50 (S527).

In addition, in the description of FIGS. 51 to 53, although the RTP session and the FLUTE session are described to be transmitted by the same service, the FLUTE session and the RTP session may be configured to be transmitted by different services. In this case, the SMT is transmitted for each service, and each service is associated with each other through the SMT.

<Details of Specific Processes Performed by Devices>

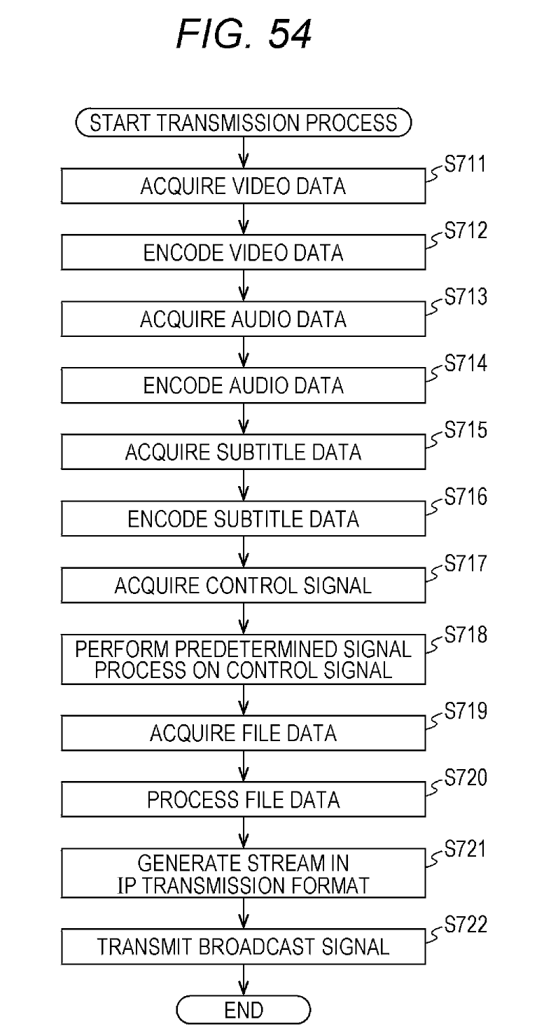

Next, details of specific processes performed by devices constituting the broadcasting system 1 of FIG. 7 will be described with reference to FIGS. 54 to 56.

(Transmission Process)

First, a transmission process performed by the transmission device 10 of FIG. 7 will be described with reference to a flowchart of FIG. 54.

In step S711, the video data acquisition unit 111 acquires the video data and supplies the video data to the video encoder 112. In step S712, the video encoder 112 encodes the video data supplied from the video data acquisition unit 111 and supplies the encoded video data to the Mux 121.

In step S713, the audio data acquisition unit 113 acquires the audio data and supplies the audio data to the audio encoder 114. In step S714, the audio encoder 114 encodes the audio data supplied from the audio data acquisition unit 113 and supplies the encoded audio data to the Mux 121.

In step S715, the subtitle data acquisition unit 115 acquires the subtitle data and supplies the subtitle data to the subtitle encoder 116. In step S716, the subtitle encoder 116 encodes the subtitle data supplied from the subtitle data acquisition unit 115 and supplies the encoded subtitle data to the Mux 121.

In step S717, the control signal acquisition unit 117 acquires the control signals such as the NIT or the SMT and supplies the control signals to the control signal processing unit 118. In step S718, the control signal processing unit 118 performs a predetermined signal process on the control signals supplied from the control signal acquisition unit 117 and supplies the processed control signals to the Mux 121.

In step S719, in a case where data in an asynchronous file format are transmitted, the file data acquisition unit 119 acquires file data, for example, the NRT content, the application, and the like and supplies the file data to the file processing unit 120. In step S720, the file processing unit 120 performs a predetermined file process on the file data supplied from the file data acquisition unit 119 and supplies the processed file data to the Mux 121.

In step S721, the Mux 121 generates a stream in an IP transmission format by multiplexing the video data from the video encoder 112, the audio data from the audio encoder 114, the subtitle data from the subtitle encoder 116, the control signals from the control signal processing unit 118, and the file data from the file processing unit 120 and supplies the stream to the transmission unit 122.

In step S722, the transmission unit 122 transmits the stream supplied from the Mux 121 as the broadcast signal through the antenna 123. When the process of step S722 is ended, the transmission process is ended.

Hereinbefore, the transmission process is described.

(Package Recording Process)

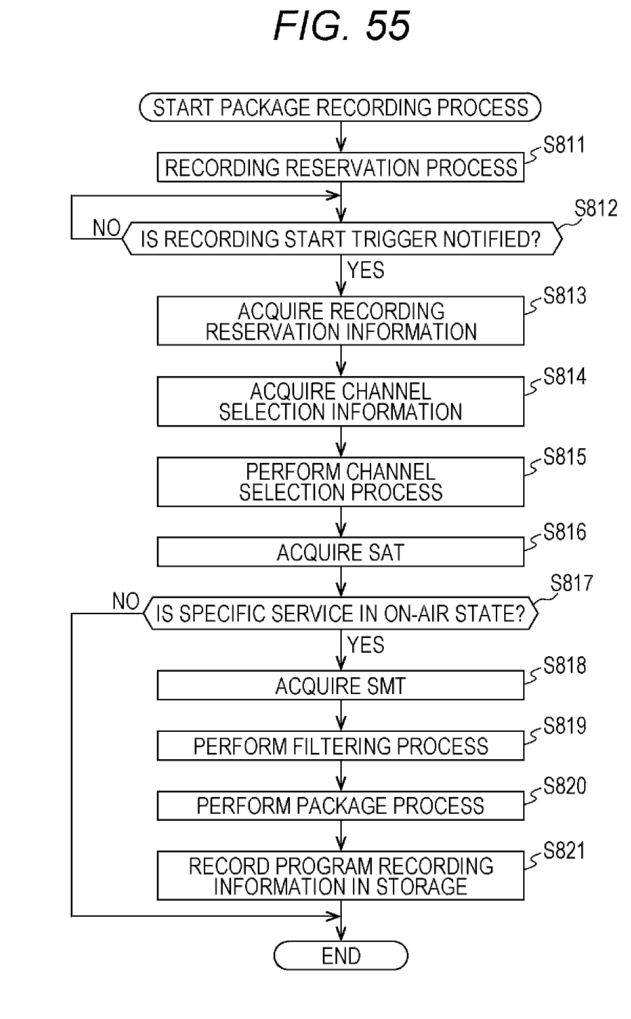

Next, a package recording process performed by the reception device 20 of FIG. 7 will be described with reference to a flowchart of FIG. 55.

In step S811, a recording reservation process is performed. In the recording reservation process, as described in the ESG recording reservation/execution process of FIG. 39, in a case where the specific service is selected from the service list according to the ESG information, the recording reservation information on the service is recorded in the storage 221.

When the recording reservation process is ended, the process proceeds to step S812. In step S812, it is determined whether or not a recording start trigger is notified. After awaiting receipt of notification of the recording start trigger, the process proceeds to step S813.

In step S813, the control signal processing unit 222 acquires the recording reservation information from the storage 221. In addition, in step S814, the control signal processing unit 222 acquires the channel selection information from the NVRAM 223.

In step S815, the tuner 212 performs the channel selection process according to the control of the control signal processing unit 222. Therefore, the broadcast signal of the specific service which is an object of the recording reservation is extracted and demodulated.

In step S816, the control signal processing unit 222 acquires the SAT extracted by the filtering processes in the GSE filter 251 and the section filter bank 254. In step S817, the control signal processing unit 222 determines based on the SAT whether or not the specific service is in an on-air state.

In step S817, in a case where it is determined that the specific service is not in the on-air state, the following processes are stopped, and the package recording process is ended. On the other hand, in step S817, in a case where it is determined that the specific service is in the on-air state, the process proceeds to step S818.

In step S818, the control signal processing unit 222 acquires the SMT extracted by the filtering processes in the IP filter 252 and the UDP filter 253.

In step S819, the IP filter 252 performs a filtering process. Namely, for example, the components (Audio/Video), the time information (NTP), and the control information (MLS) of the specific service transmitted by the RTP session may be acquired by performing the filtering process using the IP address obtained from the channel selection information.

In step S820, the service package unit 224 performs a package process for packaging the components (Audio/Video), the time information (NTP), and the control information (MLS) extracted by the IP filter 252.

In step S821, the service package unit 224 records the program recording information of the specific service obtained by the package process in the storage 221. When the process of step S821 is ended, the package recording process is ended.

Hereinbefore, the package recording process is described.

(Depackage Reproduction Process)

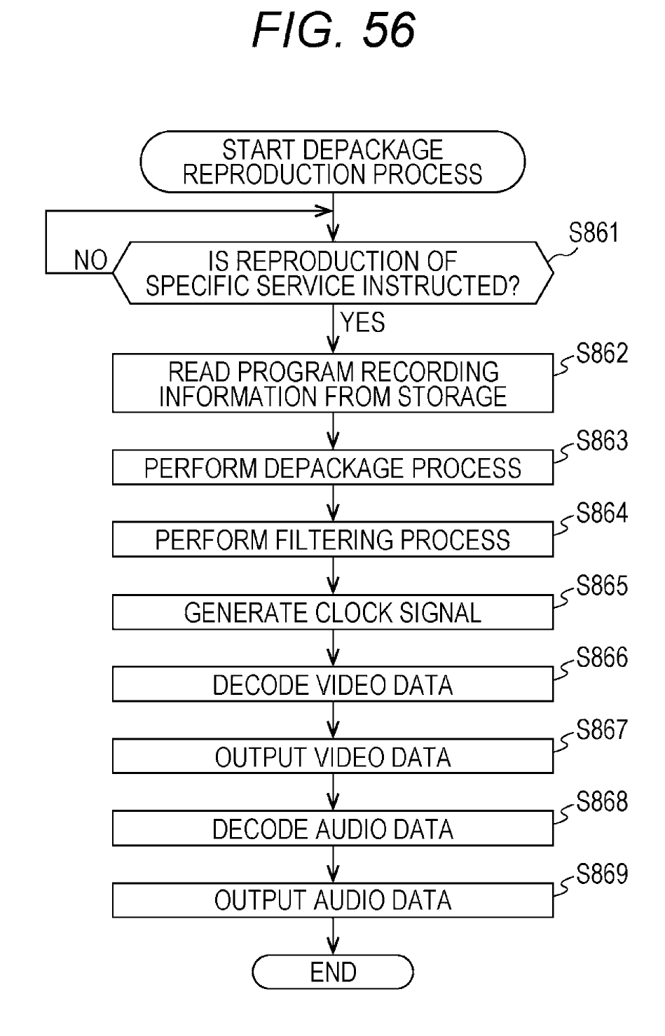

Next, a depackage reproduction process performed by the reception device 20 of FIG. 7 will be described with reference to a flowchart of FIG. 56.

In step S861, it is determined whether or not the specific service is selected from the recorded service list according to the ESG information by the viewer. After the specific service is selected by the viewer and instruction of reproduction of the service is awaited, the process proceeds to step S862.

In step S862, the service package unit 224 reads the program recording information of the specific service from the storage 221. In step S863, the service package unit 224 depackages the program recording information read in the process of step S862 to acquire the components (Audio/Video), the time information (NTP), and the control signals (MLS) packaged in units of a service and supplies the acquired data to the IP filter 252.

In step S864, the IP filter 252 and the UDP filter 253 perform filtering processes using the IP address and the port number and supply the NTP, the video data, and the audio data to the clock generator 214, the video decoder 215, and the audio decoder 217, respectively.

In step S865, the clock generator 214 generates a clock signal based on the NTP supplied from the UDP filter 253 and supplies the clock signal to the video decoder 215 and the audio decoder 217.

In step S866, the video decoder 215 decodes the video data supplied from the UDP filter 253 based on the clocked signal supplied from the clock generator 214 and supplies the decoded video data to the video output unit 216. In step S867, the video output unit 216 outputs the video data supplied from the video decoder 215 to the display.

In step S868, the audio decoder 217 decodes the audio data supplied from the UDP filter 253 based on the clock signal supplied from the clock generator 214 and supplies the decoded audio data to the audio output unit 218. In step S869, the audio output unit 218 supplies the audio data supplied from the audio decoder 217 to the speaker.

In this manner, since the video data and the audio data are decoded synchronously according to the clock signal, the audio corresponding to the video of the TV program displayed on the display is output from the speaker. When the process of step S869 is ended, the depackage reproduction process is ended.

Hereinbefore, the depackage reproduction process is described.

<Description of Computer Employing the Present Disclosure>

A series of the above-described processes may be performed by hardware, or a series of the above-described processes may be performed by software. In a case where a series of the processes is performed by software, a program constituting the software is installed in a computer. Herein, the computer includes a computer assembled into dedicated hardware, a computer where various programs are installed to be able to execute various functions, for example, a general-purpose personal computer, and the like.

FIG. 57 is a block diagram illustrating an example of a hardware configuration of a computer which executes a series of the above-described processes by a program.

In a computer 900, a CPU (Central Processing Unit) 901, a ROM (Read Only Memory) 902, and a RAM (Random Access Memory) 903 are connected to each other via a bus 904. In addition, an input/output interface 905 is connected to the bus 904. An input unit 906, an output unit 907, a recording unit 908, a communication unit 909, and a drive 910 are connected to the input/output interface 905.

The input unit 906 is configured with a keyboard, a mouse, a microphone, and the like. The output unit 907 is configured with a display, a speaker, and the like. The recording unit 908 is configured with a hard disk, a nonvolatile memory, and the like. The communication unit 909 is configured with a network interface or the like. The drive 910 drives a removable media 911 such as a magnetic disc, an optical disc, a magneto-optical disc, or a semiconductor memory.

In the computer 900 configured as described above, the CPU 901 loads the program recorded, for example, in the recording unit 908 on the RAM 903 via the input/output interface 905 and the bus 904 and executes the program to perform a series of the above-described processes.

The program which is to be executed by the computer 900 (CPU 901) may be provided as the removable media 911, for example, a package media or the like where the program is recorded. In addition, the program may be provided through a wired or wireless transmission medium such as a local area network, the Internet, or digital satellite broadcasting.

In the computer 900, the program may be installed in the recording unit 908 via the input/output interface 905 by mounting the removable media 911 on the drive 910. In addition, the program may be received through the communication unit 909 via the wired or wireless transmission medium to be installed in the recording unit 908. In addition, the program may be installed in the ROM 902 or the recording unit 908 in advance.

In addition, the program which is to be executed by the computer 900 may be a program which is processed in time series according to the order of description in the specification or may be a program which is processed in parallel or at a necessary timing such as a time when the program is called.

Herein, in the specification, process steps describing the program for allowing the computer 900 to perform various processes are not necessarily processed in time series according to the order written in a flowchart, but processes (for example, parallel processes or processes by objects) which are performed in parallel or individually are also included.

In addition, the program may be processed by one computer, or the program may be processed by a plurality of computers in a distributed processing manner. In addition, the program may be transmitted to a remote computer to be executed by the computer.

In addition, in the specification, a system denotes a set of plural configuration elements (devices, modules (units), and the like), and it does not matter whether all the configuration elements are included in the same housing. Therefore, plural devices which are contained in separate cases and are connected via a network and one device in which plural modules are contained in one case are the systems.

In addition, the embodiments of the present disclosure are not limited to the embodiments described above, but various changes are available within the scope without departing from the spirit of the present disclosure. For example, the present disclosure may have a configuration of cloud computing where one function is shared by plural devices via a network to be cooperatively processed.

In addition, each step described in the above-described flowcharts may be shared and processed by the plural devices in addition to being processed by one device. In addition, in a case where one step includes plural processes, the plural processes included in the one step may be shared and processed by the plural devices in addition to being processed by one device.

In addition, the present disclosure may have the following configuration.

(1)

A reception device including:

circuitry configured to

receive a digital broadcast signal including an IP (Internet Protocol) transport stream;

package, for a specific service among a plurality of services included in the digital broadcast signal, packets of one or a plurality of components and a first control signal constituting the specific service by using an IP address included in each of the packets; and

perform a predetermined process by using the packaged one or the plurality of components and first control information.

(2)

The reception device according to (1) above, wherein packets of the one or the plurality of components and a packet of the first control information which are packaged as a same service have a same IP address.

(3)

The reception device according to (2) above, wherein the circuitry is configured to package the first control information used for a first layer which is an upper layer of an IP layer among layers of a protocol used to transmit the digital broadcast signal.

(4)

The reception device according to (3) above, wherein second control information transmitted in a packet having a structure which is different from a structure of an IP packet includes:

an ID identifying a network;

an ID identifying the IP transport stream; and

an ID identifying a service.

(5)

The reception device according to (4) above, wherein the second control information includes a different ID for identifying each of a plurality of IP transport streams included in the digital broadcast signal.

(6)

The reception device according to (4) above, wherein the ID identifying the network identifies a network associated with the received digital broadcast signal, and the ID identifying the service identifies the specific service.

(7)

The reception device according to (6) above, wherein the circuitry is further configured to

extract, based on the second control information, service information indicating one or more port numbers associated with the one or the plurality of components corresponding to the ID identifying the specific service, and package the specific service based on the IP address and the one or more port numbers.

(8)

The reception device according to (1) above, wherein

each of the packets of the one or the plurality of components includes a first header, a second header, and a third header, the first header indicates a type of information included in the respective packet, the second header indicates the IP address associated with the specific service, and the third header indicates a port number of a UDP (User Datagram Protocol).

(9)

The reception device according to (3) above, wherein the first control information used for the first layer includes information on the one or the plurality of components constituting the specific service.

(10)

The reception device according to (9) above,

wherein the information on the one or the plurality of components includes a port number of a UDP, and

the circuitry is further configured to extract the one or the plurality of components constituting the specific service by performing filtering using the IP address and the port number.

(11)

The reception device according to any one of (3) to (10) above, wherein the first control information used for the first layer includes control information of an application.

(12)

The reception device according to any one of (4) to (11) above, wherein the second control information includes information associated with the IP address for each of the services.

(13)

The reception device according to any one of (1) to (12) above, wherein the digital broadcast signal is transmitted using an IP transmission mode in which the packets are designated with port numbers of a UDP (User Datagram Protocol).

(14)

The reception device according to any one of (1) to (13) above, wherein the one or the plurality of components is acquired from one of an RTP (Real-time Transport Protocol) session and a FLUTE (File Delivery over Unidirectional Transport) session of the digital broadcast signal based on whether the specific service is provided in a synchronous or an asynchronous format.

(15)

The reception device according to any one of (1) to (14) above, wherein the circuitry is configured to store the one or the plurality of packaged components and the first control information in a memory.

(16)

The reception device according to (15) above, wherein the circuitry is further configured to read the one or the plurality of components and the first control information which are stored in the memory to perform reproduction.

(17)

The reception device according to any one of (1) to (16) above, wherein the circuitry is further configured to the packaged one or the plurality of components and the first control information to another electronic device.

(18)

A reception method of a reception device, including:

receiving a digital broadcast signal including an IP transport stream;

packaging, by circuitry of the reception device and for a specific service among a plurality of services included in the digital broadcast signal, packets of one or a plurality of components and control information constituting the specific service by using an IP address included in each of the packets; and

performing a predetermined process by using the packaged one or the plurality of components and control information.

(19)

A transmission device including:

circuitry configured to

acquire one or a plurality of components;

acquire a control information; and

transmit a digital broadcast signal including an IP transport stream in which packets of the one or the plurality of components and a packet of the control information constituting a specific service have the same IP address.

(20)

A transmission method of a transmission device, including:

acquiring, by circuitry of the transmission device, one or a plurality of components;

acquiring, by the circuitry, control information; and

transmitting, by the circuitry, a digital broadcast signal including an IP transport stream in which packets of the one or the plurality of components and a packet of the control information constituting a specific service have the same IP address.

### REFERENCE SIGNS LIST

1 Broadcasting system
10 Transmission device
20 Reception device
111 Video data acquisition unit
113 Audio data acquisition unit
117 Control signal acquisition unit
119 File data acquisition unit
121 Mux
122 Transmission unit
212 Tuner
213 Demux
214 Clock generator
215 Video decoder
216 Video output unit
217 Audio decoder
218 Audio output unit
219 Subtitle decoder
220 FLUTE processing unit
221 Storage
222 Control signal processing unit
223 NVRAM
224 Service package unit
225 Communication I/F
226 Browser
251 GSE filter
252 IP filter
253 UDP filter
254 Section filter bank
900 Computer
901 CPU

1. A reception device comprising:
circuitry configured to receive a digital broadcast signal including an IP (Internet Protocol) transport stream;
package, for a specific service among a plurality of services included in the digital broadcast signal, packets of one or a plurality of components and first control information constituting the specific service by using an IP address included in each of the packets; and
perform a predetermined process by using the packaged one or the plurality of components and first control information.

2. The reception device according to claim 1, wherein the packets of the one or the plurality of components and a packet of the first control information which are packaged as a same service have a same IP address.

3. The reception device according to claim 2, wherein the circuitry is configured to package the first control information used for a first layer which is an upper layer of an IP layer among layers of a protocol used to transmit the digital broadcast signal.

4. The reception device according to claim 3, wherein second control information transmitted in a packet having a structure which is different from a structure of an IP packet includes:
an ID identifying a network;
an ID identifying the IP transport stream; and
an ID identifying a service.

5. The reception device according to claim 4, wherein the second control information includes a different ID for identifying each of a plurality of IP transport streams included in the digital broadcast signal.

6. The reception device according to claim 4, wherein
the ID identifying the network identifies a network associated with the received digital broadcast signal, and
the ID identifying the service identifies the specific service.

7. The reception device according to claim 6, wherein the circuitry is further configured to
extract, based on the second control information, service information indicating one or more port numbers associated with the one or the plurality of components corresponding to the ID identifying the specific service, and
package the specific service based on the IP address and the one or more port numbers.

8. The reception device according to claim 1, wherein
each of the packets of the one or the plurality of components includes a first header, a second header, and a third header,
the first header indicates a type of information included in the respective packet,
the second header indicates the IP address associated with the specific service, and
the third header indicates a port number of a UDP (User Datagram Protocol).

9. The reception device according to claim 3, wherein the first control information used for the first layer includes information on the one or the plurality of components constituting the specific service.

10. The reception device according to claim 9, wherein
the information on the one or the plurality of components includes a port number of a UDP (User Datagram Protocol), and
the circuitry is further configured to extract the one or the plurality of components constituting the specific service by performing filtering using the IP address and the port number.

11. The reception device according to claim 9, wherein the first control information used for the first layer includes control information of an application.

12. The reception device according to claim 4, wherein the second control information includes information associated with the IP address for each of the services.

13. The reception device according to claim 1, wherein the digital broadcast signal is transmitted using an IP transmission mode in which the packets are designated with port numbers of a UDP (User Datagram Protocol).

14. The reception device according to claim 1, wherein the one or the plurality of components is acquired from one of an RTP (Real-time Transport Protocol) session and a FLUTE (File Delivery over Unidirectional Transport) session of the digital broadcast signal based on whether the specific service is provided in a synchronous or an asynchronous format.

15. The reception device according to claim 1, wherein the circuitry is further configured to store the packaged one or the plurality of components and the first control information in a memory.

16. The reception device according to claim 15, wherein the circuitry is further configured to read the one or the plurality of components and the first control information which are stored in the memory to perform reproduction.

17. The reception device according to claim 1, wherein the circuitry is further configured to transmit the packaged one or the plurality of components and the first control information to another electronic device.

18. A reception method of a reception device, comprising:
receiving, by circuitry of the reception device, a digital broadcast signal including an IP (Internet Protocol) transport stream;
packaging, by the circuitry and for a specific service among a plurality of services included in the digital broadcast signal, packets of one or a plurality of components and control information constituting the specific service by using an IP address included in each of the packets; and
performing a predetermined process by using the packaged one or the plurality of components and control information.

19. A transmission device comprising:
circuitry configured to acquire one or a plurality of components;
acquire control information; and
transmit a digital broadcast signal including an IP (Internet Protocol) transport stream in which packets of the one or the plurality of components and a packet of the control information constituting a specific service have the same IP address.

20. A transmission method of a transmission device, comprising:
acquiring, by circuitry of the transmission device, one or a plurality of components;
acquiring, by the circuitry, control information; and
transmitting, by the circuitry, a digital broadcast signal including an IP (Internet Protocol) transport stream in which packets of the one or the plurality of components and a packet of the control information constituting a specific service have the same IP address.
